(19) United States
(12) Patent Application Publication
(10) Pub. No.: US 2023/0293975 A1
(43) Pub. Date: Sep. 21, 2023

(54) Interactive Touch Control for a Pinball Machine

(71) Applicant: DEEPROOT CAPITAL MANAGEMENT LLC, San Antonio, TX (US)

(72) Inventors: ROBERT MUELLER, San Antonio, TX (US); MARC CALL, San Antonio, TX (US); PATRICK FINUCANE, San Antonio, TX (US); DREW CARLTON, San Antonio, TX (US); GABRIEL HERNANDEZ, San Antonio, TX (US); SHAWN BETTS, San Antonio, TX (US); STEVEN DELORENZO, San Antonio, TX (US); DANIEL VELA, San Antonio, TX (US); JEREMY SANCHEZ, San Antonio, TX (US); JOSUE CRUZ-LAMBERT, San Antonio, TX (US); MATTHEW BRADSHAW, San Antonio, TX (US); BLAKE ADRIAN, San Antonio, TX (US); TEAGHAN AVRETT, San Antonio, TX (US); RYAN GRAHAM, San Antonio, TX (US); ETHAN HUNSAKER, San Antonio, TX (US); CRAIG RUSHFORTH, Sugar City, ID (US)

(21) Appl. No.: 17/787,971

(22) PCT Filed: Dec. 23, 2020
(86) PCT No.: PCT/US20/66966

§ 371 Date: Jun. 22, 2022

Related U.S. Application Data
(60) Provisional application No. 62/952,646, filed on Dec. 23, 2019.

(51) Int. Cl. A63F 7/02

(52) U.S. Cl. CPC A63F 7/027; A63F 2007/3045

(57) ABSTRACT

The present invention comprises an interactive touch control for a pinball machine to allow a user to interact with various settings of a pinball game. The invention further comprises an improved glass top assembly to permit lifting of the glass top via a hinge near the back box. The invention further comprises an improved mechanism for locking the glass top assembly to the cabinet and locking the playfield to the cabinet.

### CROSS-REFERENCES TO RELATED APPLICATIONS

This application claims the benefit of U.S. Provisional Application Ser. No. 62/952,646 filed Dec. 23, 2019 entitled Interactive touch control for a Pinball Machine. The above application is incorporated by reference herein.

### STATEMENT REGARDING FEDERALLY SPONSORED RESEARCH OR DEVELOPMENT

Not applicable.

### BACKGROUND OF THE INVENTION

### 1. Field of the Invention

The present invention relates to pinball machines.

### 2. Background of the Related Art

A pinball machine typically includes a cabinet supported by four legs, an inclined playfield housed within the cabinet, two flippers, a backbox extending vertically from the cabinet, and a glass top that protects the playfield and encloses the top of the cabinet. A button, positioned on each side panel, typically controls the flipper corresponding to that side. The glass top is generally secured by a metal frame that extends around the top edge of the cabinet. A lock bar is placed at the front edge of the frame and further secures the glass. In typical pinball machines, the glass is removed by first removing the lock bar which allows the glass to slide out of the metal frame. The lock bar also provides a location for a player to rest their hands during gameplay. The vertically-oriented backbox, or header, typically extends upward from a rear portion of the cabinet. Peripheral devices are routinely found in pinball machines such as video displays, lights, and audio hardware that provide sound effects and music.

The playfield is configured to support one or more rolling pinballs and a plurality of fixed, stationary, electrical, mechanical, or electro-mechanical components that may interact with the pinball(s) to score points and/or activate certain features of the game. Other items such as a multi-level playfields or inclusion of more than two flippers are also found in the prior art.

While the structure, peripherals, and game play of pinball machines have evolved over the last several decades as technology has advanced, player interaction with a pinball machine has undergone very few changes. Changing various pinball machine settings such as display brightness, volume, sound quality, and game modes remains cumbersome and difficult. Part of the limitation is derived from the placement of the user's hands during game play; generally resting each hand on the opposing ends of the lock bar with fingers extended around to the sides of the pinball machine. This allows the user to access the physical flipper buttons the control the flipper that ultimately engages the ball(s).

To change machine settings on current pinball machines, if changes are even permissible, a user must physically access the secured interior of the pinball machine. This multi-step process usually includes: (i) opening the front coin door with a key; (ii) using a primitive and counter-intuitive series of 2, 3, or 4 buttons (on the inside of the coin door) to navigate through menus or alter settings; (iii) having to cycle attention back and forth between the back box and the buttons on the coin door; (iv) reset the device; (v) close and lock the coin door. Seeking to change any of these settings during gameplay results in a complete disruption to gameplay. It is physically awkward (and nearly impossible) to follow the above described sequences to make changes to settings while also keeping the playfield in view and game play in progress. More problematic is that opening the coin door sets off a safety mechanism that shuts off high voltage power to certain pinball components. Finally, changing settings typically requires a machine reset which results in the loss of game progress and scoring.

### SUMMARY OF THE INVENTION

The invention herein involves the addition of an interactive touch control 140 that permits the user to interact with the pinball machine to control gameplay, settings, and the peripherals associated with the pinball machine. The invention further includes a modified mechanism for opening the glass top of the playfield and for locking the playfield to the cabinet. The glass top opening includes a cutout portion that fits around the interactive touch control 140. The glass top is secured to the cabinet by two gas cylinders that allow the frame and glass to open from a pivot point at the rear of the cabinet.

### BRIEF SUMMARY OF THE DRAWINGS

FIG. 1 is a perspective view of the present invention with the glass top assembly in the closed position.

FIG. 2 is a top down view of the present invention with the glass top assembly in the closed position.

FIG. 3 is a right side view of the present invention with the glass top assembly in the closed position.

FIG. 4 is a close up view of the left lifting assembly with the glass top assembly in the closed position.

FIG. 5 is a close up view of the left lifting assembly with the “L” shaped cover bracket removed with the glass top assembly in the closed position.

FIG. 6 is a close up view of the right lifting assembly with the glass top assembly in the closed position.

FIG. 7 is a close up view of the right lifting assembly with the “L” shaped cover bracket removed with the glass top assembly in the closed position.

FIG. 8 is a perspective view of the present invention with the glass top assembly in the first open position.

FIG. 9 is a top down view of the present invention with the glass top assembly in the first open position.

FIG. 10 is a right side view of the present invention with the glass top assembly in the first open position.

FIG. 11 is a close up view from the right side of the present invention with the glass top assembly in the first open position.

FIG. 12 is a close up view from the left side of the present invention with the glass top assembly in the first open position.

FIG. 13 is a perspective view of the present invention with the glass top assembly in the second open position.

FIG. 14 is a right side view of the present invention with the glass top assembly in the second open position.

FIG. 15 is a close up view from the right side of the present invention with the glass top assembly in the second open position.

FIG. 16 is a close up view from the left side of the present invention with the glass top assembly in the second open position.

FIG. 17 is a close up underside view of the first portion of the frame.

FIG. 18 is a close up front view of the playfield with the present invention.

FIG. 19 is a close up left side perspective view of the playfield with the present invention.

FIG. 20 is a close up view of the underside of the present invention.

FIG. 21 is a close up right side perspective view of the playfield with the present invention.

FIG. 22 is a close up right side perspective view of the interior face of the front panel of the present invention.

FIG. 23 is a close up left side perspective view of the playfield with the present invention with the front panel removed.

FIGS. 24-25 are block diagrams of the interaction of the various systems of the invention.

FIGS. 26-31 are illustrative examples of system menu displays on the interactive touch control.

FIGS. 32-33 are illustrative examples of testing menu displays on the interactive touch control.

FIGS. 34-35 are illustrative examples of settings menu displays on the interactive touch control.

FIGS. 36-39 are illustrative examples of statistics menu displays on the interactive touch control.

FIGS. 40-45 are illustrative examples of game play displays on the interactive touch control.

### DETAILED DESCRIPTION OF THE VARIOUS EMBODIMENTS

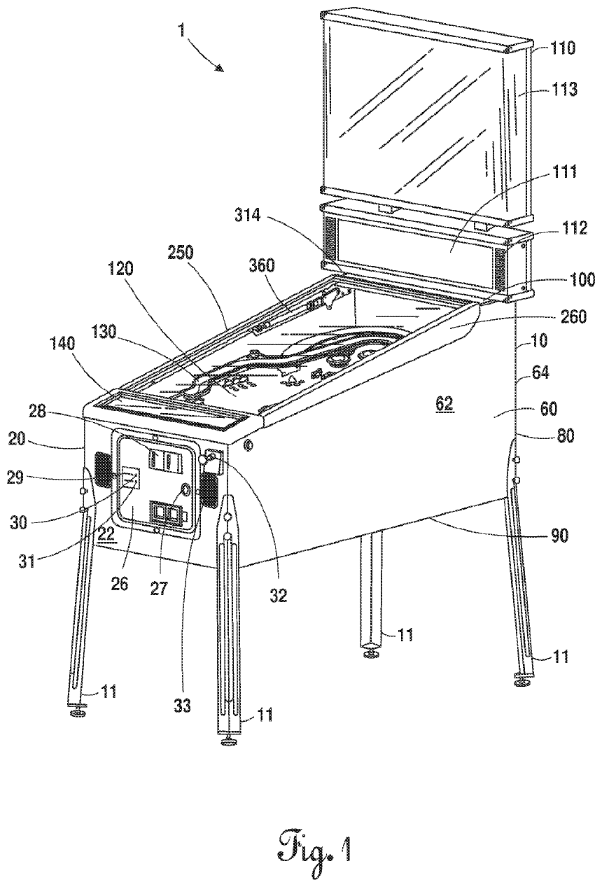

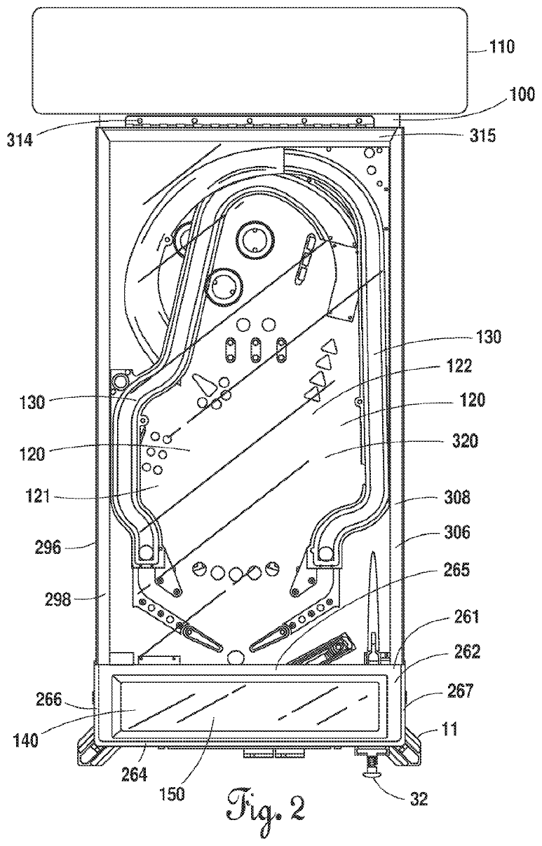

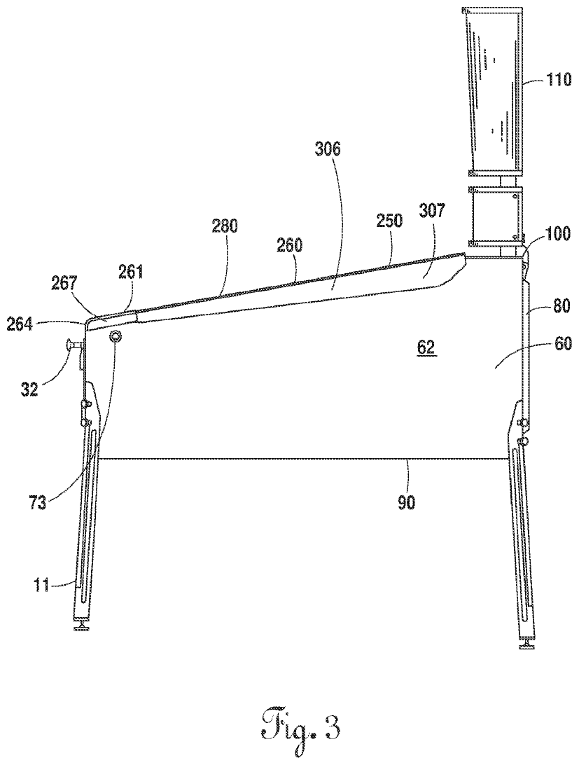

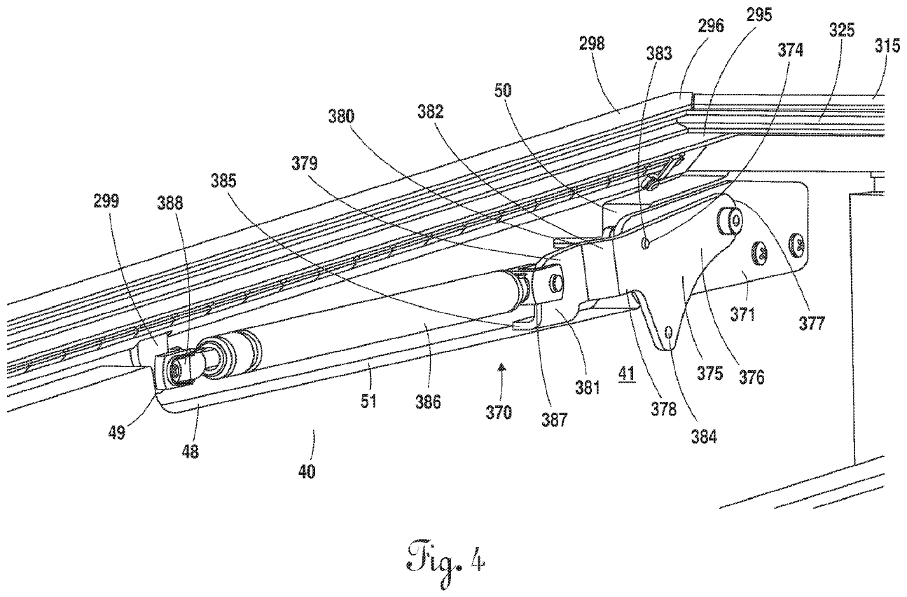

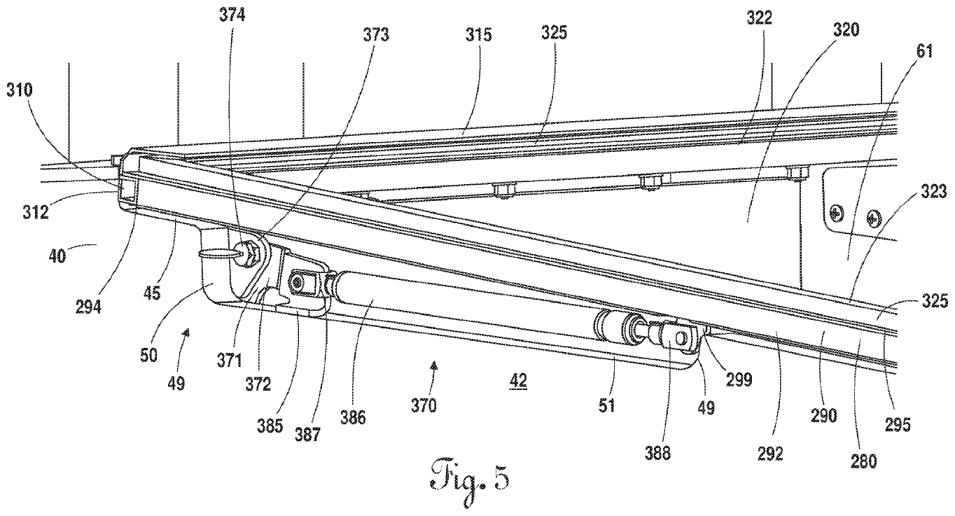

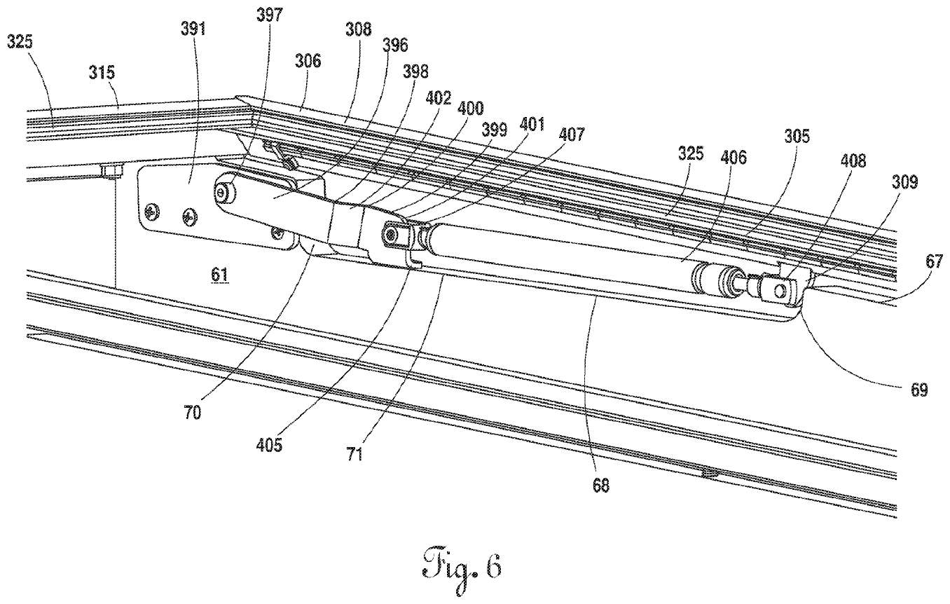

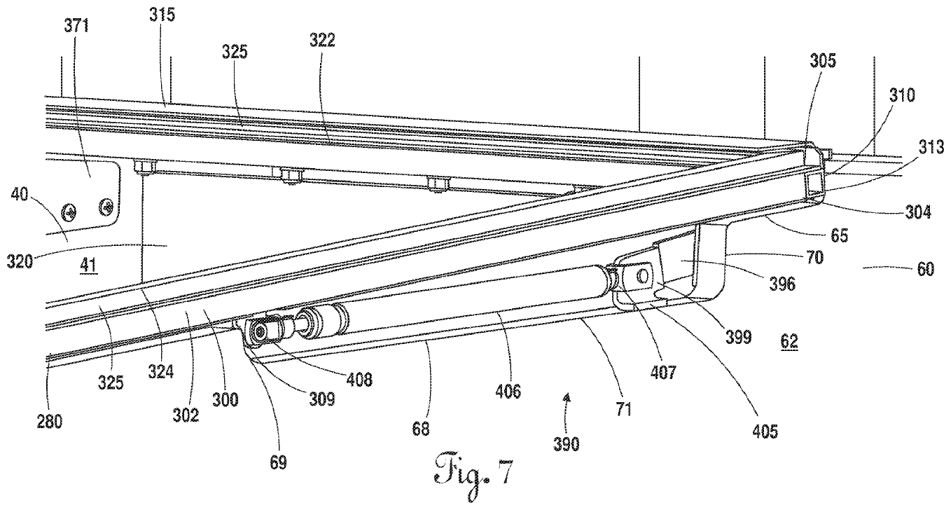

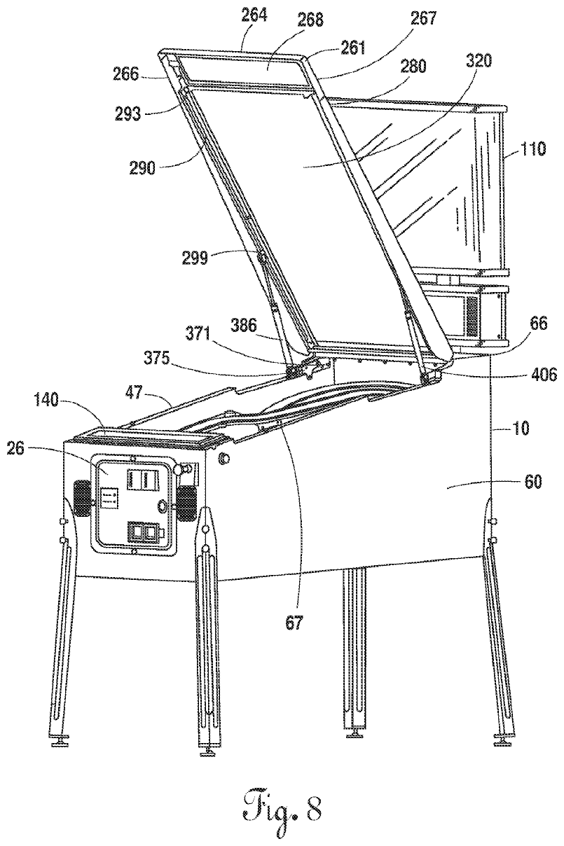

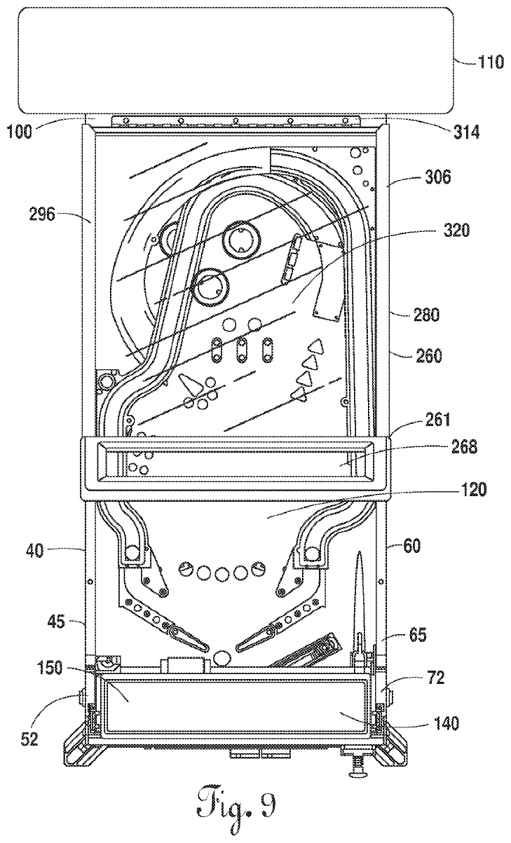

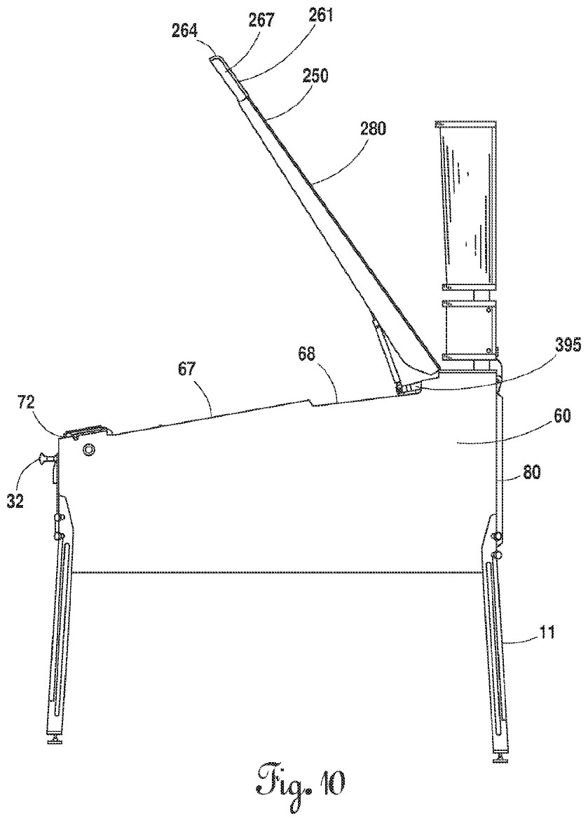

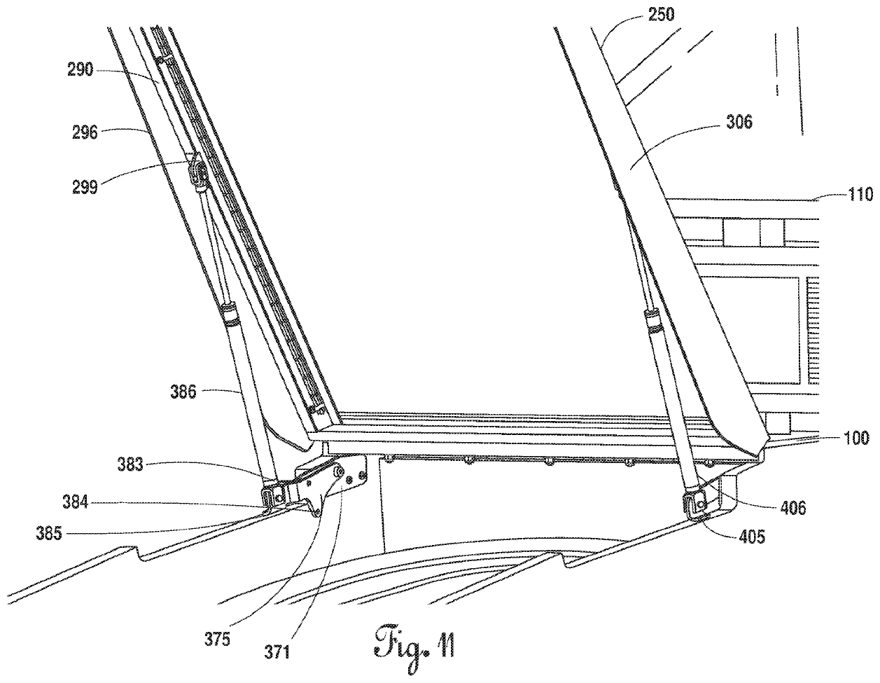

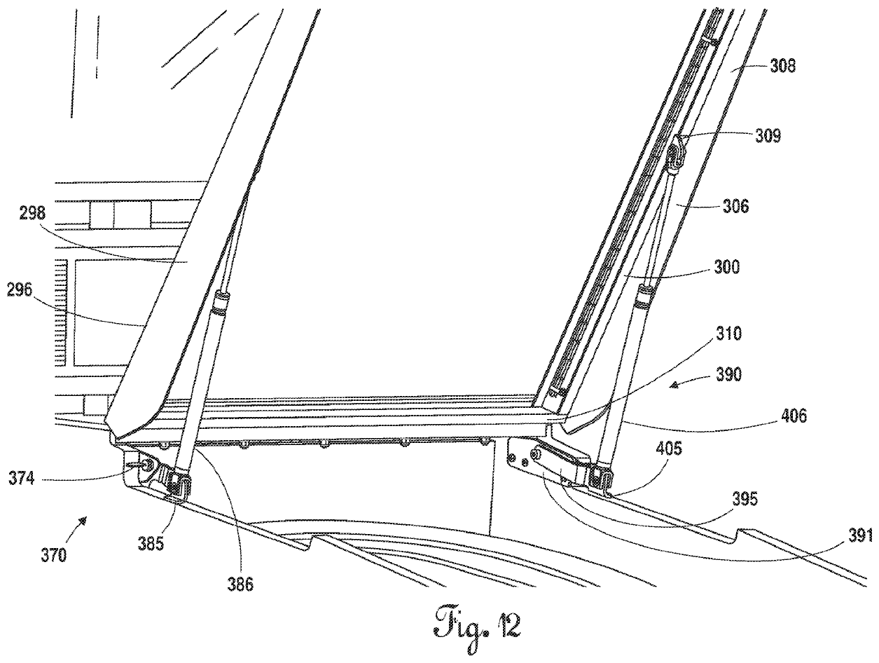

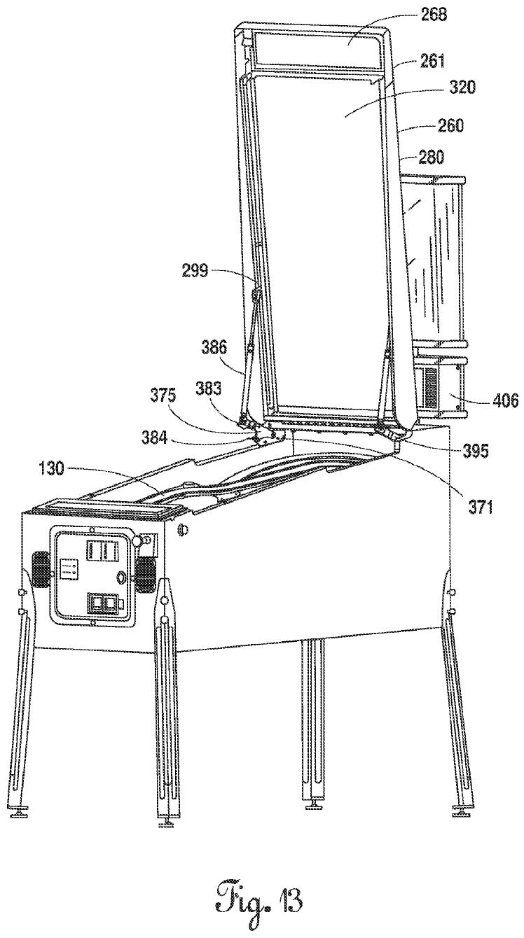

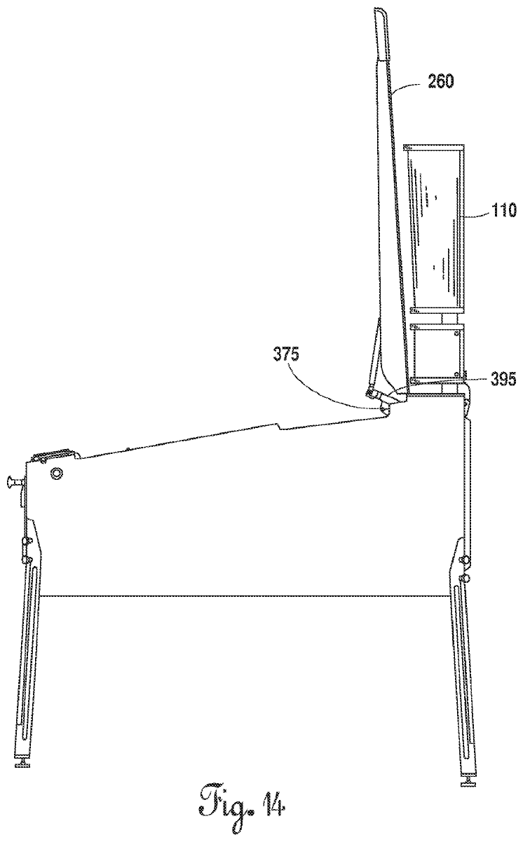

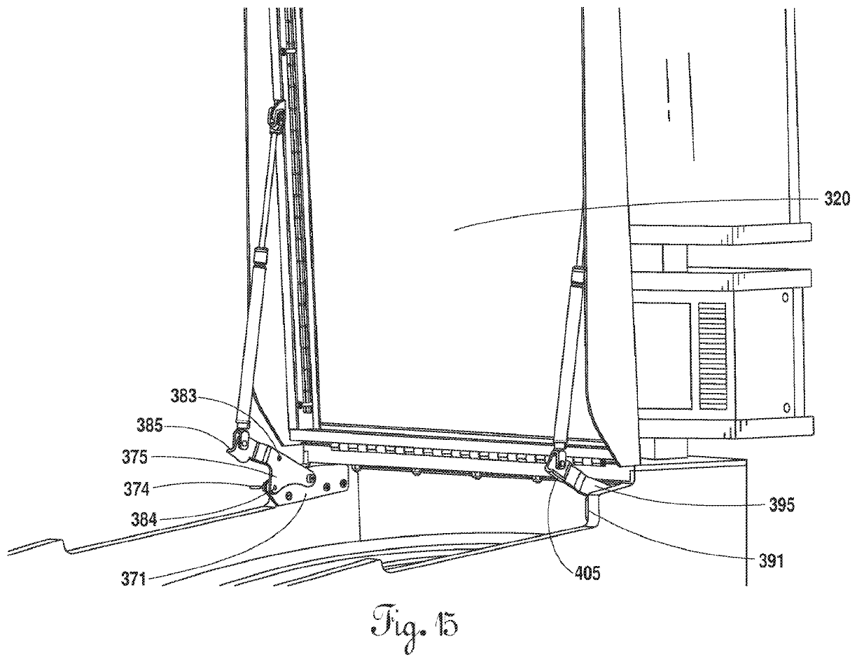

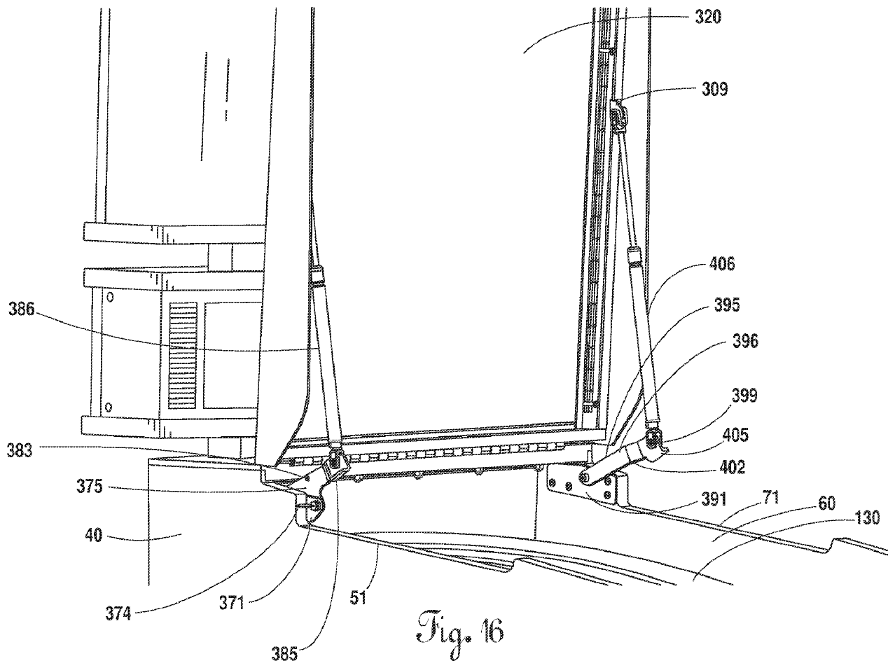

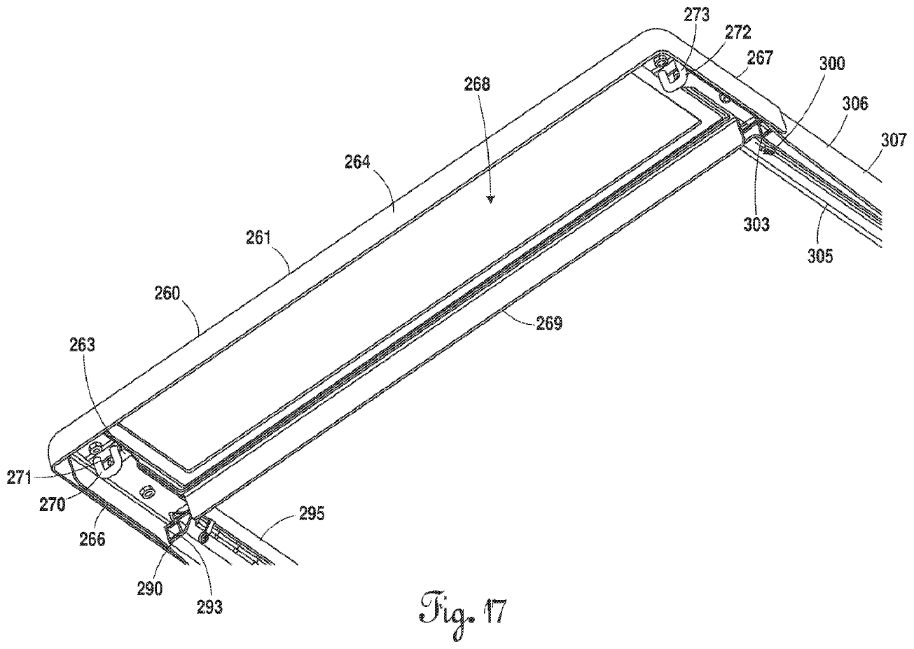

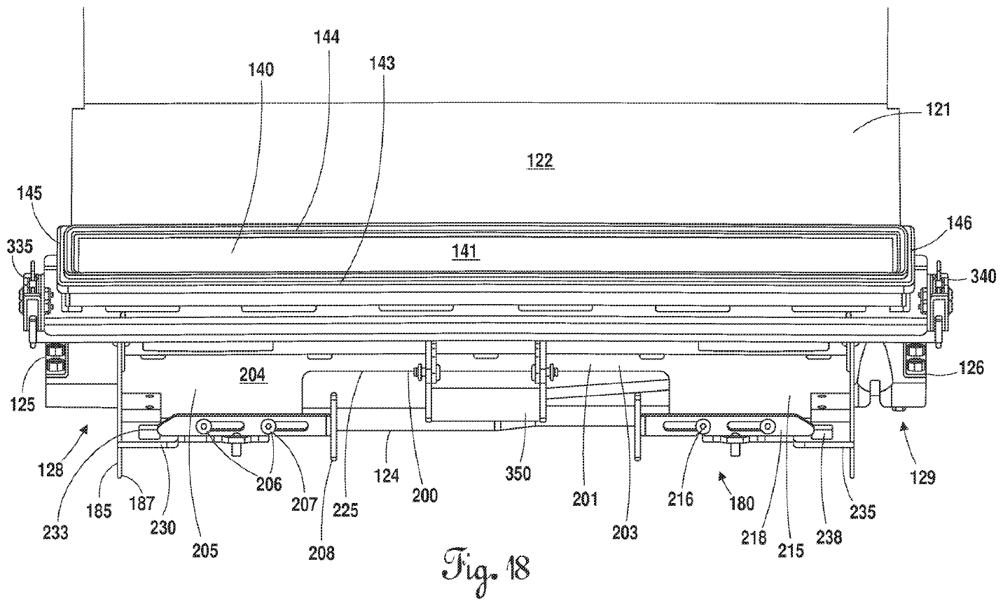

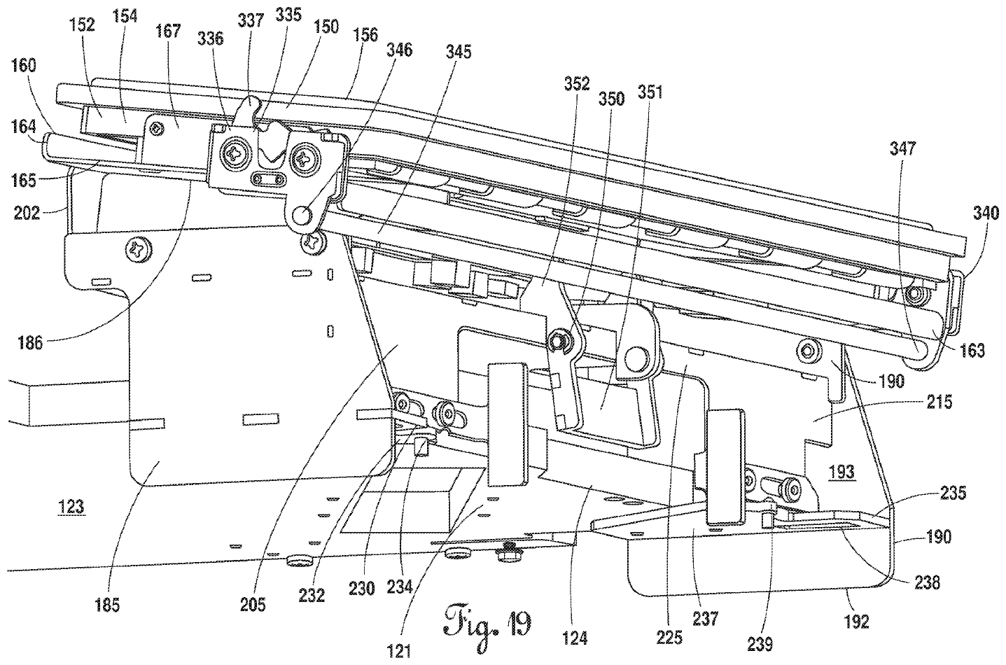

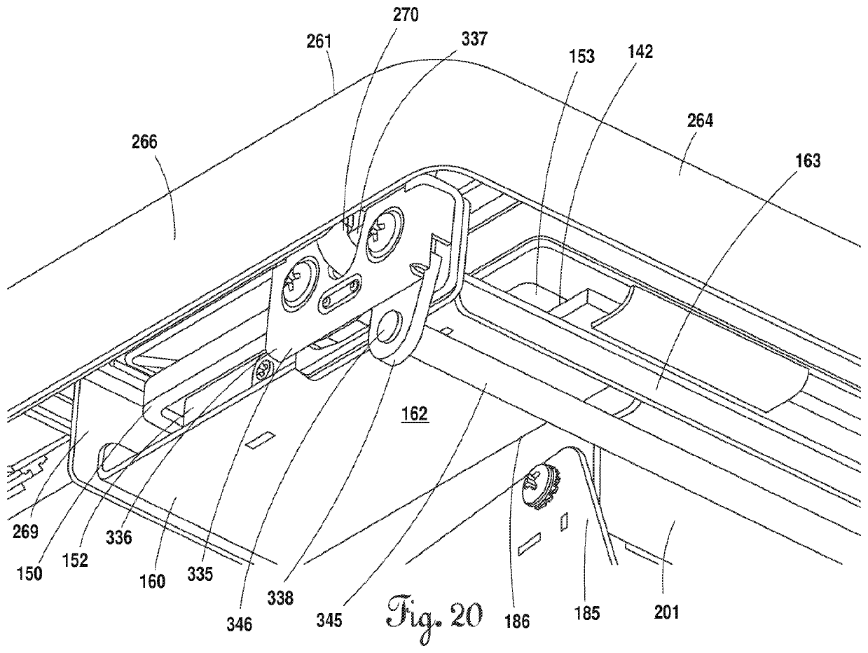

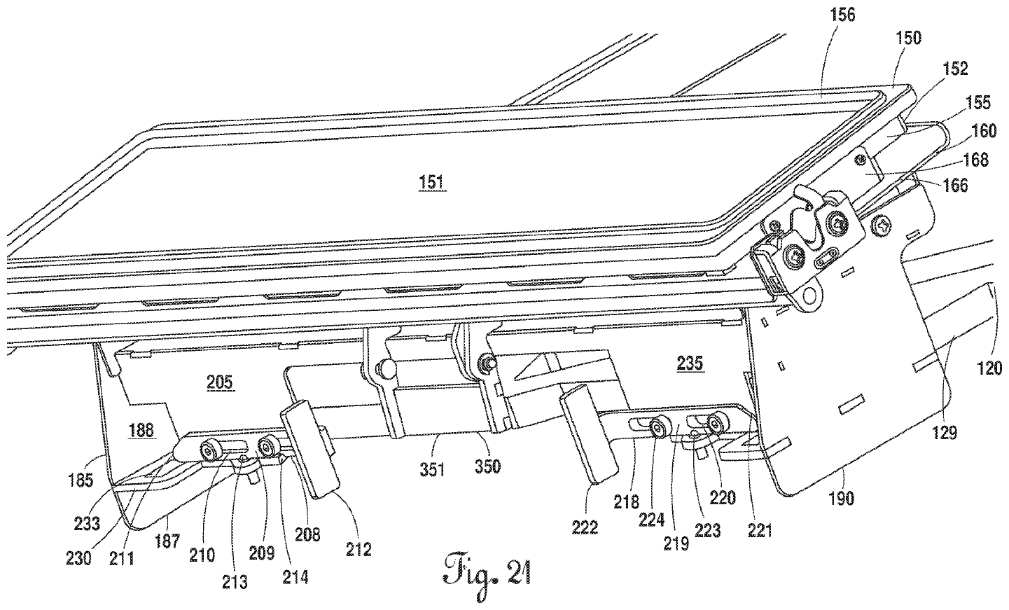

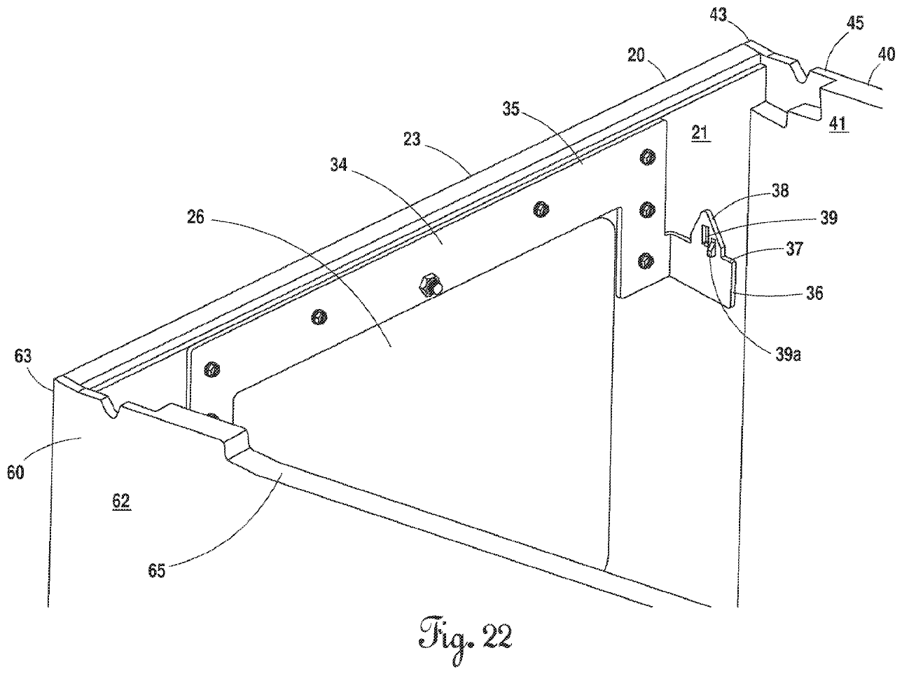

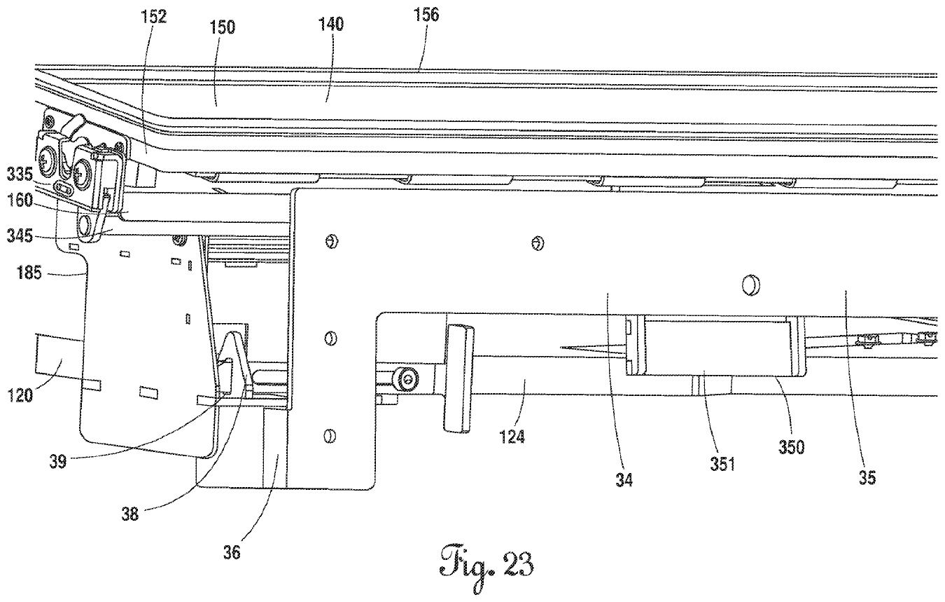

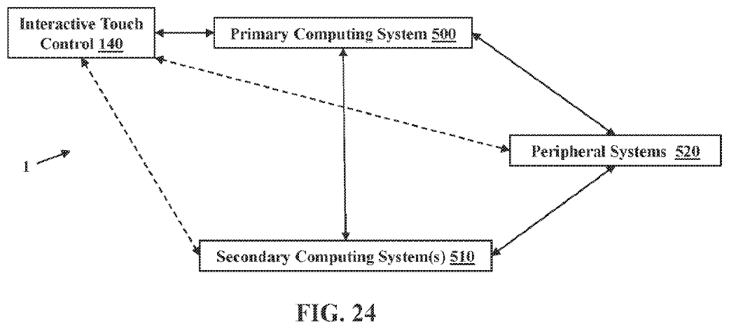

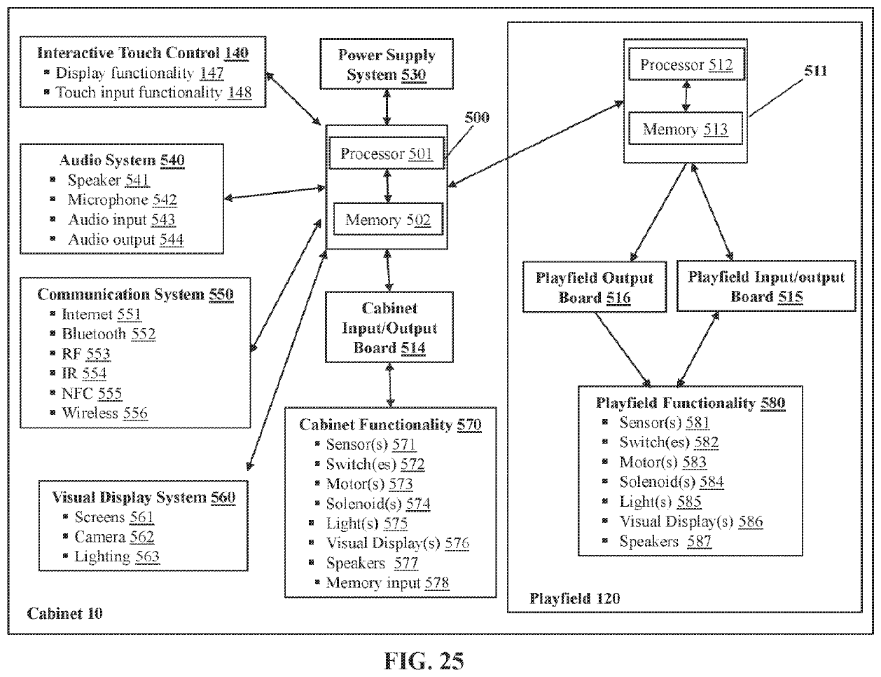

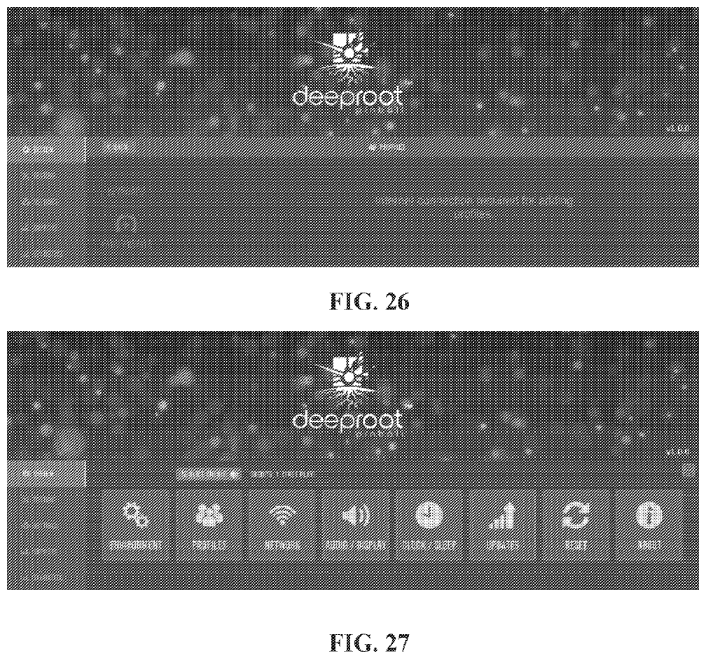

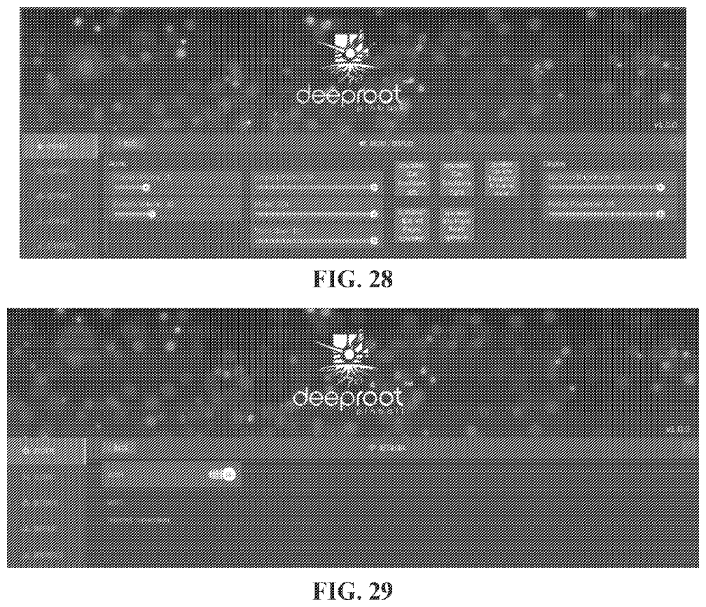

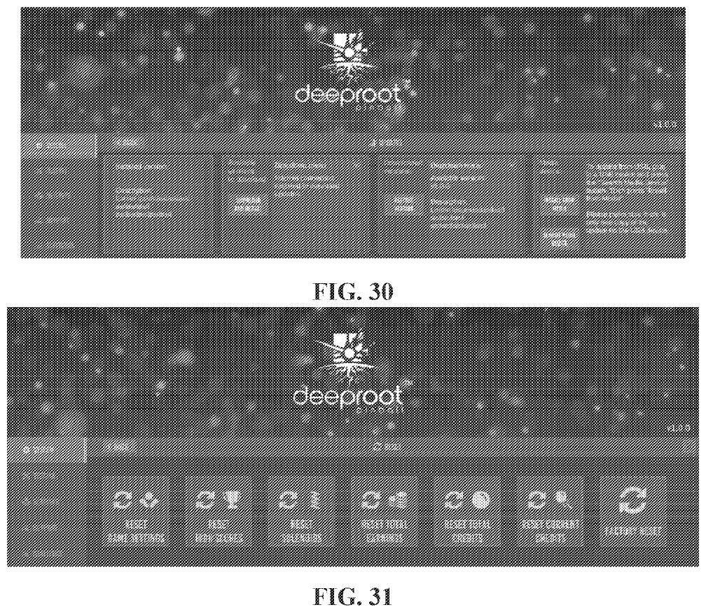

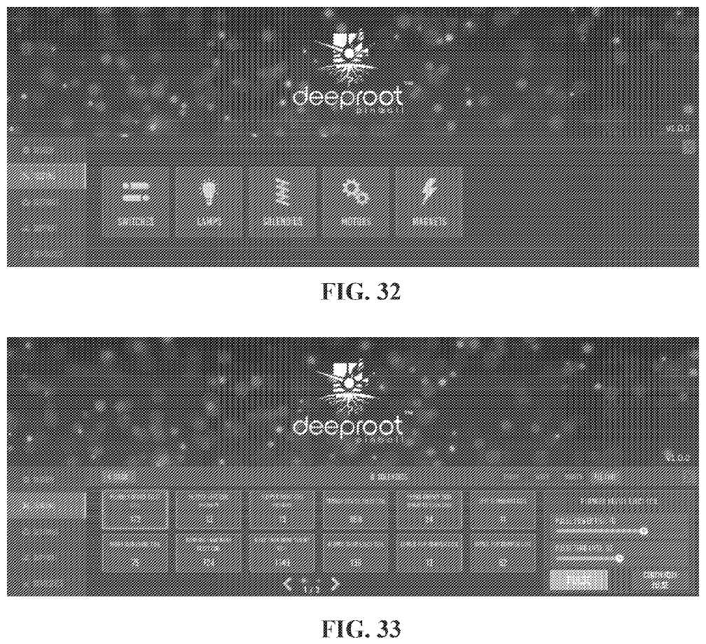

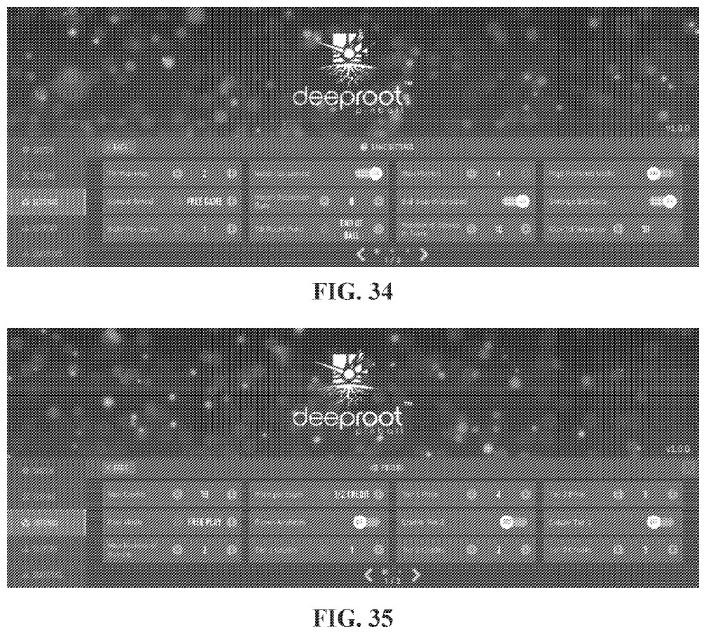

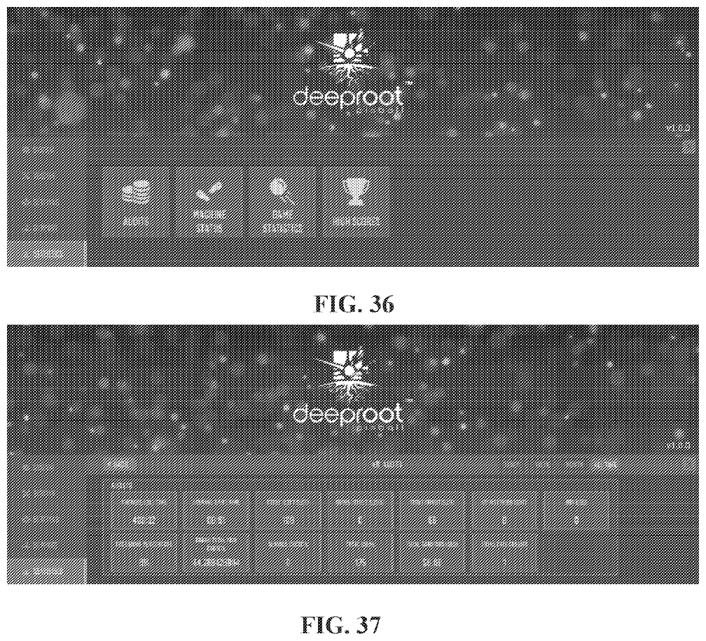

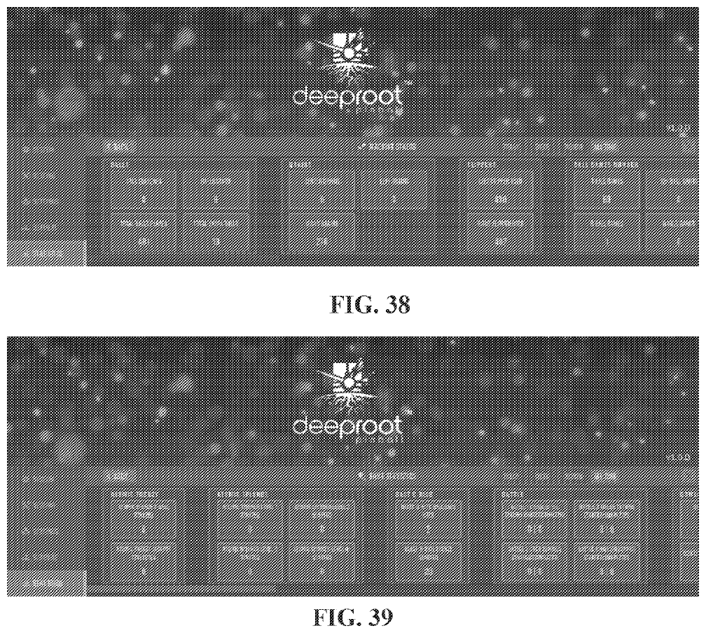

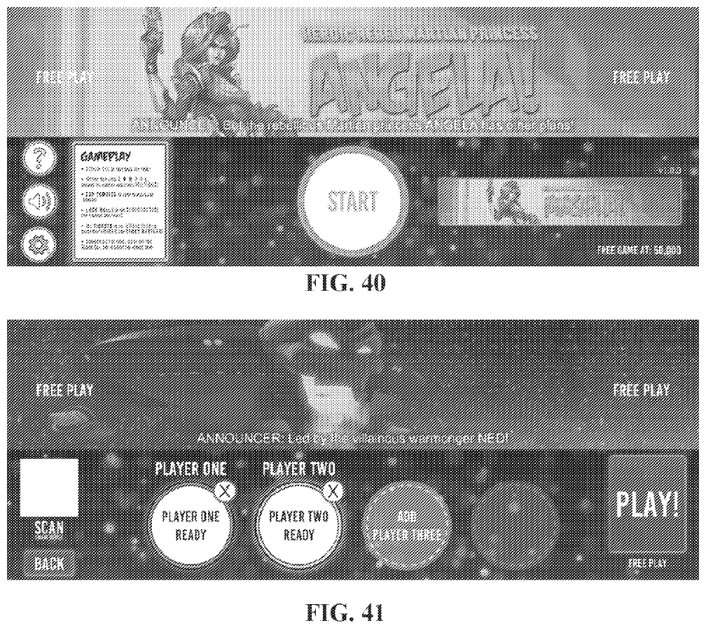

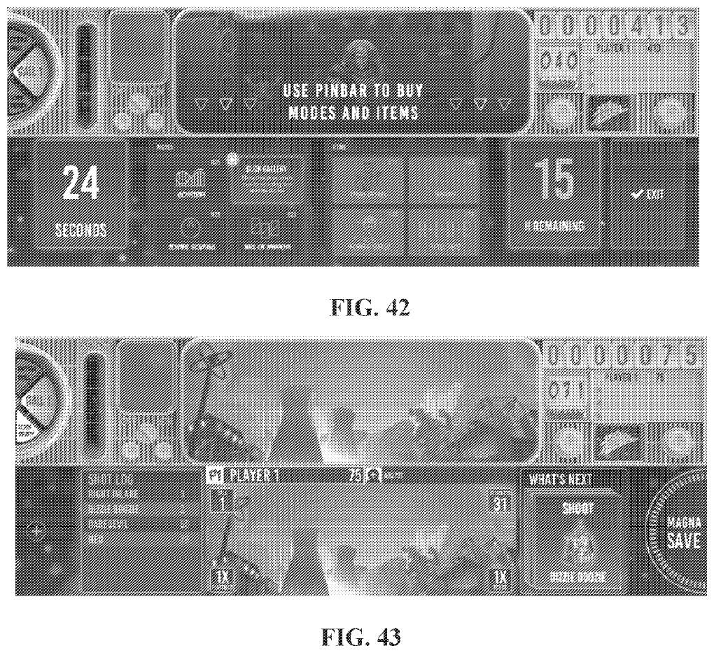

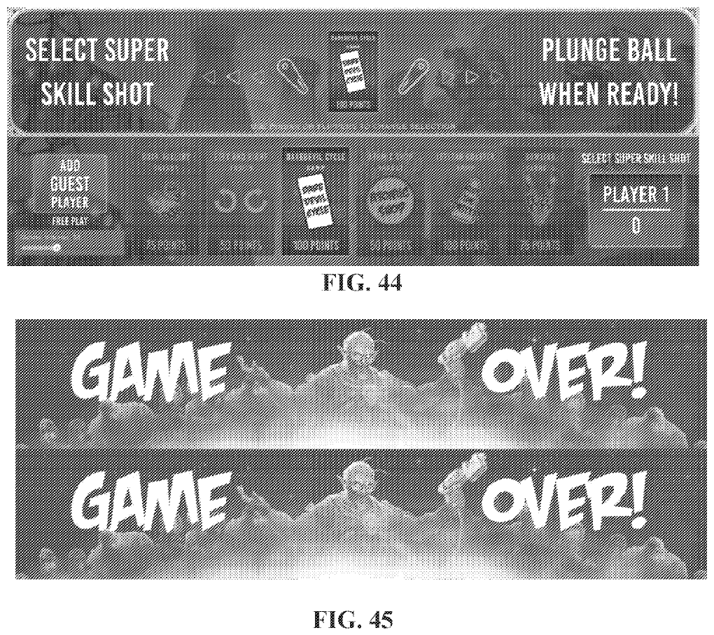

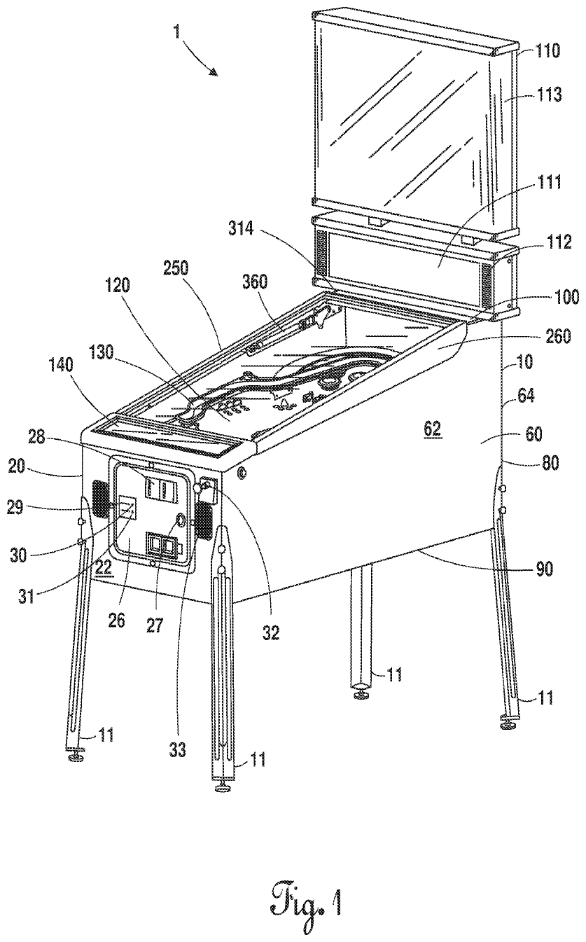

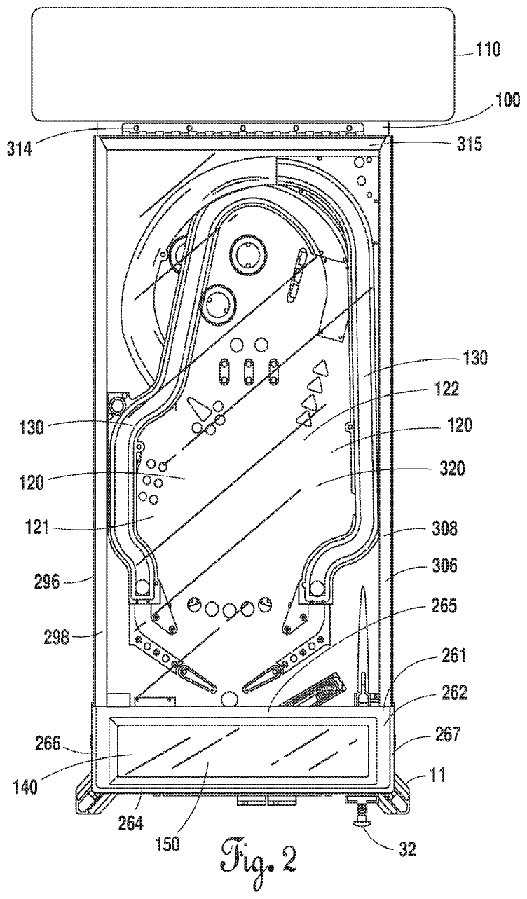

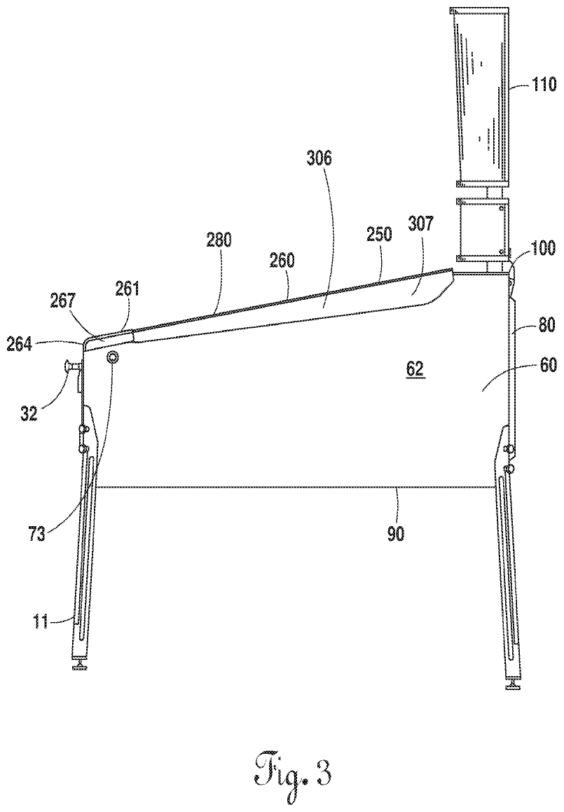

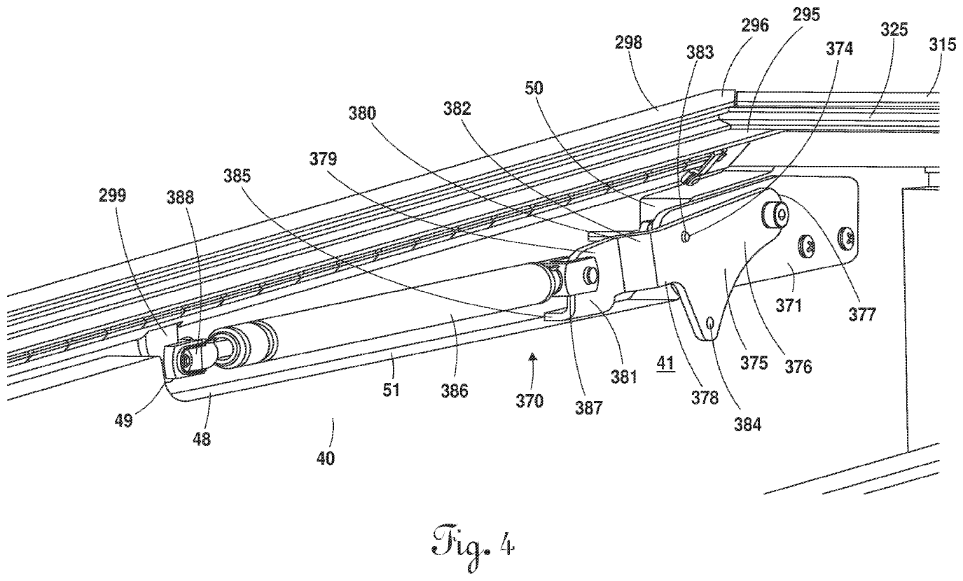

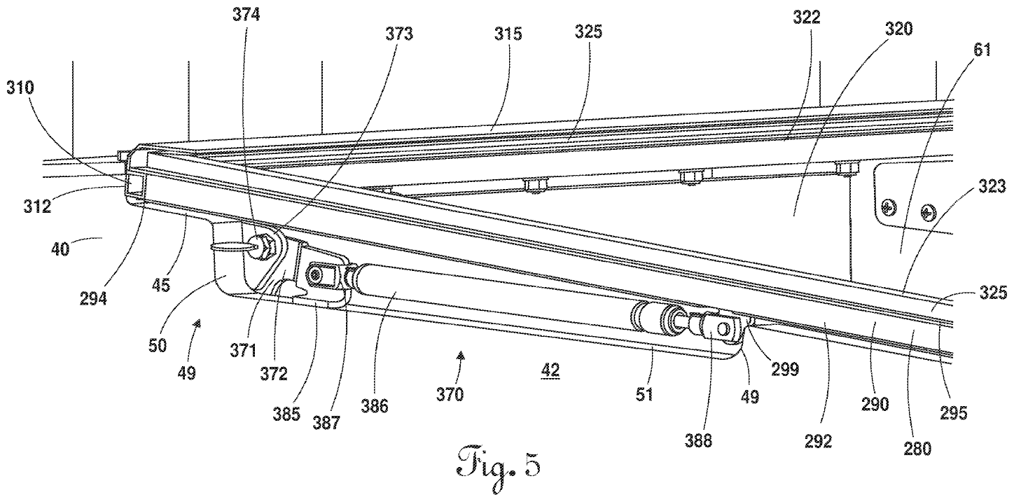

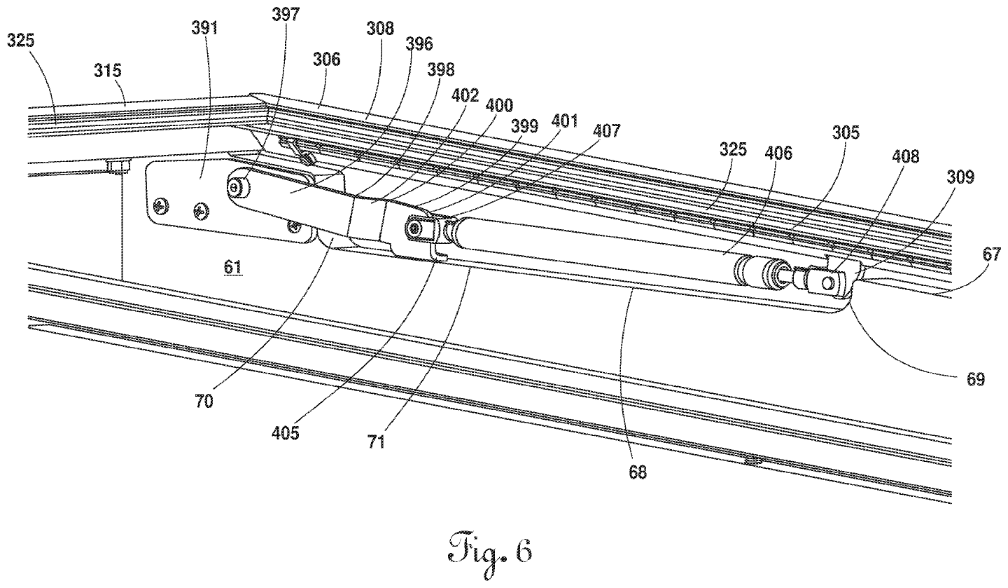

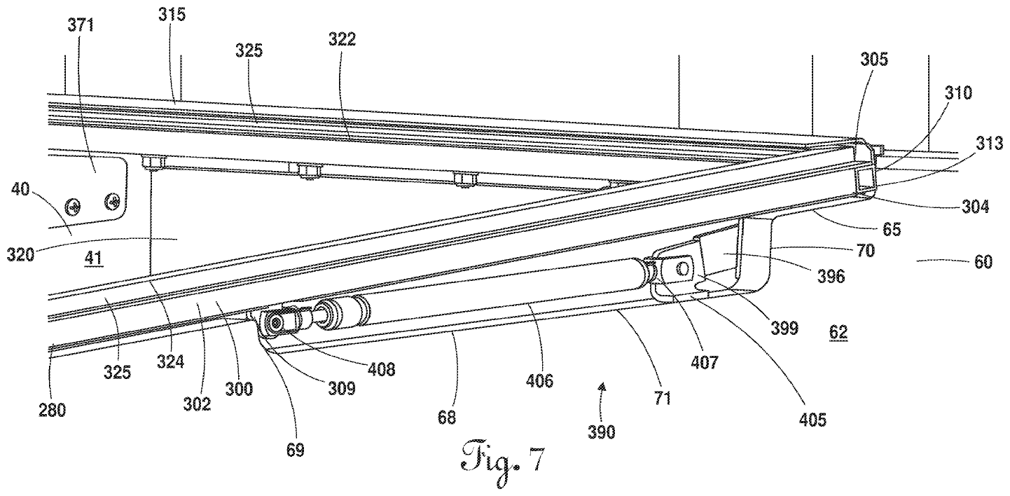

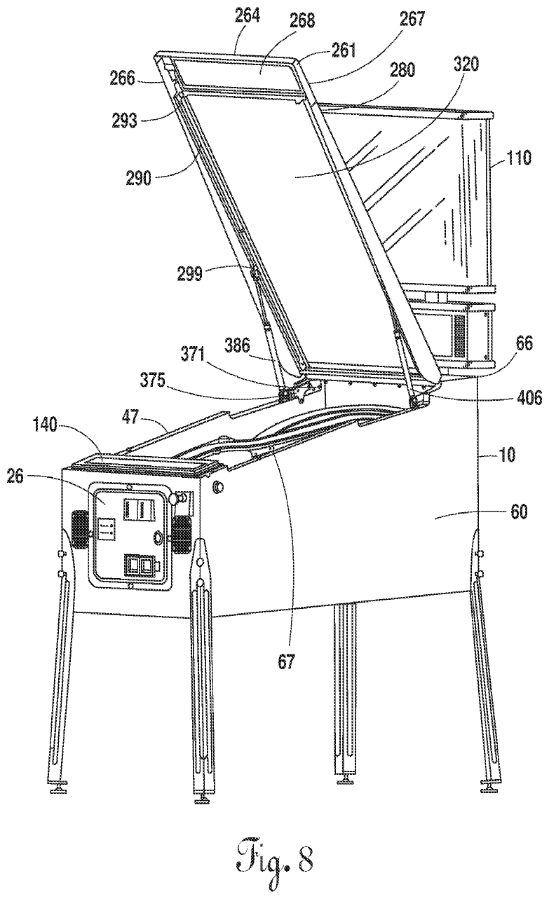

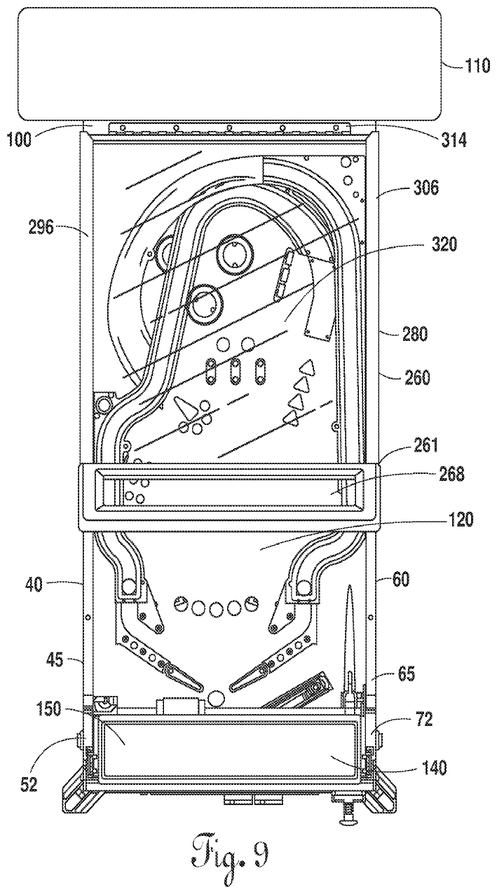

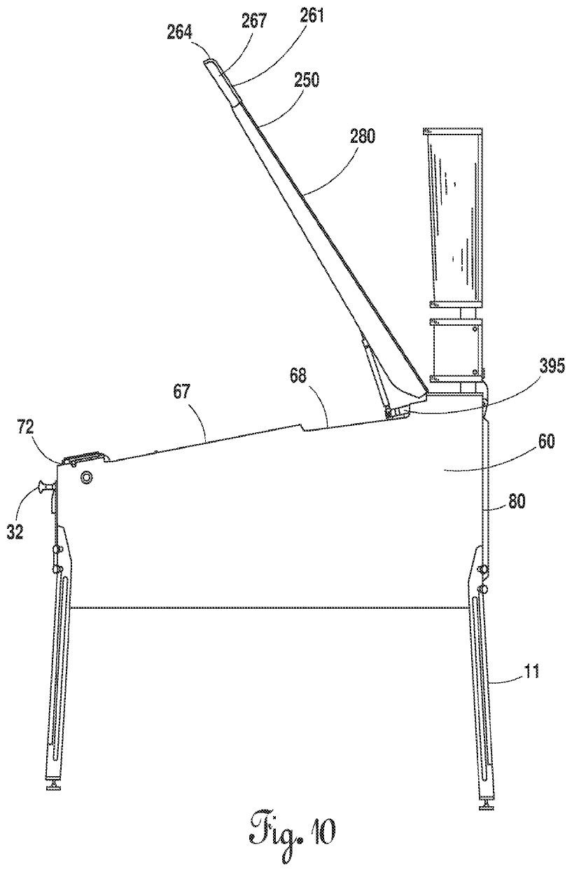

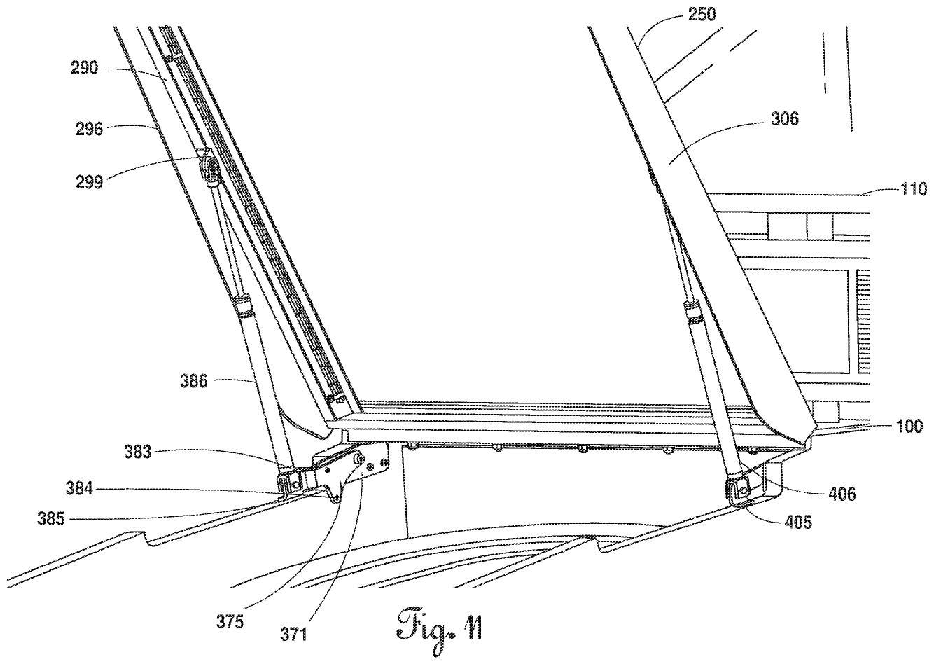

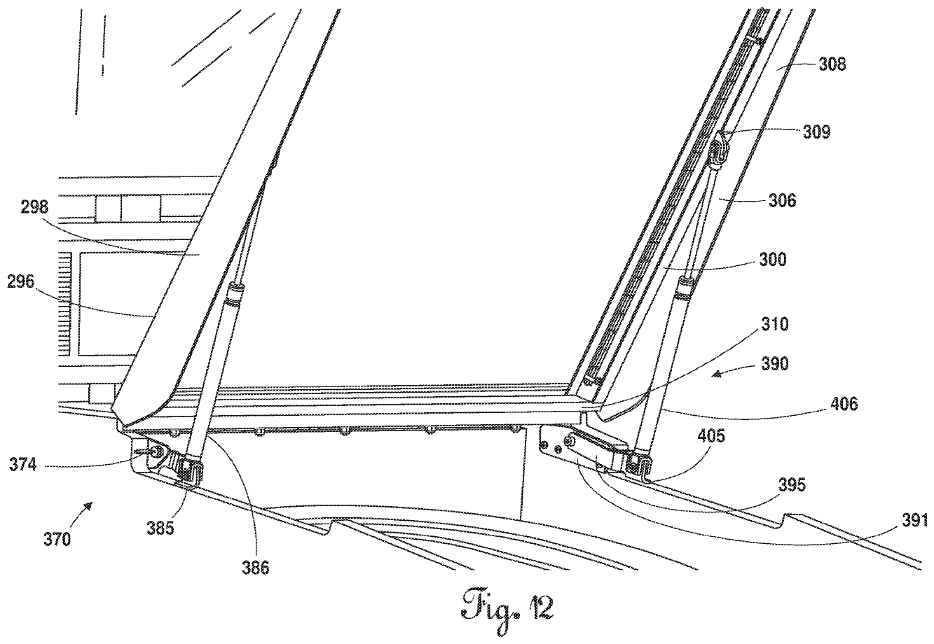

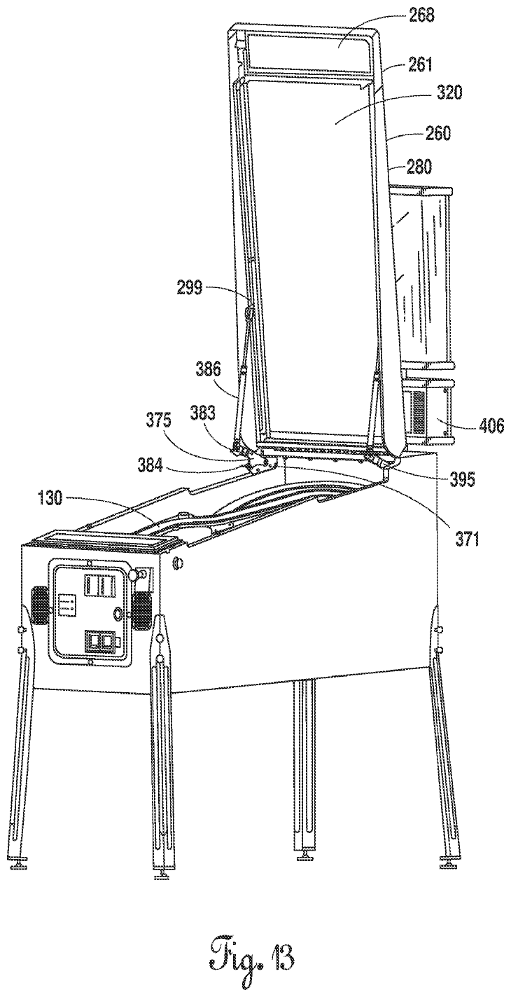

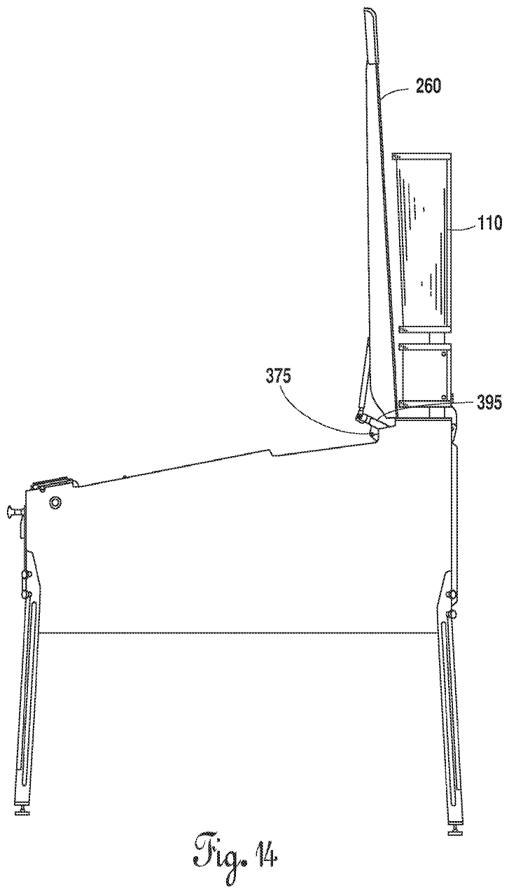

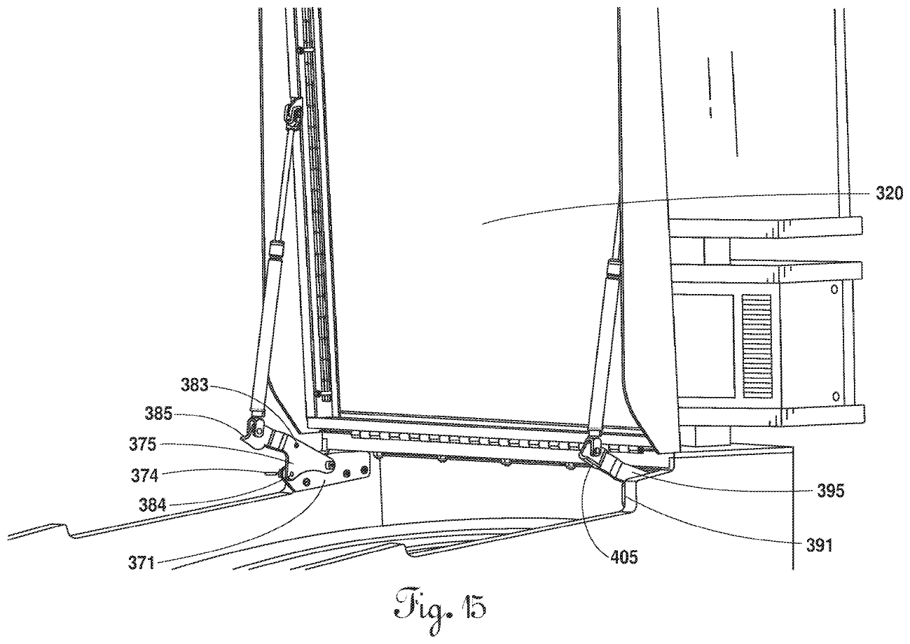

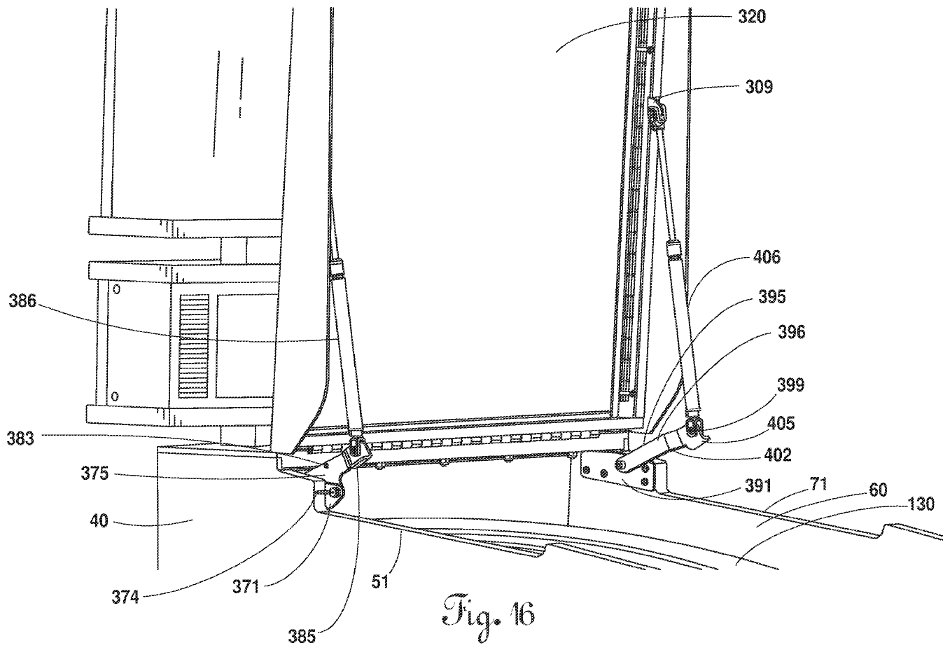

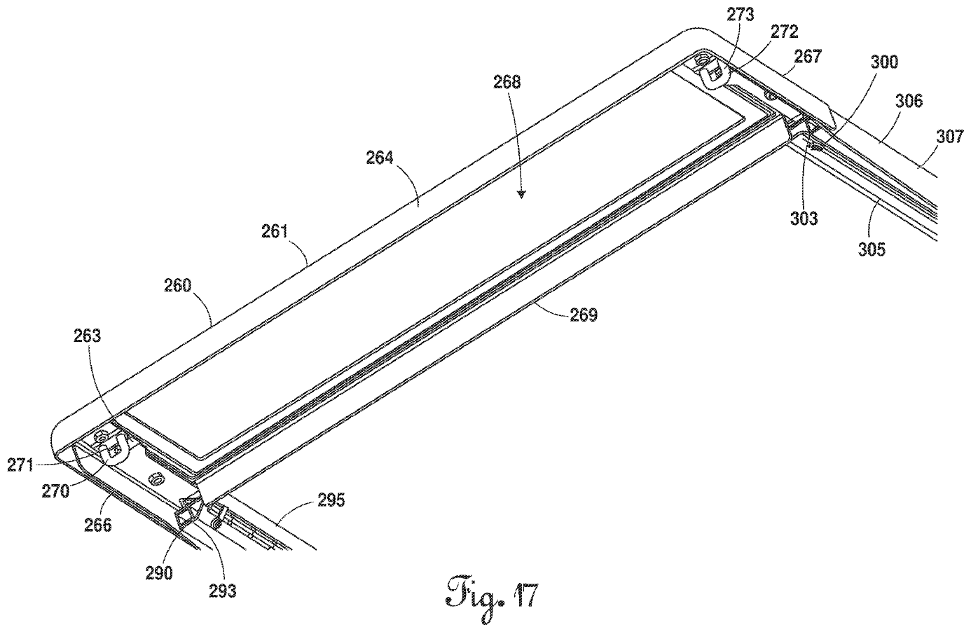

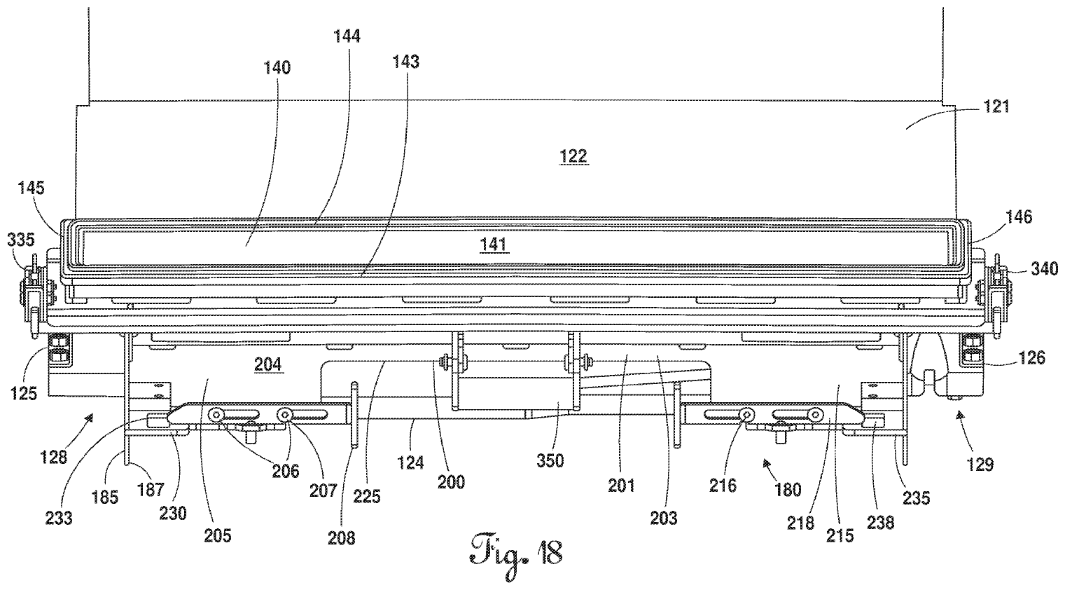

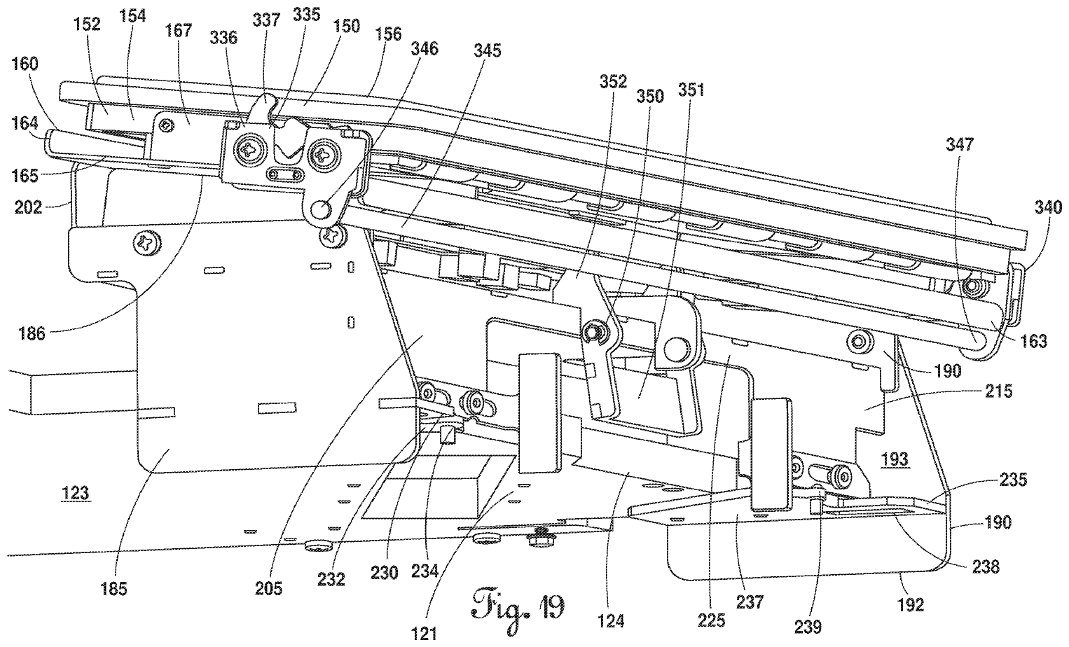

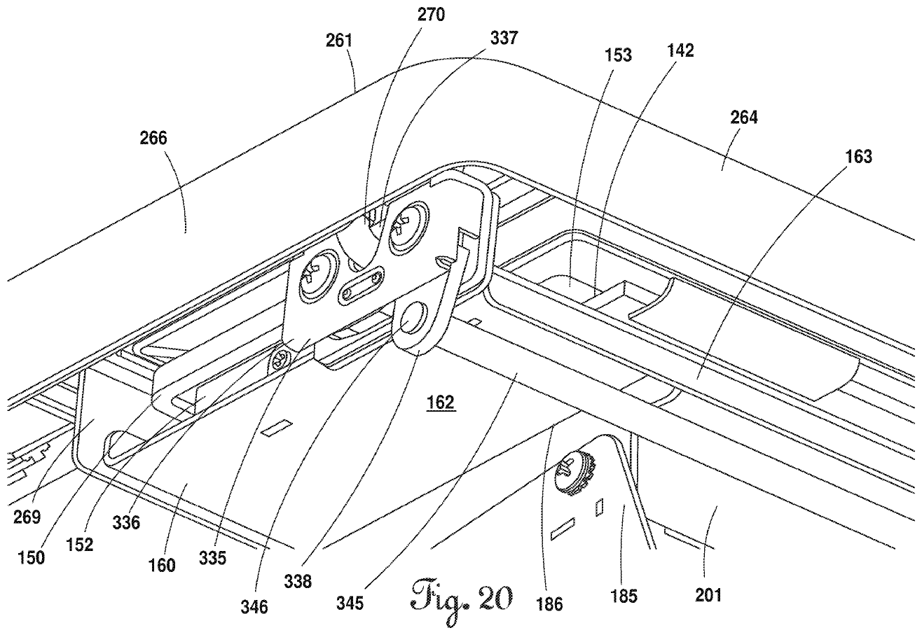

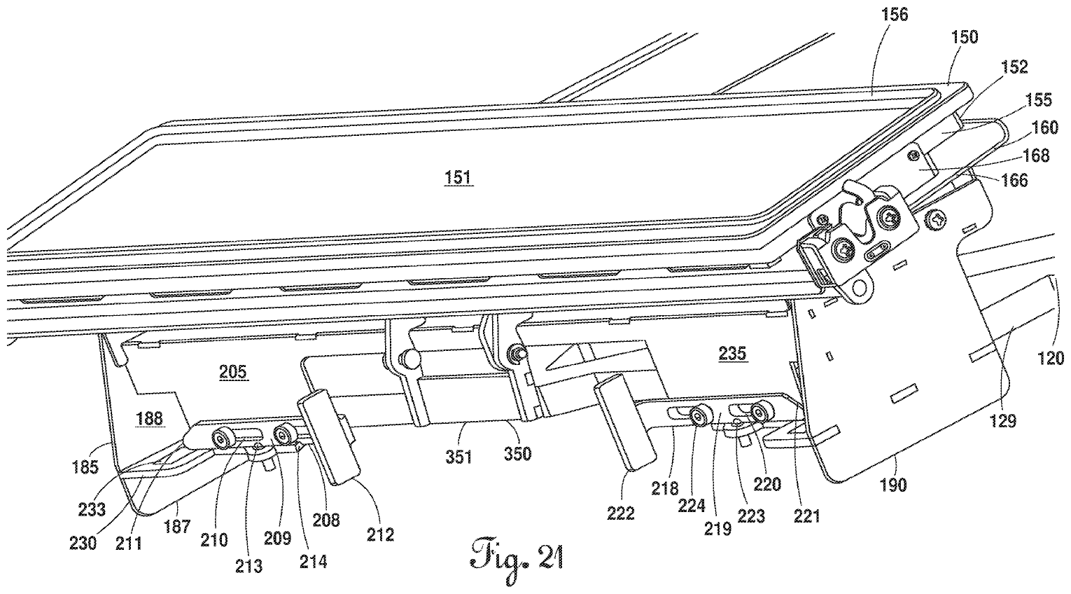

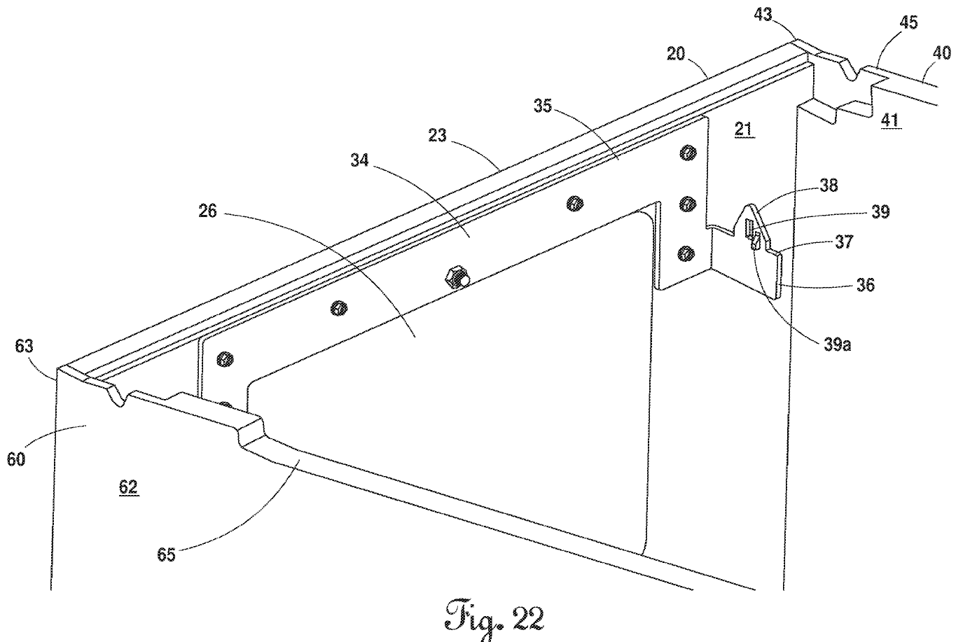

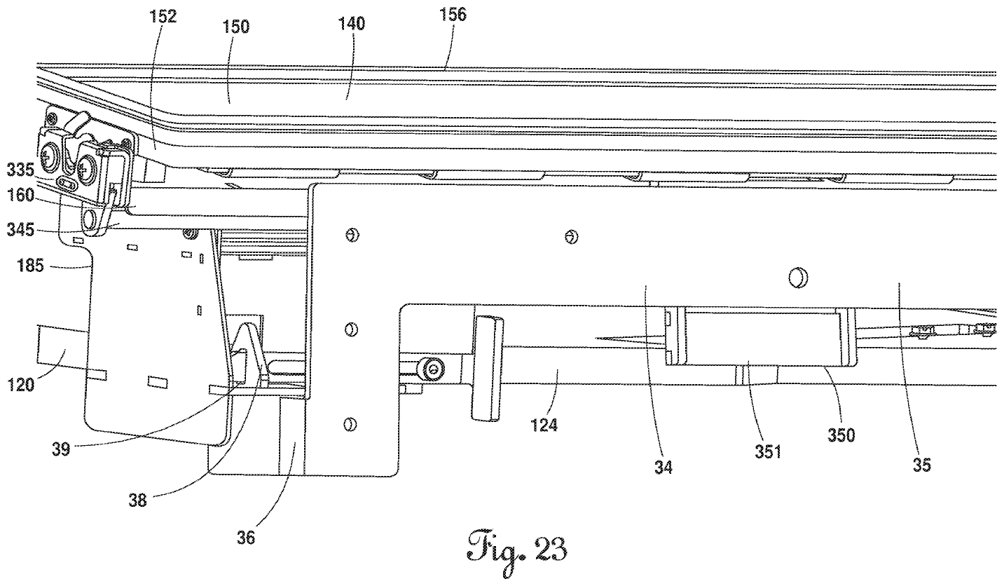

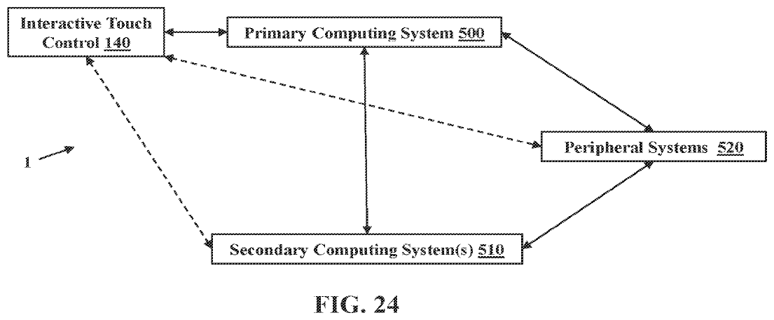

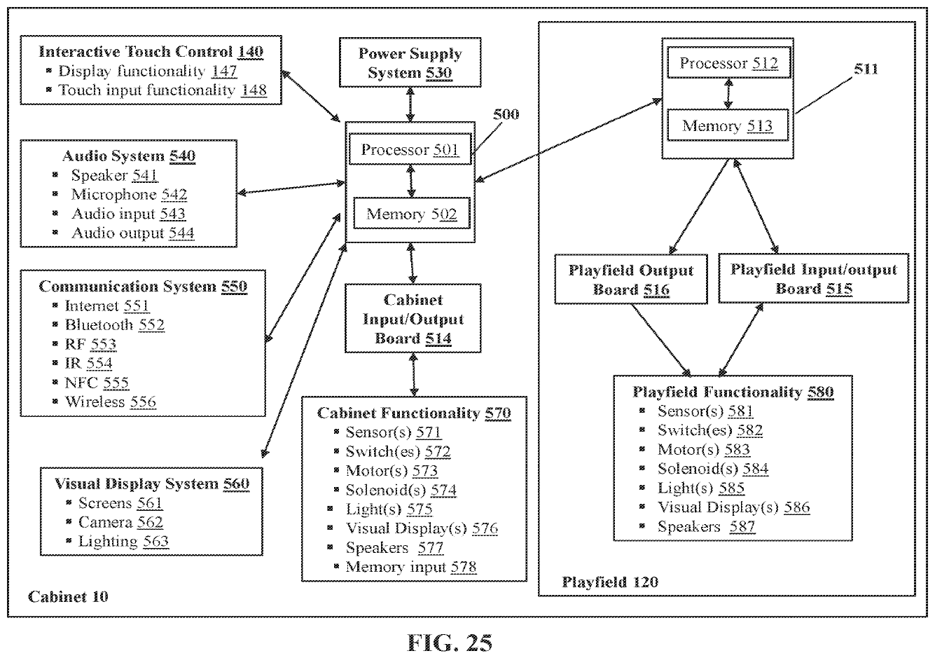

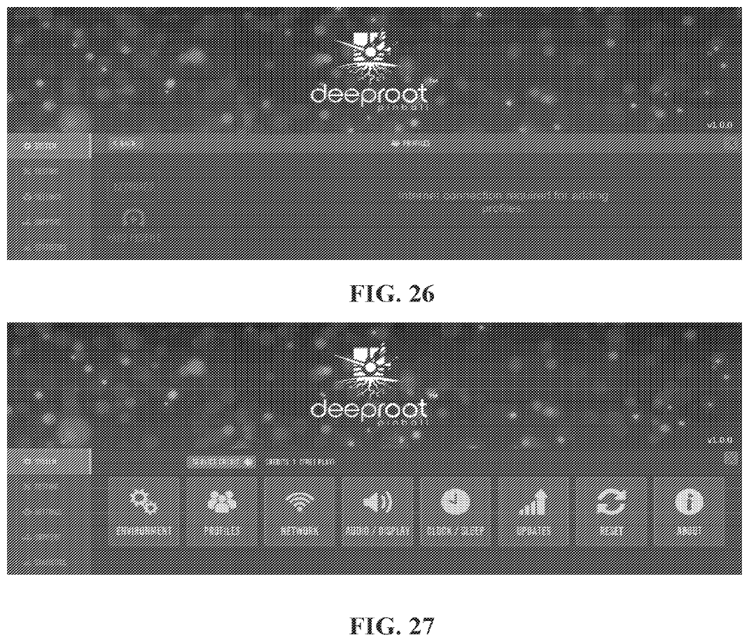

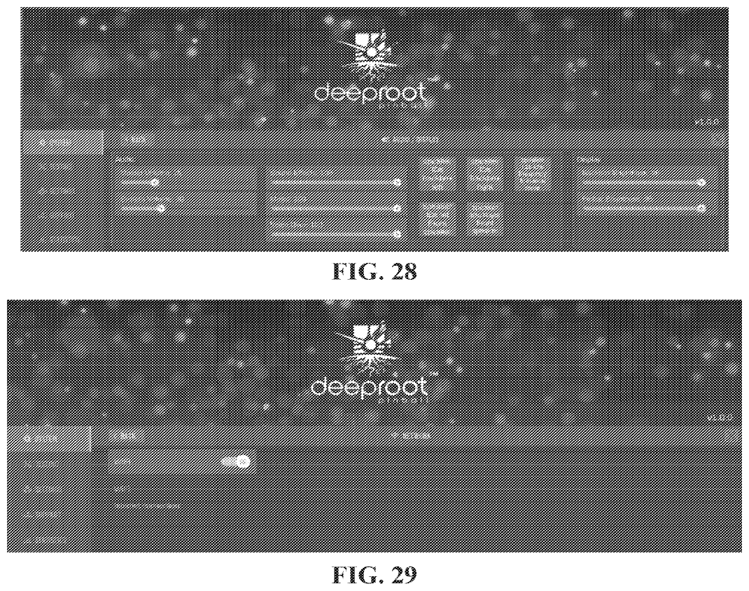

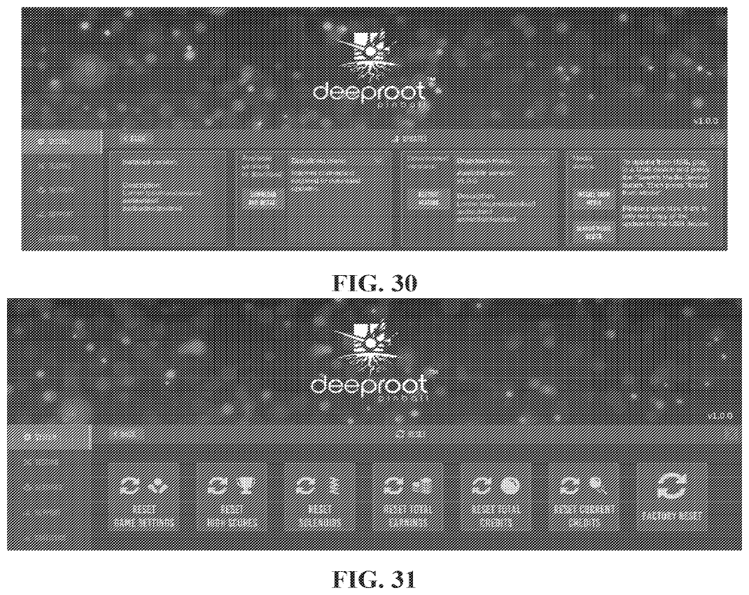

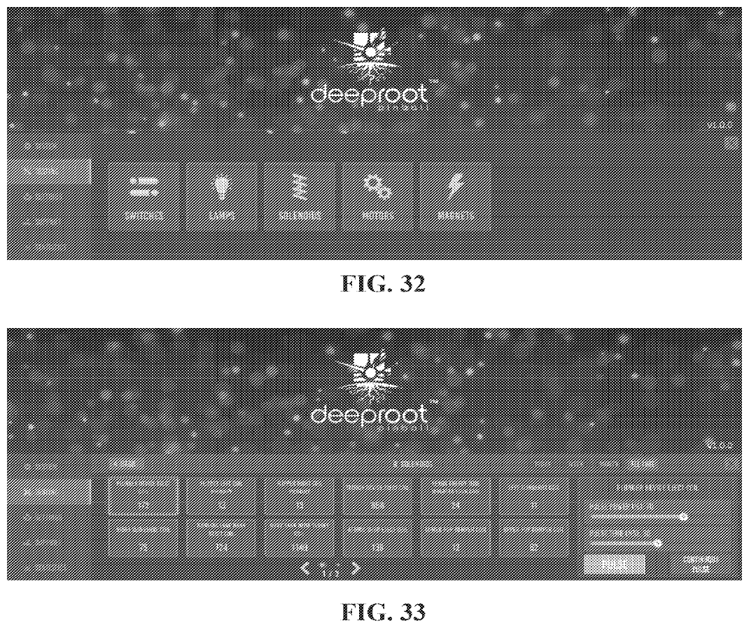

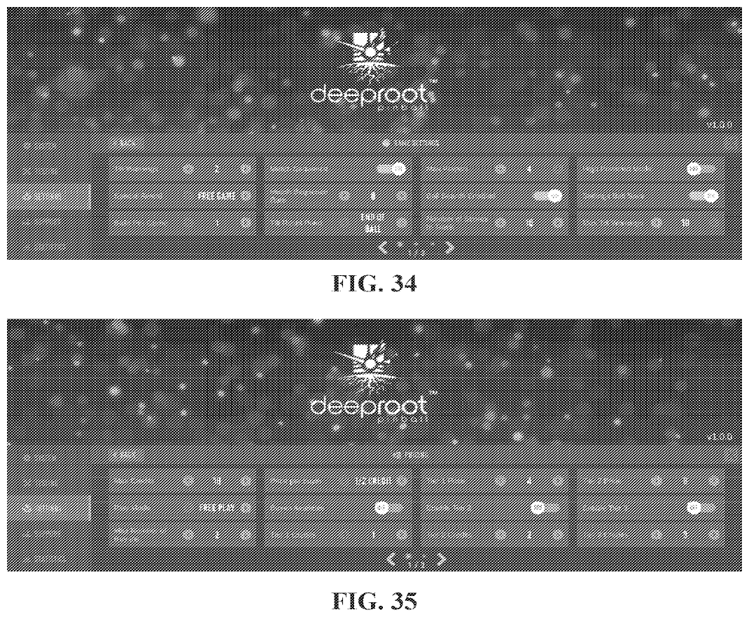

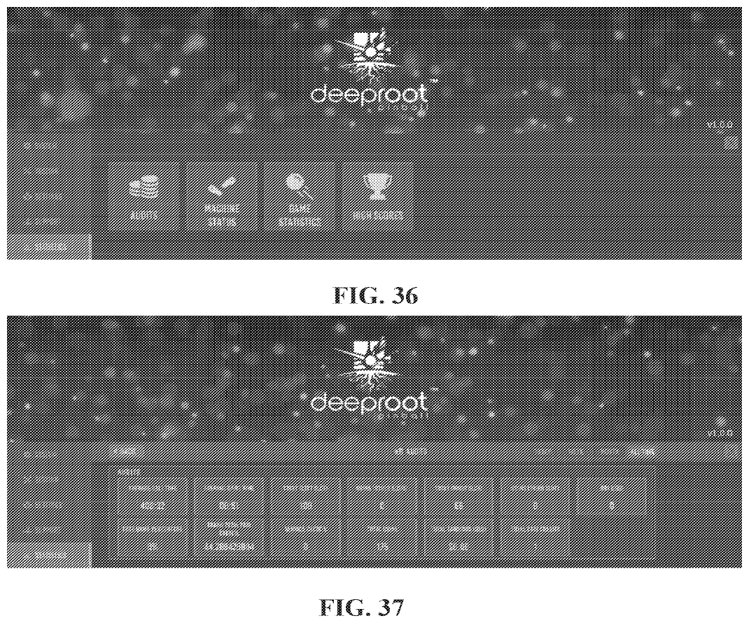

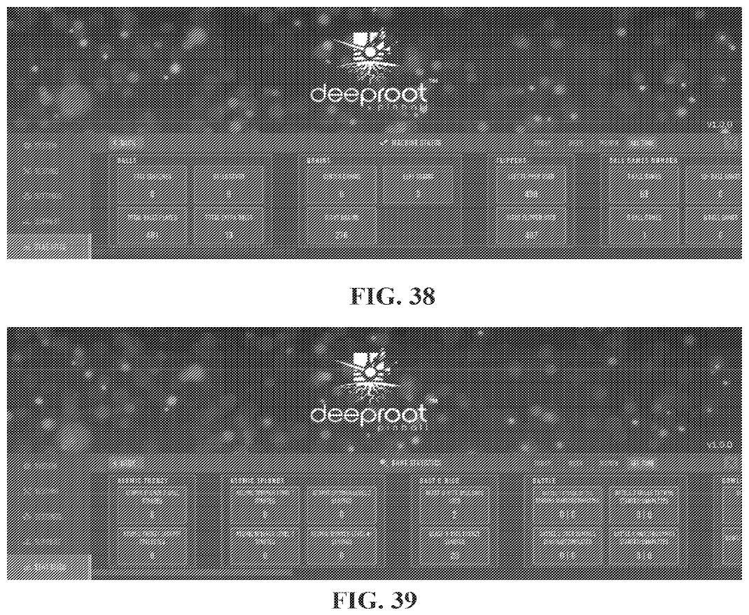

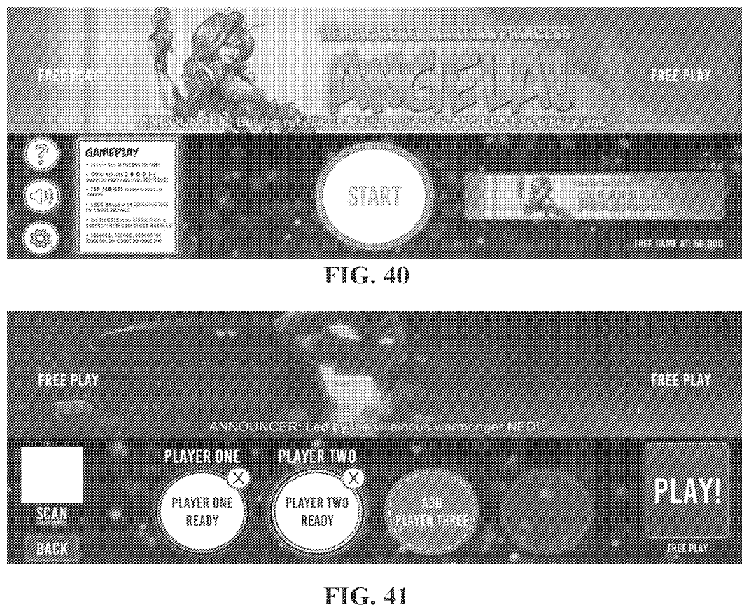

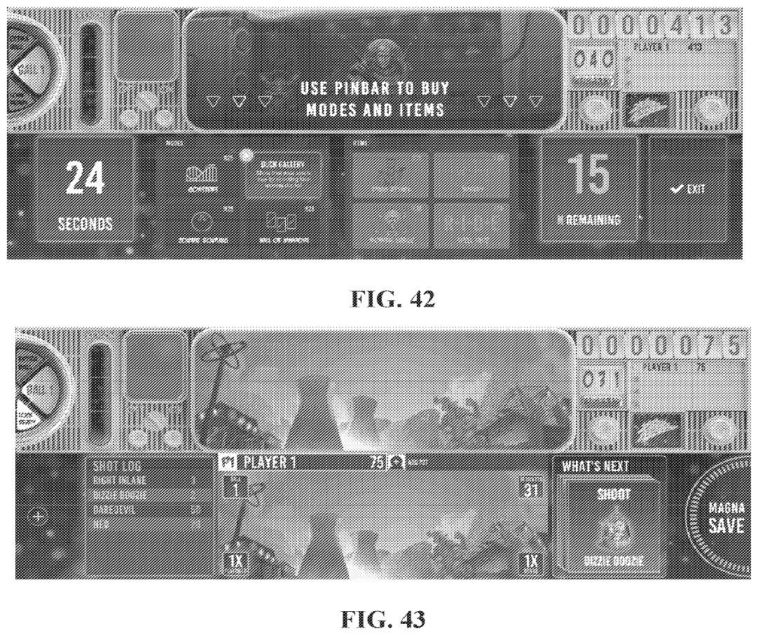

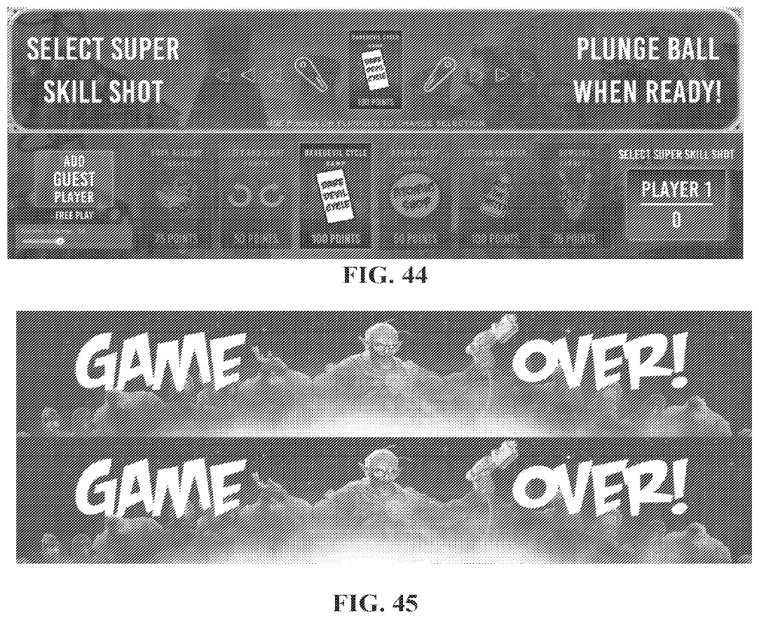

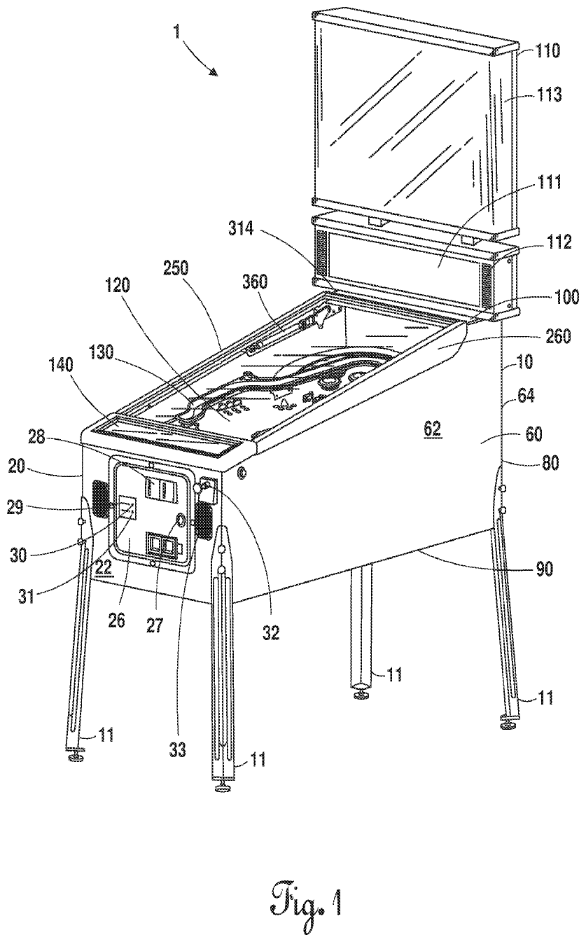

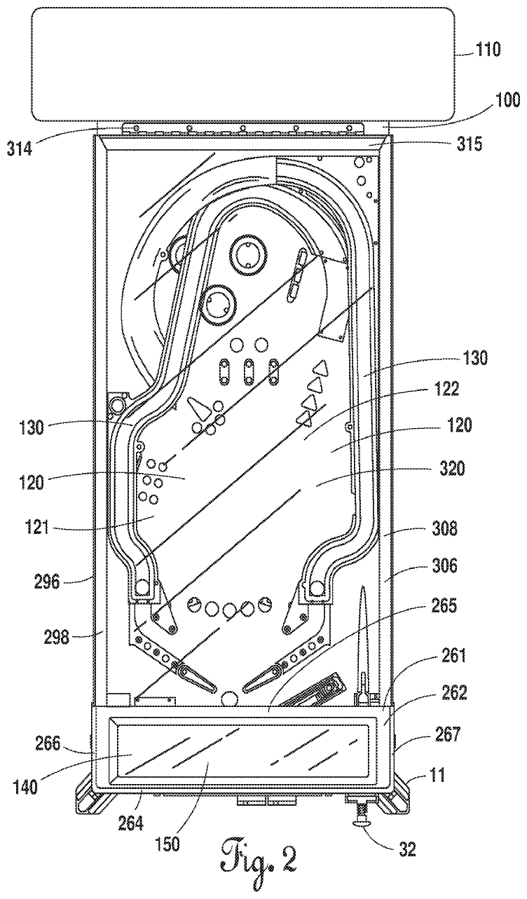

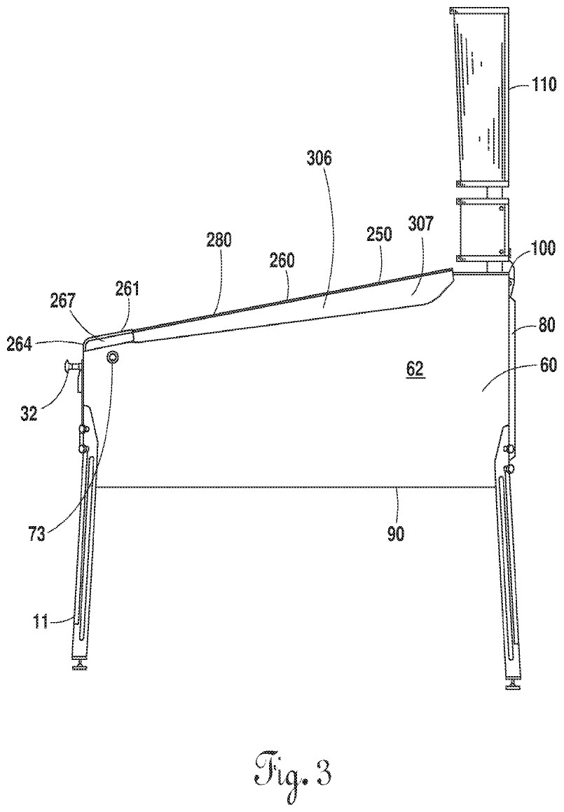

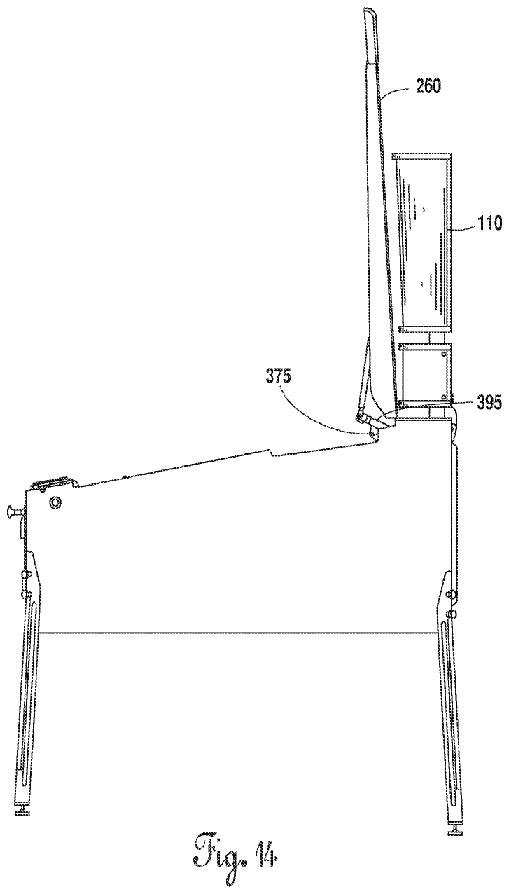

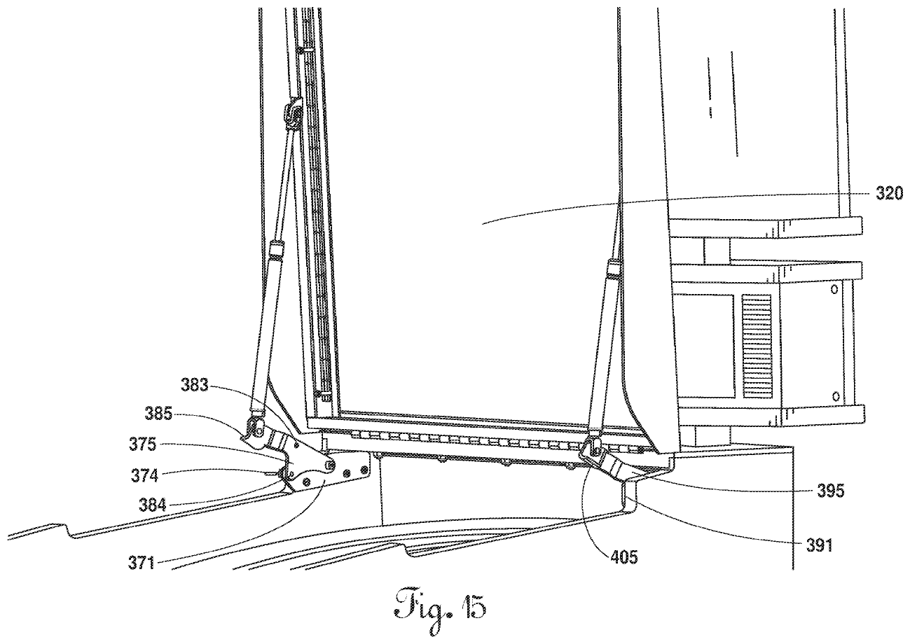

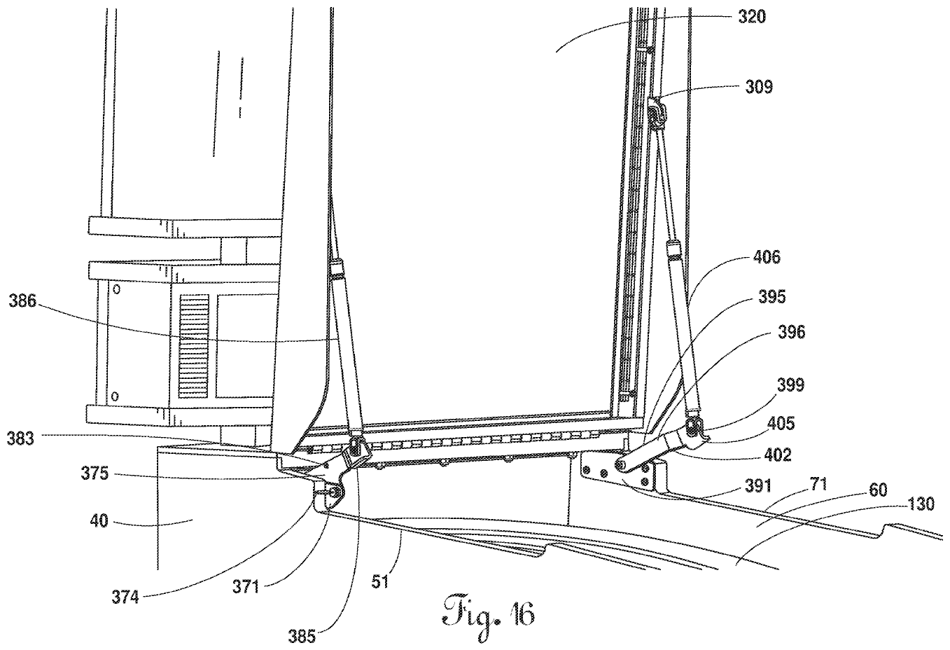

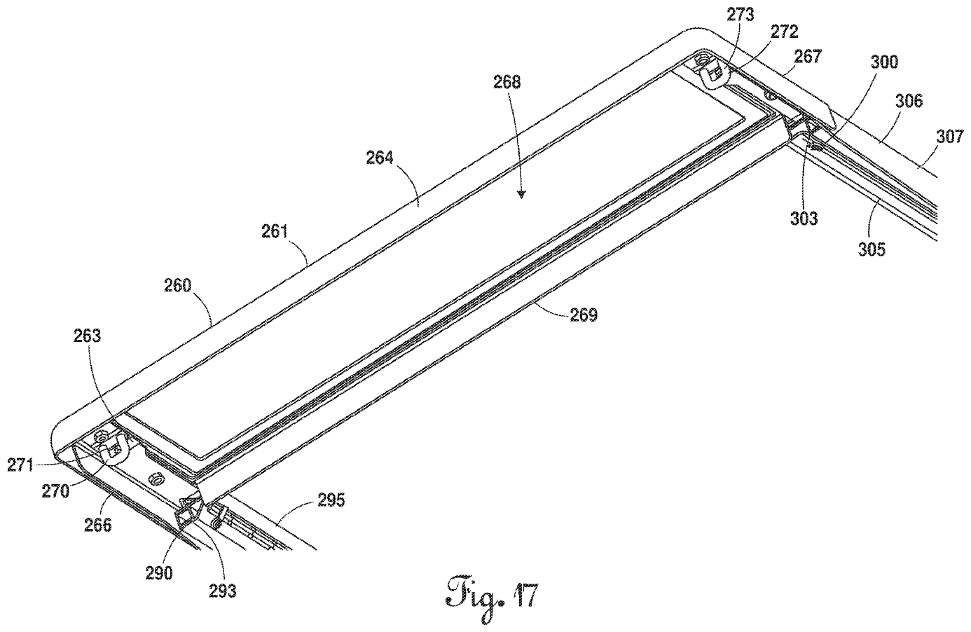

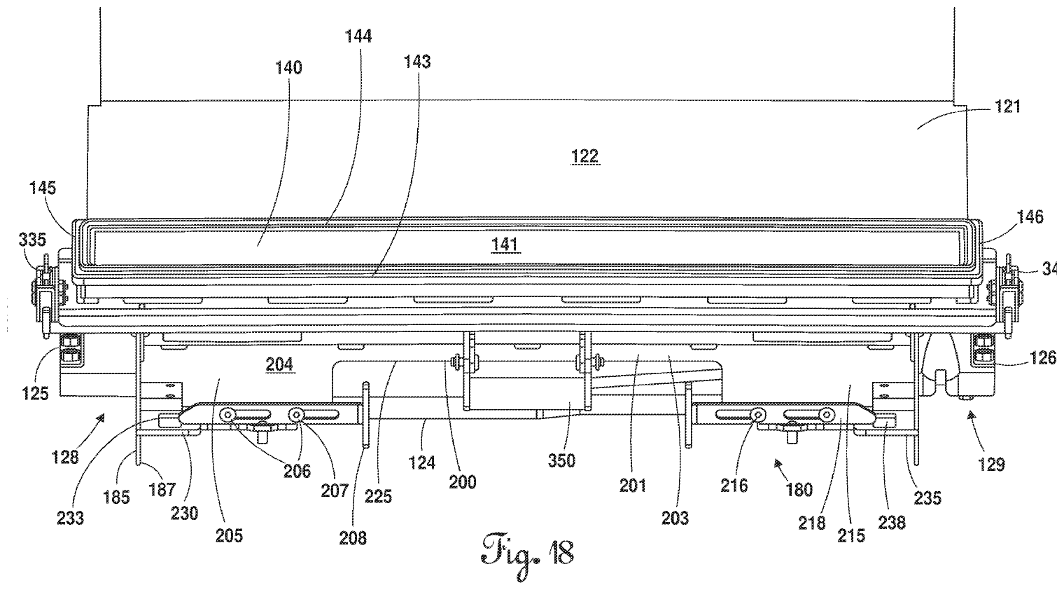

One embodiment of the present invention is shown in reference to the FIGS. As seen in FIGS. 1-19, a pinball game machine comprises a cabinet 10, back box 110, a playfield 120, an interactive touch control 140, and a glass top assembly 250.

The cabinet 10 is a generally rectangular shaped box supported by four legs 11. The cabinet 10 further comprises a front panel 20, a left side panel 40, a right side panel 60, a back panel 80, bottom panel 90, and top panel 100.

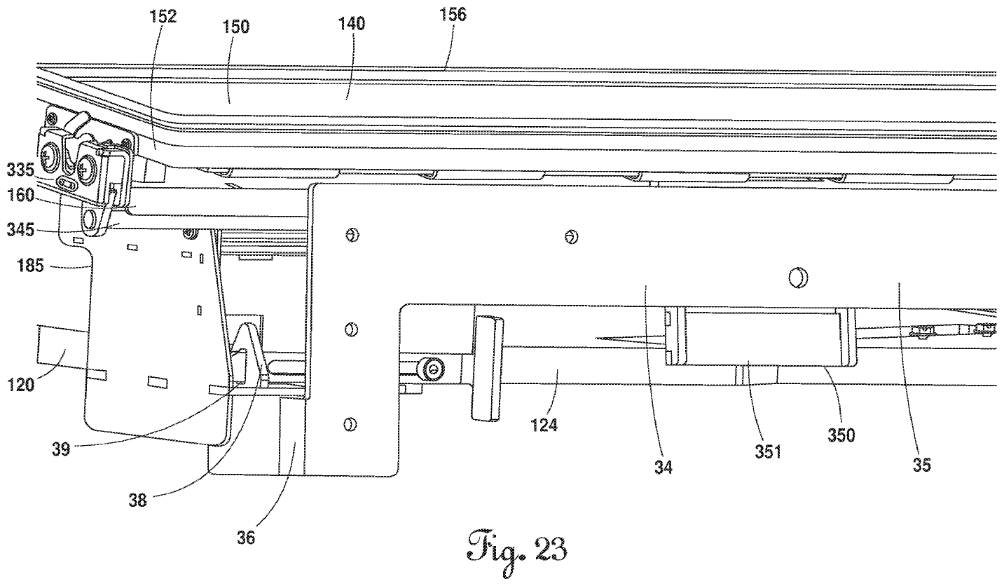

The front panel 20, having an interior surface 21 and exterior surface 22, is connected to the left side panel 40, right side panel 60, and bottom panel 90. A coin door 26 is positioned within the front panel 20 which when opened provides access to the interior of the cabinet 10. The coin door 26 further comprises a lock 27 to secure the interior of the cabinet 10, payment portion 28, a USB port 29, audio input 30, and audio output 31. Alternatively, the payment portion 28, a USB port 29, audio input 30, and audio output 31 may not be located on the coin door and instead placed on other places of the cabinet such as the front panel 20, left panel 40, or right panel 60. The payment portion 28 may be a coin receptacle, electronic card processor, scanner, or other payment processing means. The front panel 20 further comprises a plunger 32 positioned near the top right portion and may include at least one speaker 33. As seen in FIG. 23, a bracket 34 is mounted to the interior surface 21 of the front panel 20. The bracket 34 comprises a flat U-shaped portion 35 that is positioned around the coin door 26 with two arms 36 extending perpendicular from interior surface 21. Each arm 36 has a flat top surface 37 and a triangular portion 38 extending upwards from the top surface 37. A vertical slot 39 is disposed through the triangular portion 38. An alignment tab 39a is positioned on the triangular portion 38 and is positioned between the vertical slot 39 and the end of the arm 36. The alignment tab 39a of each arm 36 oppose each other. The bracket 34 is preferably constructed of metal or a high strength material.

The left panel 40, having an interior surface 41 and exterior surface 42, is connected to the front panel 20, back panel 80, bottom panel 90, and top panel 100. The left panel 40 connects to the front panel 20 at the front edge 43 and connects to the back panel 80 at the back edge 44. The top edge 45 of the left panel 40 comprises a flat edge 46 and a slanted edge 47. The flat edge 46 extends from the back edge 44 and is the portion that connects to the top panel 100. The slanted edge 47 extends from the flat edge 46 to the front edge 43. The slanted edge 47 further comprises an inset portion 48 positioned near the flat edge 46 having a front inset edge 49, back inset edge 50, and a inset edge surface 51. The slanted edge 47 further comprises a raised portion 52 extending from the front edge 43. A flipper button 53 is positioned along the exterior surface 42 near the front edge 43 and raised portion 52. The left panel 40 may have lights or other audiovisual components positioned on the exterior surface 42 or within the left panel 40.

The right panel 60, having an interior surface 61 and exterior surface 62, is connected to the front panel 20, back panel 80, bottom panel 90, and top panel 100. The right panel 60 connects to the front panel 20 at the front edge 63 and connects to the back panel 80 at the back edge 64. The top edge 65 of the right panel 60 comprises a flat edge 66 and a slanted edge 67. The flat edge 66 extends from the back edge 64 and is the portion that connects to the top panel 100. The slanted edge 67 extends from the flat edge 66 to the front edge 63. The slanted edge 67 further comprises an inset portion 68 positioned near the flat edge 66 having a front inset edge 69, back inset edge 70, and a inset edge surface 71. The slanted edge 67 further comprises a raised portion 72 extending from the front edge 63. A flipper button 73 is positioned along the exterior surface 62 near the front edge 63 and raised portion 72. The right panel 60 may have lights or other audiovisual components positioned on the exterior surface 62 or within the right panel 60.

The back panel 80 is connected to the bottom panel 90, the back edge 44 of left panel 40, the back edge 64 of the right panel 60, and top panel 100. The bottom panel 90 is connected to the front panel 20, the left panel 40, right panel 60, and back panel 80. Numerous electrical and structural components for the pinball machine 1 are mounted or positioned on the interior surface of bottom panel 90.

The top panel 100, having a front edge 101, a top surface 102, and an inset within the top surface 102 adjacent the front edge 101, is connected to the back panel 80, the flat edge 46 of the left panel 40, and the flat edge 66 of the right panel 60.

A generally rectangular shaped back box 110 extends above the top panel 100 of the cabinet 10. The back box 110 may include a video screen 111, speakers, 112, and a lighted display panel 113. Other items such as toppers may be mounted or positioned on top of the back box 110. The interior of the back box 110 may include multiple electrical, power, and/or audiovisual components to operate the video screen 111, speakers, 112, and a lighted display panel 113.

The cabinet 10 may feature several audiovisual components including video screens, speakers, lights, cameras, microphones, and other audiovisual components. The cabinet 10 may include various other components including motors, sensors, switches, and solenoids used to control and operate different functionality of the cabinet. Multiple components are located within the cabinet 10 including computing system and power supply.

A playfield 120, comprising a board 121 and playfield components 130, is positioned within the interior of cabinet 10. The rectangular shaped board 121 comprises a top surface 122, a bottom surface 123, a front edge 124, a left edge 125, a right edge 126, and a back edge 127. A left notch 128 is formed at the juncture of the front edge 124 and left edge 125. A right notch is formed at the juncture of the front edge 124 and right edge 126.

The playfield 120 contains multiple playfield components 130 including a plurality of fixed, stationary, electrical, mechanical, or electro-mechanical components that may interact with the pinball(s) to score points and/or activate certain features of the game. Playfield components 130 may include ball return assembly, action coils (e.g., flippers, slingshots, pop bumpers), ball devices (e.g., plunge, trough, vertical up kick, ball lock, kickback, scoop lock), diverters, ramps, gates, toys, spinners, targets (e.g., drop, stationary, variable, kicking, rollover, popup), accelerometers, magnets (actuated or fixed), motors (e.g., servos, stepper, dc motor), sensors, switches (e.g., rollover, eddy, kickback, button, IR, induction, solenoid, trough, or opto), and audiovisual components (e.g., screens, speakers, and lights). The sensors may be enabled to detect the location of the pinball, speed and direction of the pinball, levelness of the playfield, and movement of the playfield (e.g., detect nudging, bumps, or knocks). Playfield components 130 may have a portion positioned on the top surface 122, a portion positioned through the board 121, and/or a portion positioned on the bottom surface 123. Playfield components 130 may be combined together in numerous combinations. Playfield components 130 may further comprise low level computing and software controls that utilize conditional circumstances or logic to determine whether to change the state of the component or transmit data.

The interactive touch control 140 is generally rectangular shaped having a top surface 141, a bottom surface 142, a front edge 143, a back edge 144, a left edge 145, and a right edge 146. The interactive touch control 140 is further comprised of a tempered capacitive touch screen 150 having a top surface 151 and an LCD display 152 having a top surface, bottom surface 153, left edge 154, and a right edge 155. In alternative embodiments the touch screen may utilize other touch detection methodologies and technologies such as resistive, infrared, surface acoustic wave, or near field imaging. In further alternative embodiments the LCD display may be other types of display technologies such as OLED or LED. A gasket 156 is positioned on the top surface 151 of the capacitive touch screen 150 and runs adjacent to the front edge 143, the back edge 144, the left edge 145, and the right edge 146.

The interactive touch control 140 is attached to a base plate 160 having a top surface 161, a bottom surface 162, a downward facing front edge lip 163, an upward facing back edge lip 164, a left edge 165, and a right edge 166. A left side plate 167 extends from the top surface 161 of the base plate near the left edge 165. A right side plate 168 extends from the top surface 161 of the base plate near the right edge 166. The left side plate 167 attaches to the left edge 145 and right side plate 168 attaches to the right edge 146 of the interactive touch control 140. Specifically, the left side plate 167 attaches to the left edge 154 of the LCD screen 152 and right side plate 168 attaches to the right edge 155 of the LCD screen 152. Additional support structure, such as a raised plate is positioned between the bottom surface 152 of the LCD screen 151 and the top surface 161 of the base plate 160. A hole is positioned within the base plate 160 to allow wiring to connect to the playfield 160 or other computer componentry. The base plate 160 provides a protective frame around the bottom surface 142 of the interactive touch control 140. Drivers, controllers, and other electronic componentry related to the interactive touch control 140 may be placed on the underside of the base plate 160. The base plate 160 is preferably made of a strong material such as metal.

The lockbar mounting assembly 180 comprises a left bracket 185, a right bracket 190, and a center mounting assembly 200. The left bracket 185 further comprises a top edge 186, a bottom edge 187, and an interior surface 188. The left bracket 185 is generally parallel to the left panel 40. The right bracket 190 further comprises a top edge 191, a bottom edge 192, and an interior surface 193. The right bracket 190 is generally parallel to the right panel 60. The base plate 160 is attached to the top edge 186 of the left bracket 185 and the top edge 191 of the right bracket 190.

The center mounting assembly 200 comprises a center cross plate 201 having an upward facing back edge lip 202 and a downward facing plate 203. The center cross plate 201 is generally parallel to the bottom panel 90. The upward facing back edge lip 202 and a downward facing plate 203 are generally parallel to the front panel 20. The downward facing plate 203 comprises an exterior surface 204, a left portion 205, a right portion 215, and a center portion 225. Two knobs 206 extend perpendicularly from the exterior surface 204 near the bottom edge 207 of the left portion 205. A planer slide handle 208 comprises a shaft 209 having slots 210, a pointed end 211 on one end of the shaft 209, and a handle 212 on the other end of the shaft 209. A first detent 213 is positioned on the bottom of the shaft 209 near the pointed end 211 and a second detent 214 is positioned on the bottom of the shaft 209 near the handle 212. The slide handle 208 is slidably attached to the two knobs 206 through the slots 210. The slide handle 208 is capable of sliding parallel to the front panel 20. Two knobs 216 extend perpendicularly from the exterior surface 204 near the bottom edge 217 of the right portion 215. A planer slide handle 218 comprises a shaft 219 having slots 220, a pointed end 221 on one end of the shaft 219, and a handle 222 on the other end of the shaft 219. The slide handle 218 is slidably attached to the two knobs 216 through the slots 220. A first detent 223 is positioned on the bottom of the shaft 219 near the pointed end 221 and a second detent 224 is positioned on the bottom of the shaft 219 near the handle 222. The slide handle 218 is capable of sliding parallel to the front panel 20. A glass top opening lever 350 is attached to the center portion 225 and extends between the left portion 205 and right portion 215.

A left lockdown plate 230, having a top surface 231 and a bottom surface 232, is parallel to the bottom panel 90 and attached to the interior surface 188 of left bracket 185 near the bottom edge 187 and the bottom edge 207 of the left portion 205. The left lockdown plate 230 further comprises a receiving slot 233 and a ball detent device 234. A right lockdown plate 235, having a top surface 236 and a bottom surface 237, is parallel to the bottom panel 90 and attached to the interior surface 188 of right bracket 190 near the bottom edge 192 and the bottom edge 217 of the right portion 215. The right lockdown plate 235 further comprises a receiving slot 238 and a ball detent device 239. The length of the receiving slot 233 and receiving slot 238 is approximately equal to the length of the triangular portion 38 of the arm 37 of the bracket 34. The width of the receiving slot 233 and receiving slot 238 is approximately equal to the length of the alignment tab 39a of the arm 37 of the bracket 34.

To lock the playfield 120 in the cabinet 10, the playfield 120 is placed onto the bracket 34 of the front panel 20. The bottom surface 232 of the left lockdown plate 230 and the bottom surface 237 of the right lockdown plate 235 rest on the top flat surface 37 of the arms 36. The triangular portion 38 and alignment tab 39a of the arms 37 extend through the receiving slot 233 and receiving slot 238. The dimensions of the triangular portion 38 and alignment tab 39a prevent the playfield 120 from sliding front to back or right to left. The slide handles 208, 218 are then pushed away from each other such that the pointed ends 211, 221 may slide through the vertical slots 39 of the arms 36. The pointed ends 211, 221 permit the handle to slide easier into the vertical slots 39. The ball detent device 234 of the left lockdown plate 230 is engaged with the second detent 214 of the slide handle 208. The ball detent device 239 of the right lockdown plate 235 is engaged with the second detent 224 of the slide handle 218. The ball detent device 234, 239 keep the slide handles 208, 218 locked until manually released. The size of the shaft 209, 219 corresponds to the size of the vertical slot 39 of the bracket 34.

To release the playfield 120, the slide handles 208, 218 are pulled toward each other until each slide handle 208, 218 is completely removed from the vertical slots 39. The slide handles 208, 218 are slid with enough force to disengage the ball detent device 234, 239. When the slide handles 208, 218 are in the fully open position, the ball detent devices 234, 239 engage the first detent 213, 223 of each slide handle 208, 218. In this position, the pointed ends 211, 221 are fully removed from the vertical slot 39.

A glass top assembly 250 comprises a frame 260, locking mechanism, and lifting mechanism 360. The generally rectangular frame 260 comprises a first portion 261 and a second portion. The first portion 261 is rectangular in shape having a top surface 262, a bottom surface 263, a front lip 264, a back portion 265, a left lip 266, and a right lip 267. A seal is positioned along the bottom surface 262 to seal the first portion 261 against the top of the front panel 20, left panel 40, right panel 60, and the front edge 321 of the glass plate 320. A rectangular shaped opening 268 is positioned through the top surface 262 of the first portion 261 and is defined by the front lip 264, the back portion 265, the left lip 266, and the right lip 267. A back plate 269 extends perpendicularly from the bottom surface 263 of the back portion 265. As seen in FIG. 17 a left U shaped bolt 270, having and eye 271, extends perpendicularly from the bottom surface 263 of the first portion 261 between the left lip 266 and the opening 268 and a right U shaped bolt 272, having an eye 273, extends perpendicularly from the bottom surface 263 of the first portion 261 between the right lip 267 and the opening 268. The left and right U shaped bolts 270, 272 are positioned such that the eyes 271, 273 are parallel to the left lip 266 and right lip 267. The opening 268 generally corresponds to the gasket 156 attached to the top surface 141 of the interactive touch control 140. When the glass top assembly 250 is in the closed position, the bottom surface 263 of the first portion 261 presses against the gasket 156 of the interactive touch control 140, the left lip 266 covers a portion of the top edge 45 of the left panel 40, the front lip covers the top edge 23 of the front panel 20, and the right lip 267 covers a portion of the top edge 65 of the right panel 60. The seal formed by the gasket 156 and the bottom surface 263 is sufficient to prevent liquid, dust, or other debris from entering the cabinet 10. The first portion 261 of the frame 260 is preferably made of a strong material such as a metal and may be unitary construction or comprised of one or more components.

The second portion 280 of the frame 260 comprises a left member 290, a right member, and a rear member. The left member 290 further comprises a top face 291, an exterior face 292, a front terminal end 293, and a rear terminal end 294. A glass support plate 295 is attached to the top face 292 of the left member 290. The right member 300 further comprises a top face 301, an exterior face 302, a front terminal end 303, and a rear terminal end 304. A glass support plate 305 is attached to the top face 301 of the right member 300. The rear member 310 further comprises a top face 311, a left end 312, and a right end 313. A hinge 314 is mounted to the inset of the top panel 100 and the top face 311 of the rear member 310. In the preferred embodiment the hinge 314 is a plano style hinge.

The rear terminal end 294 of the left member 200 is attached to the left end 312 of the rear member 310. The rear terminal end 304 of the right member 300 is attached to the right end 313 of the rear member 310. The rear member 310 is approximately the same length as the front edge 101 of the top panel 100. The glass support plates 295, 305 are approximately the same thickness of the hinge 314.

A glass plate 320, having front edge 321, rear edge 322, left edge 323, right edge 324, and a seal 325 positioned around the rear, left, and right edges, is placed on top of the glass support plates 295, 305 and the hinge 314. The front edge 321 of the glass 320 abuts the back plate 269 of the first portion 261.

An “L” shaped left cover bracket member 296, having a first leg 297 and second leg 298, wherein the first leg 297 is attached to the exterior face 292 of the left member 290 and the interior surface of the left lip 266 of the first portion 261. The second leg 298 of the “L” shaped bracket 296 extends over the seal 325 and left edge 323 of the glass 320. An “L” shaped right cover bracket member 306, having a first leg 307 and second leg 308, wherein the first leg 307 is attached to the exterior face 302 of the right member 300 and the interior surface of the right lip 267 of the first portion 261. The second leg 308 of the “L” shaped bracket 306 extends over the seal 325 and right edge 324 of the glass 320. A rear trim member 315 is mounted to the rear member 310 and includes a glass catch to prevent the glass 320 from sliding back as the glass assembly 250 is lifted. As seen in FIGS. 1-7, when in the closed position, the “L” shaped cover bracket member 296, 306 cover up the inset portion 48, 68 of the left panel 40 and right panel 60 which adds to the aesthetics of the cabinet and helps keep the interior of the cabinet 10 from collecting debris and dust.

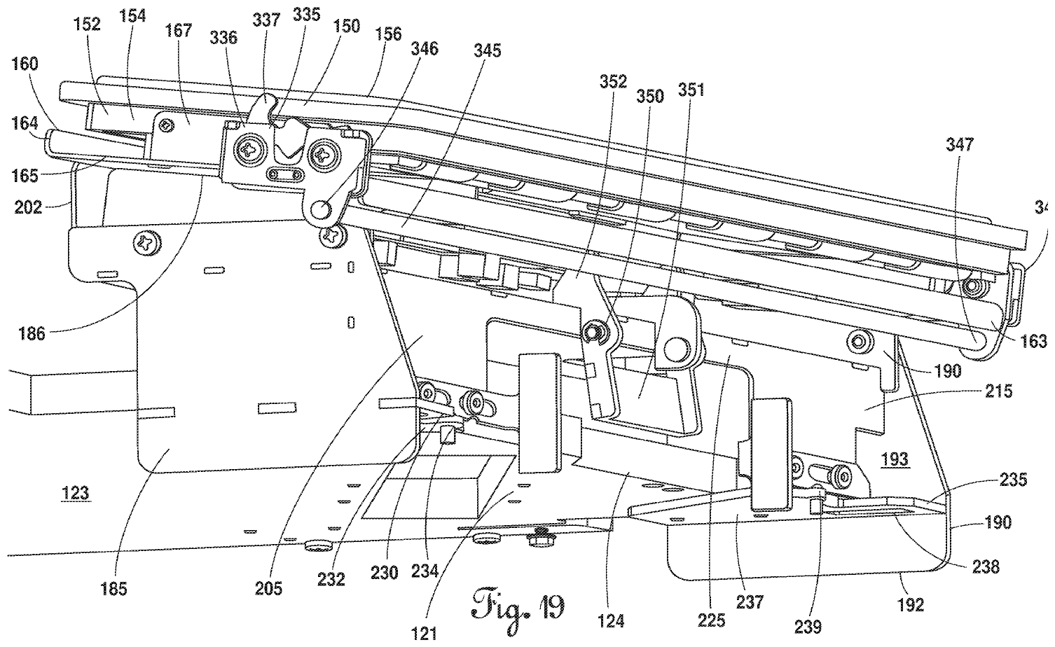

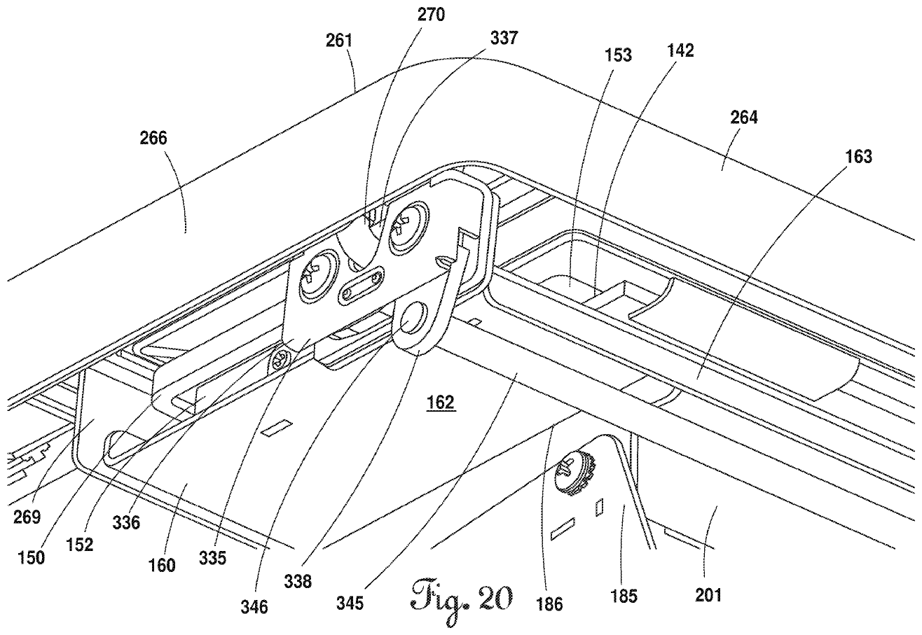

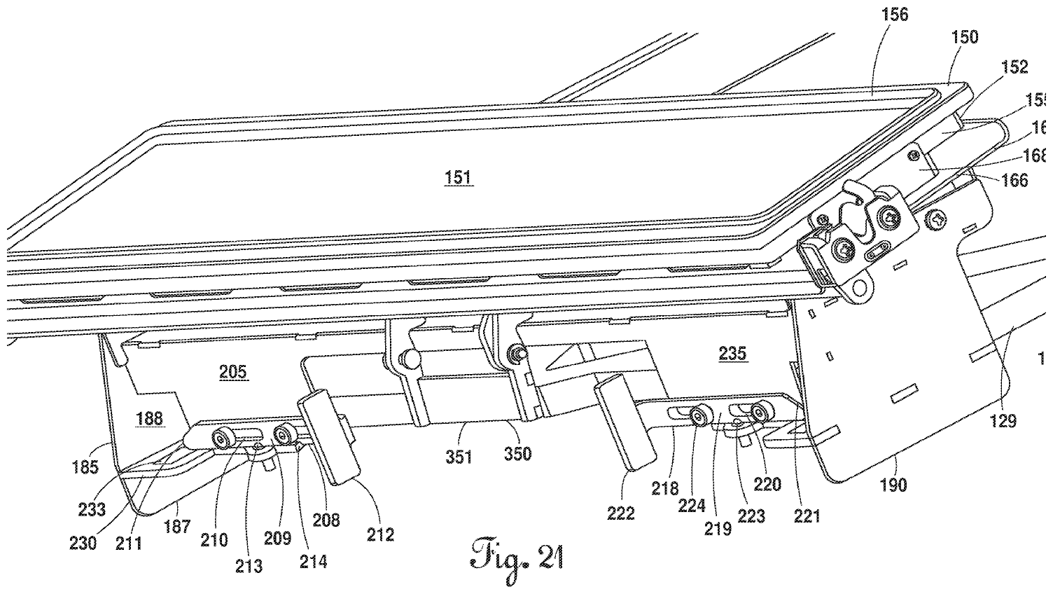

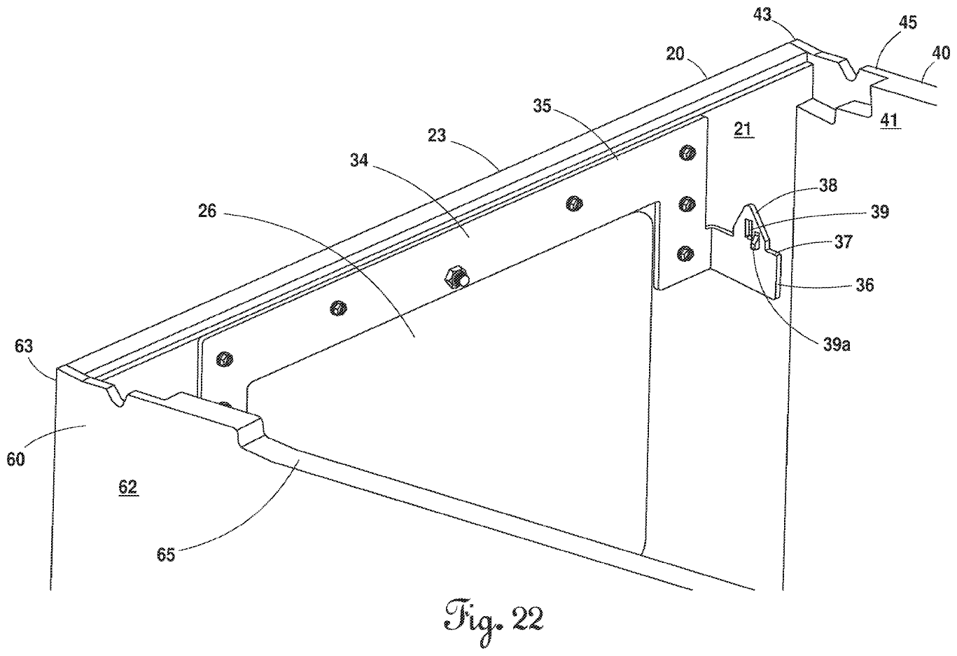

As seen in FIGS. 17-23, the locking mechanism comprises the U shaped bolts 270, 272, a left rotary latch 335, a right rotary latch 340, a rod 345, and the glass top opening lever 350. The left rotary latch 335 comprises a housing 336, a latch 337, and a latch release mechanism 338. The latch 337 is capable of securing the left U shaped bolt 270 to the housing 336. The left rotary latch 335 is mounted to the left edge 165 of the base plate 160. The right rotary latch 340 comprises a housing 341, a latch 342, and a latch release mechanism 343. The latch 342 is capable of securing the right U shaped bolt 272 to the housing 341. The right rotary latch 340 is mounted to the right edge 166 of the base plate 160. The rod 345 is positioned parallel to the front panel and positioned underneath the downward facing front edge lip 164 of the base plate 160. The left end 346 of the rod 345 is connected to the latch release mechanism 338 of the left rotary latch 335 and the latch release mechanism 343 of the right rotary latch 340. The glass top opening lever 350 comprises a handle portion 351 and two activation prongs 352. As the handle portion 351 of the glass top opening lever 350 is pushed away from the front panel 20, the activation prongs 352 rotate toward the rod 345. As the activation prongs 352 push the rod 345 towards the front panel 20, the latch release mechanisms 338, 343 are pushed towards the front panel 20. When this occurs, the latch 337, 342 disengages from the U-shaped bolts 270, 272. When the handle portion 351 of the glass top opening lever 350 is released, the rod 345 and latch release mechanisms 338, 343 are returned to the rest position. When the glass top assembly 250 is closed, the U-shaped bolts 270, 272 push down on the latches 337, 342 within the housings 336, 341 until the latches 337, 342 reengage the U-shaped bolts 270, 272.

As seen in FIGS. 1, 4-7, the lifting mechanism 360 comprises a left lifting assembly 370, a right lifting assembly, and the hinge 314. The left lifting assembly 370 further comprises a mount plate 371, a pivot plate 375, and gas cylinder 386. The mount plate 371 is generally rectangular in shape and is mounted to the interior face 41 of the left panel 40 near top edge 45. The mount plate 371 is positioned in such a manner that a portion 372 of the mount plate 371 is accessible via the inset portion 49 of the left panel 40. A hole 373 is positioned within the accessible portion 372 of the mount plate 371 adjacent the back inset edge 50. The pivot plate 375 is comprised of a first planar portion 376 and a second planar portion 379 connected via an angled portion 382. The first planar portion 376 is pivotally mounted to the mount plate 371 at the first terminal end 377 and connected to the angled portion 382 at the second terminal end 378. The first planar portion 376 has a first position hole 383 and a second position hole 384 disposed there through. The second planar portion 379 is connected to the angled portion 382 at the first terminal end 380. The first planar portion 376 and second planar portion 379 are parallel to the left panel 40 and the mount plate 371. As seen in FIGS. 4-5, the second planar portion 379 is positioned within the inset portion 48 of the left panel 40. A foot 385 extends perpendicularly from the bottom of the second planar portion 379. In the closed position, the foot 385 rests on the inset surface 51 of the left panel 40. A first terminal end 387 of the gas cylinder 386 is pivotally connected to the second terminal end 381 of the second planar portion 379. A second terminal end 388 of the gas cylinder 386 is pivotally mounted to a mount 299 attached to the left member 290 of the frame 260. As seen in FIGS. 4-5, a locking pin 374 is mounted through the hole 373 in the mount plate 371 and the first position hole 383 in the first planar portion 376 of the pivot plate 375. The locking pin 374 is a spring loaded pin that is retracted by pulling on the pin and when released returns to an extended position. In the closed position, the mount is adjacent the front inset edge 49 of the left panel 40.

The right lifting assembly 390 further comprises a mount plate 391, a pivot plate 395, and gas cylinder 406. The mount plate 391 is generally rectangular in shape and is mounted to the interior face 61 of the right panel 60 near top edge 65. The pivot plate 395 is comprised of a first planar portion 396 and a second planar portion 399 connected via an angled portion 402. The first planar portion 396 is pivotally mounted to the mount plate 391 at the first terminal end 397 and connected to the angled portion 402 at the second terminal end 398. The second planar portion 399 is connected to the angled portion 402 at the first terminal end 400. The first planar portion 396 and second planar portion 399 are parallel to the right panel 60 and the mount plate 391. As seen in FIGS. 6-7, the second planar portion 399 is positioned within the inset portion 68 of the left panel 60. A foot 405 extends perpendicularly from the bottom of the second planar portion 399. In the closed position, the foot 405 rests on the inset surface 71 of the right panel 60. A first terminal end 407 of the gas cylinder 406 is pivotally connected to the second terminal end 401 of the second planar portion 399. A second terminal end 408 of the gas cylinder 406 is pivotally mounted to a mount 309 attached to the right member 300 of the frame 260. In the closed position, the mount is adjacent the front inset edge 69 of the right panel 60.

In the preferred embodiment, the pivot points of the left lifting assembly 370 are identical to the pivot points of the right lifting assembly 390 in that pivot points are spaced identically along the frame 260 and from the back panel 80.

As seen in FIGS. 1-7, the glass top assembly is in the closed position. This means the U shaped bolts 270, 272 are locked into the rotary latches 335, 340. The locking pin 374 remains positioned within hole 373 in the mount plate 371 and the first position hole 383 of the pivot plate 375.

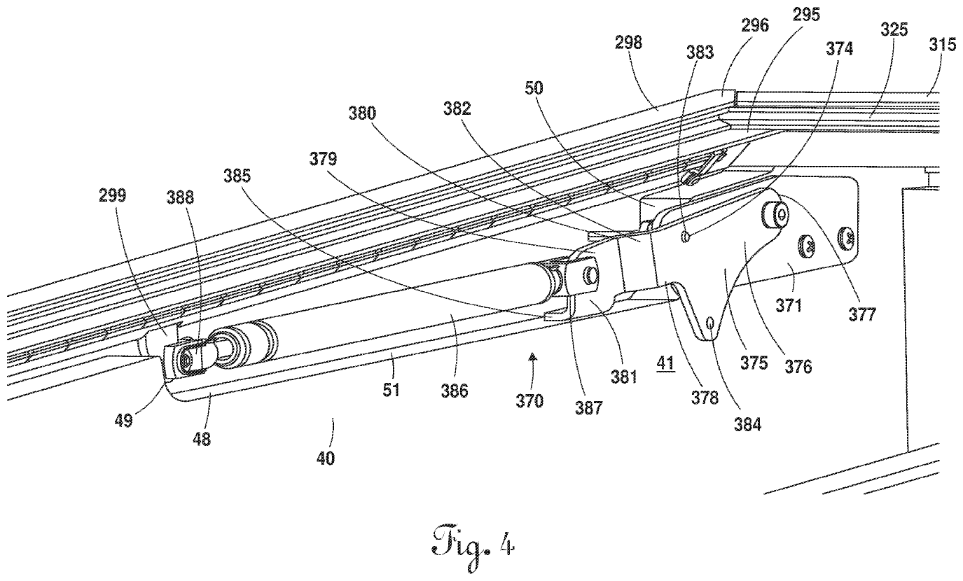

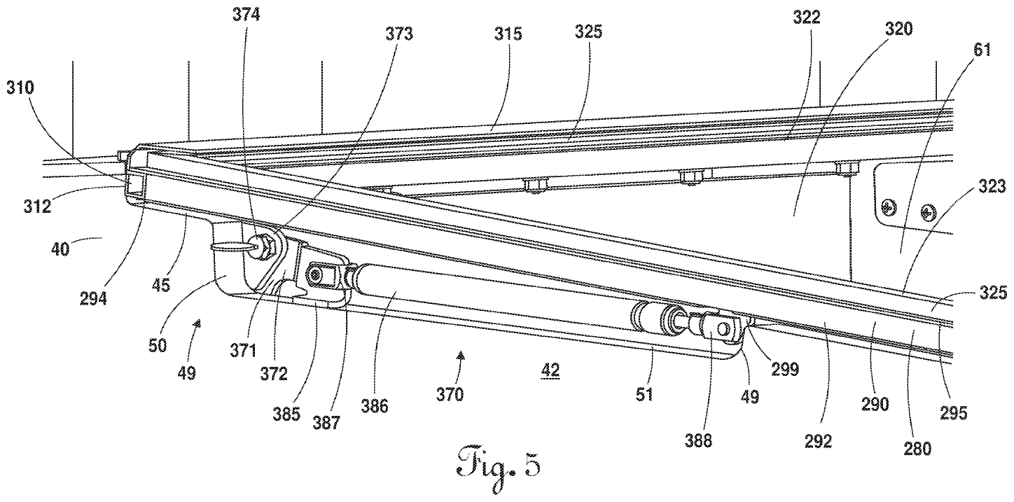

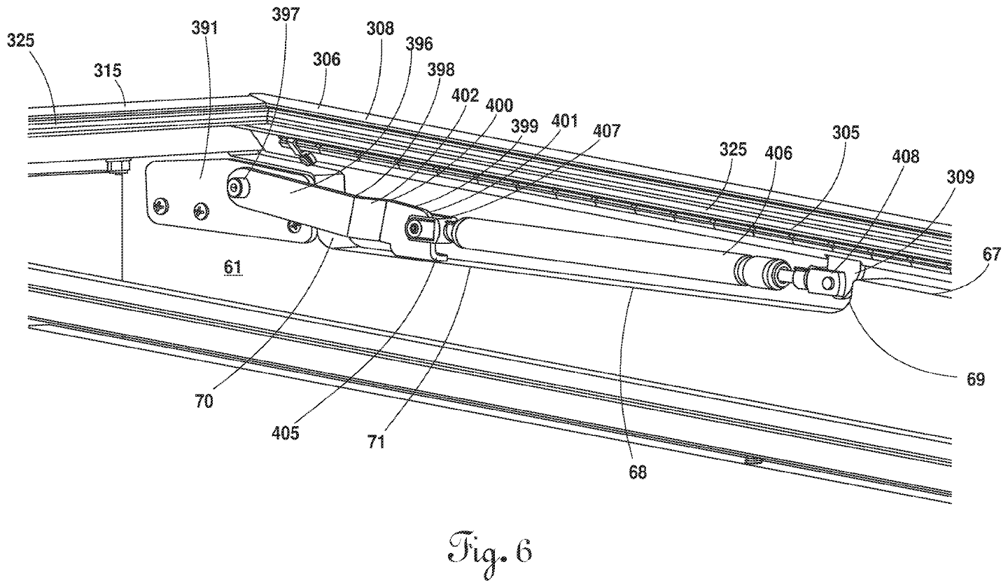

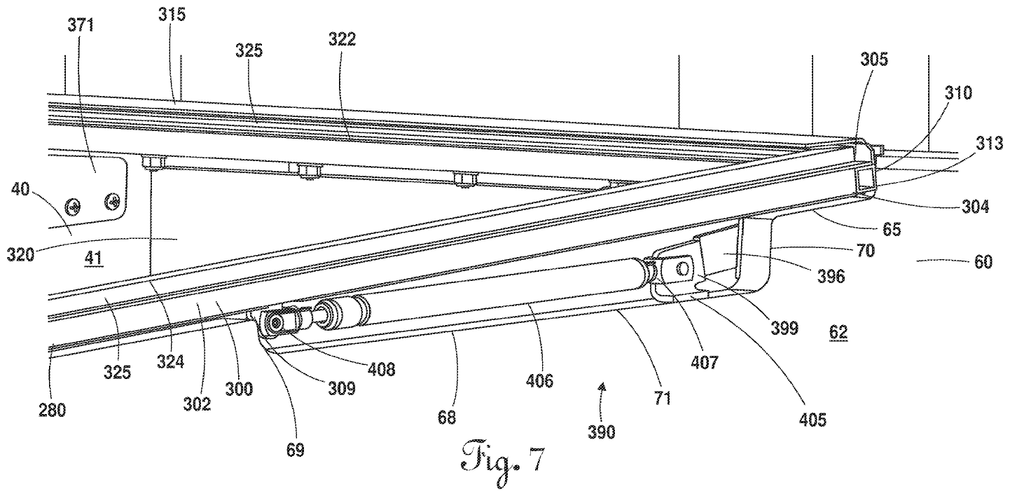

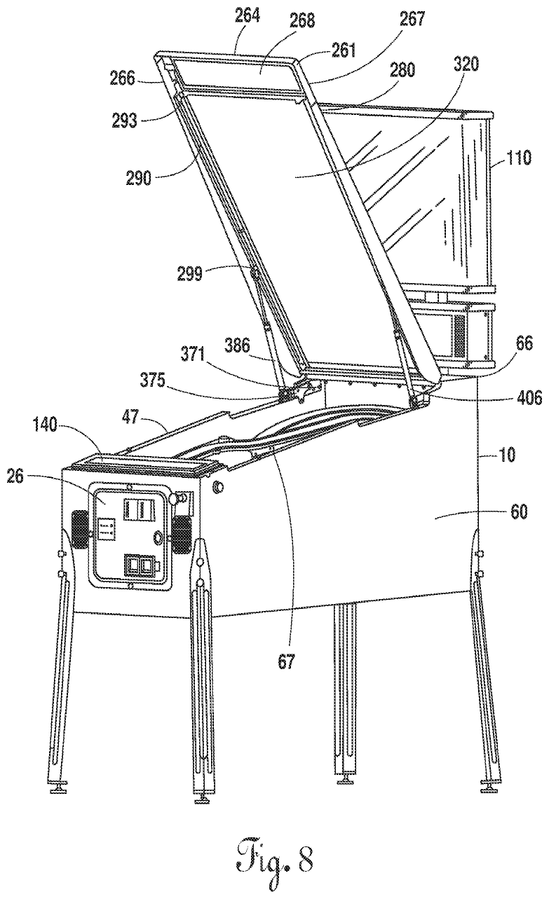

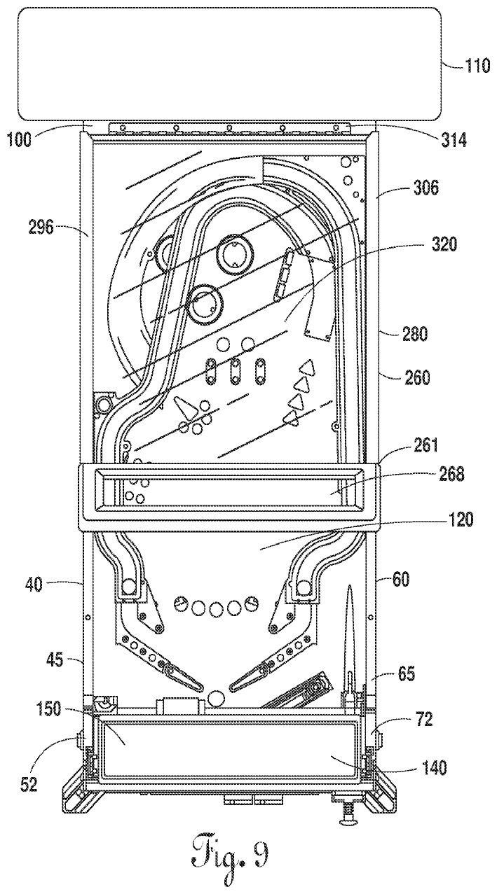

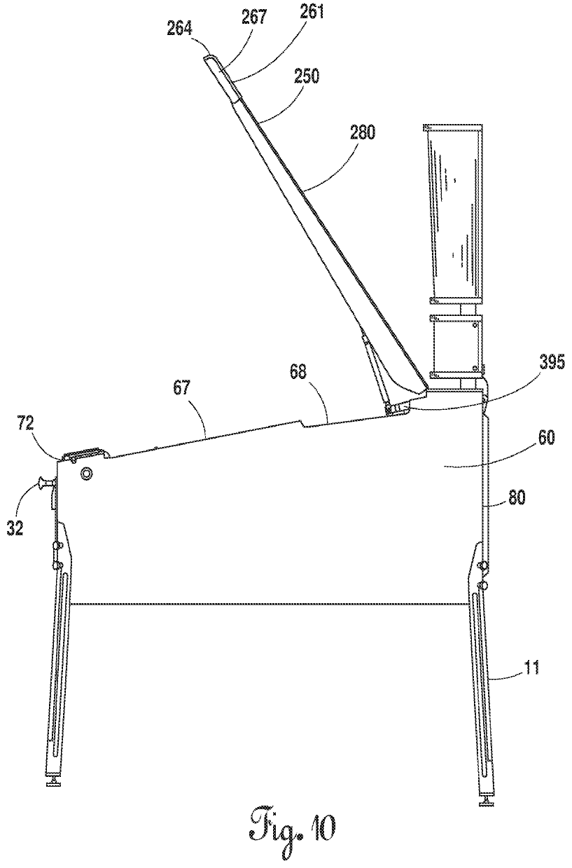

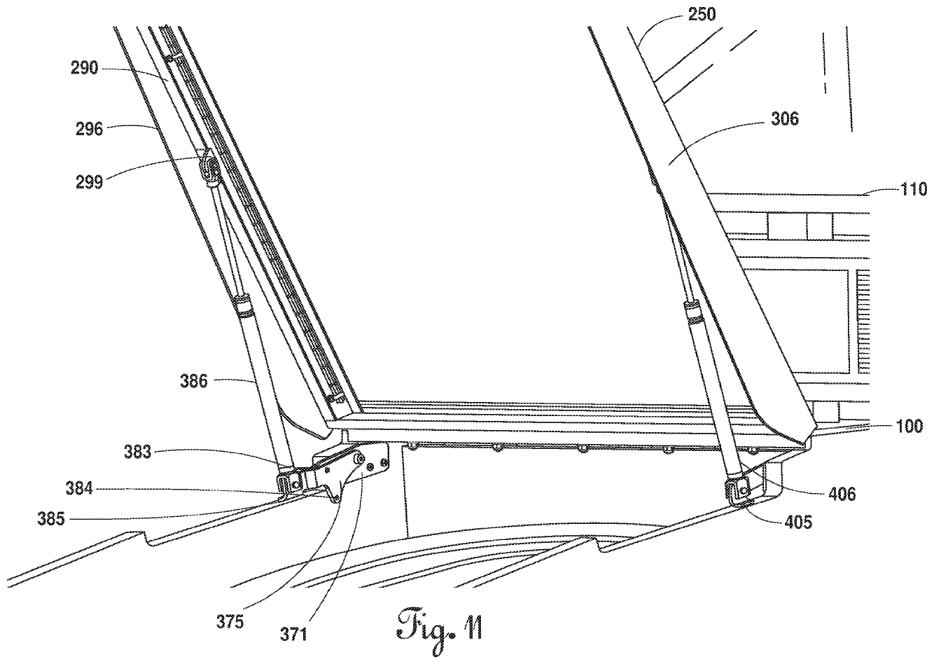

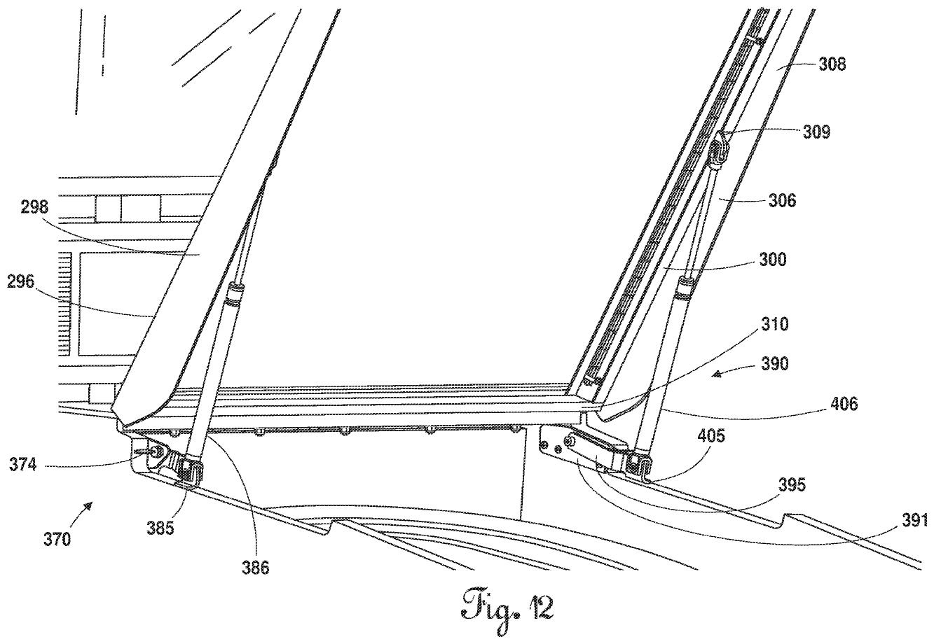

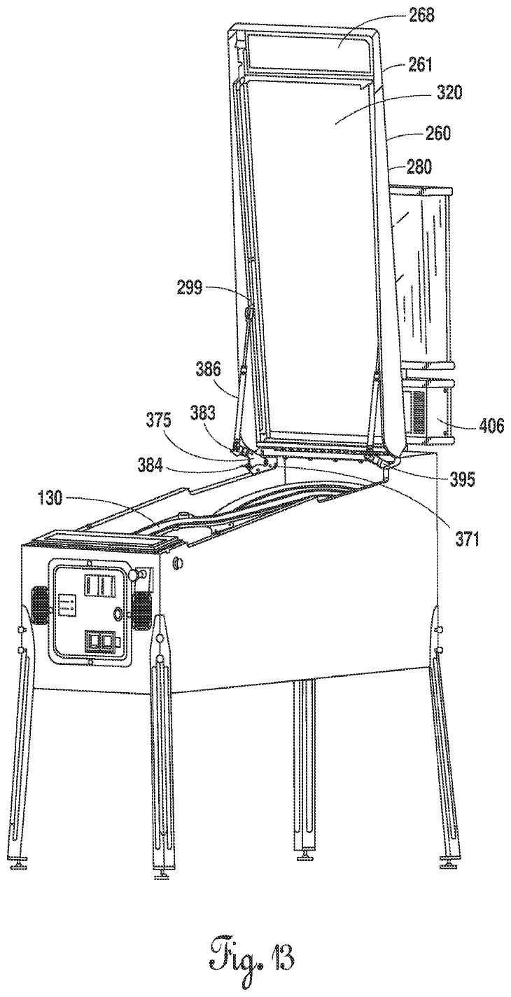

As seen in FIGS. 8-12, the glass top assembly 250 is in the first open position. To open the glass top assembly, the user opens the coin door 26, pushes the handle 351 of the glass top opening lever 350 away from the front panel 20. This causes the activation prongs to rotate towards the front panel 20 where it pushes the rod 345 towards the front panel 20. This activates the latch release mechanisms 338, 343 which releases the latches 337, 342. The U shaped bolts 270, 272 are released from rotary latch 335, 340. The user then lifts the glass top assembly 250 generally by lifting the first portion 261 of the frame 260 using the front lip 264, the left lip 266, and/or the right lip 267. The hinge 314 allows the glass top assembly 250 to rotate upwards. The gas cylinders 386, 406 rotate in relation to the pivot plate 375, 395 but the pivot plate 375, 395 remains stationary and the foot 385, 405 remains in contact with the inset surface 51, 71. The first position allows a user to gain access to the top of the playfield 120 to retrieve a stuck ball or make minor repairs. The gas cylinders 386, 406 cause the glass top assembly 250 to remain in this position until the user forcibly pulls down on the first portion 261 of the frame 260 to close the glass top assembly 250.

As seen in FIGS. 13-16, the glass top assembly 250 is in the second open position. To transition from the first open position to the second open position, the user retracts the locking pin 374 from the first hole position 383 in the pivot plate 375 of the left lifting assembly 370. The user then pushes the frame 260 to the more upright position. In doing so, the pivot plate 375, 395 pivots in relation to the mount plate 371, 391 until the second position hole aligns with the hole 373 in the mount plate 371. When the alignment occurs, the locking pin 374 automatically inserts into the second position hole 384. Alternatively, the locking pin 374 is retracted from the hole 373 in the mount plate 371 as well. When the pivot plate 375 is positioned in such a manner that the second position hole 384 is aligned with the hole 373, the spring loaded locking pin 374 automatically inserts into the second position hole 384. The locking pin 374 prevents the pivot plates 375, 395 from rotating down such that the feet 385, 405 rest on the left and right panels 40, 60. In this configuration, the playfield 120 may be removed to give access to the interior of the cabinet and either side of the board 121. To return to first position or closed position, the locking pin 374 is retracted from the second position hole 384 which allows the pivot plates 375, 395 to rotate down to left and right panels 40, 60.

In alternative embodiments, the first position hole is eliminated. The locking pin is not engaged with the pivot plate unless the glass top assembly is in the second, or fully open, position.

The glass top assembly may be powered to open or close utilizing a motor, air compressor, or other means.

One embodiment of the present invention is shown in reference to a block diagram in FIG. 24. A pinball game machine 1 includes an interactive touch control 140, a primary computing system 500, a secondary computing system(s) 510, and peripheral system(s) 520. It should be understood the interactive touch control 140 is a peripheral device and for purposes of FIG. 24 the interactive touch control 140 is separately identified. The primary computing system 500 is electronically connected to the interactive touch control 140 and may deliver instructions to and receive information from the interactive touch control 140. The primary computing system 500 is electronically connected to the secondary computing system(s) 510 and may deliver instructions to and receive information from the secondary computing system(s) 510. The primary computing system 500 and the secondary computing system(s) 510 are electronically connected to the peripheral system(s) 520 and may deliver instructions to and receive information from the peripheral system(s) 520. In an alternative embodiment and as indicated by the dashed lines in FIG. 24, the secondary computing system(s) 510 and peripheral system(s) 520 are electronically connected to the interactive touch control 140 and may deliver instructions to and receive information from the interactive touch control 140.

As further described herein, the interactive touch control 140 is capable of delivering information to the primary computing system 500. The primary computing system 500 may then utilize that information to execute a set of instructions and communicate actions to the secondary computing system(s) 510 and/or the peripheral system(s) 520. Similarly, the primary computing system 500 may receive information from the secondary computing system(s) 510 and/or the peripheral system(s) 520 and utilize that information to execute a set of instructions and communicate actions to the interactive touch control 140.

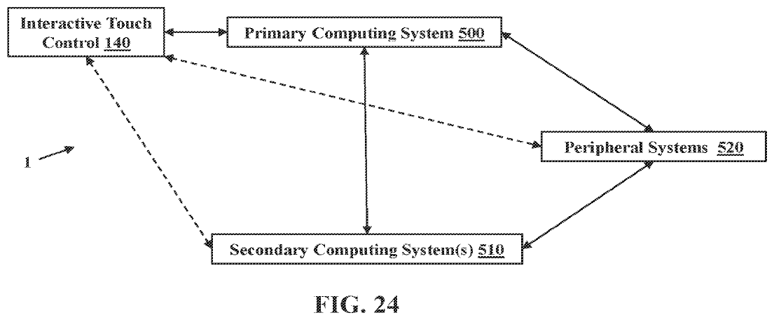

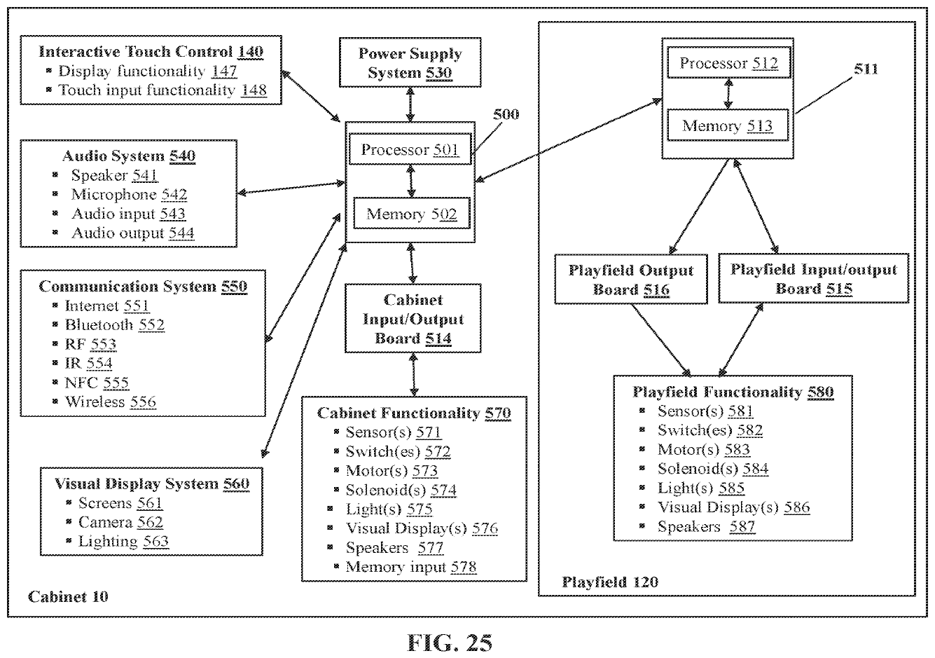

A more detailed view of an embodiment of the present invention is shown in reference to a block diagram in FIG. 25. FIG. 25 is illustrative of the interaction between the systems but is by no means limiting as FIG. 24 details the broader forms of interaction between the primary computing system 500, the secondary computing system(s) 510, and the peripheral system(s) 520. The primary computing system 500 comprises a processor 501 in communication with memory 502. The primary computing system 500 is located within the cabinet 10 of the pinball game machine a. In the disclosed embodiment the secondary computing system(s) 510 include a playfield computing system 511 having a processor 512 in communication with memory 513, a cabinet switch input board 514, a playfield input/output board 515, and a playfield output board 516. The playfield computing system 511, the playfield input/output board 515, and the playfield output board 516 are generally located on the playfield 120. The cabinet input/output board 514 is generally located within the cabinet 10 of the pinball game machine 1. The peripheral system(s) 520 may include an interactive touch control 140, a power supply system 530 530, an audio system 540, a communication system 550, a visual display system 560, cabinet functionality 570, and playfield functionality 580. The peripheral system(s) 520 may be located in the cabinet 10, on the playfield 120, or both.

Memory 502, 513 for the primary computing system 500 and the secondary computing system(s) 510 may include volatile, non-volatile, and semi-volatile memory such as RAM, one or more magnetic disk storage devices, flash memory devices, or other solid-state memory devices. Memory 502, 513 for the primary computing system 500 and the secondary computing system(s) 510 may include an operating system and software to operate and control the interactive touch control 140, peripheral system(s) 520, and other devices within the pinball machine 1.

The memory 502, 513 stores software capable of analyzing inputs from the peripheral system(s) 520 and determining proper outputs for peripheral system(s) 520 based on those inputs. The memory 502, 513 contains software capable of changing game play settings, audio-visual settings, cabinet settings, game modes, and scoring based on inputs received.

The interactive touch control 140 may have display functionality 147 and touch input functionality 148. The interactive touch control 140 may have one or more input/output boards, controllers, and/or processors with memory. The display functionality 147 results from images displayed on the display screen 152 of the interactive touch control 140. The displayed images may include graphics, text, icons, video, and any combination thereof generated by the primary computing system 500, secondary computing system(s) 510, and/or the input/output boards, controllers, and/or processors with memory directly associated with the interactive touch control 140. The touch functionality 148 results from inputs obtained from the capacitance screen 150 which is then processed by the primary computing system 500, secondary computing system(s) 510, and/or the input/output boards, controllers, and/or processors with memory directly associated with the interactive touch control 140. The capacitive touch screen 150 has a touch-sensitive surface, sensor, or set of sensors that accepts input from the user based on haptic and/or tactile contact. The capacitive touch screen 150 is multi-touch that permits advanced usage such as drag and drop, pinching, and swiping. The primary computing system 500, secondary computing system(s) 510, and/or the input/output boards, controllers, and/or processors with memory directly associated with the interactive touch control 140, take the location of the detected touch on the capacitive touch screen 150 and compare it to the image present on the display screen 152 at the time of the detected touch. The user touch may be made by the user's finger, a stylus, or some other suitable object. The surface 151 of the capacitive touch screen 150 may be able to read pressure, duration of contact, whether the contact is moving such as a swipe, direction of touch, speed of touch, and whether multiple touches are occurring. That data is then provided to the primary computing system 500, secondary computing system(s) 510, and/or the input/output boards, controllers, and/or processors with memory directly associated with the interactive touch control 140 for processing. In the disclosed embodiment, the interactive touch control 140 may transmit data directly to and receive data directly from the primary computing system 500. In other embodiments, the interactive touch control 140 may be in direct communication with secondary computing system(s) 510, and/or selected peripheral system(s) 520.

At least one power supply system 530 is connected to the pinball machine 1. The power supply system 530 may have one or more physical and/or electrical switches that selectively control and/or direct the flow of power. In alternative embodiments, the power supply system 530 may be directly connected to secondary computing system(s) and/or peripheral systems. The power supply system 530 may include standard power supply system 530 elements including a main switch, a module to regulate power from an AC input, and power supply board. The power supply system 530 provides power directly or indirectly to the interactive touch control 140, the primary computing system 500, secondary computing system(s) 510, and peripheral system(s) 520. In the preferred embodiment the primary computing system 500 may provide instructions to and receive data from the power supply system 530 to control various power functions and power supplies to the secondary computing system(s) 510 and peripheral system(s) 520 such as turning off power to selected peripheral system(s) 520, sleep power mode, and safety modes.

The audio system 540 may include speakers 541, microphone 542, audio input(s) 543, and audio outputs 544. The audio system 540, and/or its respective components such as speakers 541, microphone 542, audio input 543, and audio output 544, may have one or more input/output boards, controllers, and/or processors with memory that are connected directly or indirectly to the primary computing system 500 and/or secondary computing system(s) 510. The speakers 541 may be comprised of the speakers 33 on the cabinet 10, speakers 112 on the back box 110, and speakers on the playfield 120. Speakers 541 generate sound based on inputs from the primary computing system 500 and/or the secondary computing system(s) 510. The microphone 542 receives data and transmits that data to the primary computing system 500 and/or the secondary computing system(s) 510 where the data is processed and determined where it should be transmitted to next. The audio input 543, may include the audio input 30, receives data from a physical connection such as a portable music player, including phones, and transmits the data to the primary computing system 500 and/or the secondary computing system(s) 510. The audio output may include the audio output 31, receives data from the primary computing system 500 and/or the secondary computing system(s) 510 and transmits it an externally connected device such as headphones or external sound system.

The communication system 550 may include one or more communication modalities including internet connection through wireless or wired 551, Bluetooth 552, RF 553, IR 554, NFC 555, and/or other wireless transmission 556. The communication system, and/or the wireless or wired internet connection 551, Bluetooth 552, RF 553, IR 554, NFC 555, and/or other wireless transmission 556, may have one or more input/output boards and or controllers that are connected to the primary computing system 500. The communication system 550 facilitates communication with other devices and permits connection to local networks and/or the internet for connection to smart devices, other pinball games, and/or networks related to pinball play. The communication system 550 generates outputs that are sent to the primary computing system 500 and/or secondary computing system(s) 510 and may also receive inputs from the primary computing system 500 and/or the secondary computing system(s) 510.

The visual display system 560 may include screens 561, a camera 562, and lighting system 563. The screens 561 may include playfield video screens, cabinet video screens and/or one or more back box video screens 111. The playfield video screens, cabinet video screens and/or one or more back box video screens 111 may have one or more output boards and or controllers that are connected to the primary computing system 500 and/or secondary computing system(s) 510 that may include the playfield input/output board 515, playfield output board 516, and/or cabinet input/output board 514. The camera 562 have an output board and or controller that is connected to the primary computing system 500 and/or secondary computing system(s) 510 that may include the playfield input/output board 515, playfield output board 516, and/or cabinet input/output board 514. The camera 562 may include the capability to track body features and movements, facial features and movement, and move the lens to view the user, the playfield 120, or other desired location. The light system 563 may comprise of one or more lights positioned on the playfield 120, playfield components 130, cabinet 10, and/or back box 110. The light system 563 may have one or more output boards and or controllers that are connected to the primary computing system 500 and/or secondary computing system(s) 510 that may include the playfield input/output board 515, playfield output board 516, and/or cabinet input/output board 514.

The cabinet functionality 570 may include sensors 571, switches 572, motors 573, solenoids 574, lights 575, display 576, speakers 577, and memory input 578. The cabinet functionality 570 may be associated with the flippers, flipper buttons 53, 73, a coin door 26, the glass top assembly 250, the locking mechanism 330, leveling of the pinball game, and an anti-bump detection among others. A flipper is actuated by a solenoid that specifies the degree of rotation and speed. A flipper button 53, 73 is electronically connected to may be connected to a sensor that sends a signal to the primary computing system 500 and/or the cabinet input/output board 514 that indicates whether the button was pressed, how hard the button was pressed and/or the duration in which the button was pressed. The primary computing system 500 and/or the cabinet input/output board 514 translates the information from the sensor into an instruction to the switch controlling flipper specifying the degree of rotation and speed.

The coin door 26 may include multiple sensors capable of processing credit inputs through receipt of physical money, electronic payments, or credits. The coin door 26 may also have a sensor to detect when the coin door is open and/or not secured. The coin door may further have a lock controlled by electronic means capable of opening or closing without a physical key. The coin door 26 may also have lights or other audio visual displays. The cabinet functionality 570 associated with the coin door 26 generate outputs that are sent to the primary computing system 500 and/or secondary computing system(s) 510 and may also receive inputs from the primary computing system 500 and/or the secondary computing system(s) 510.

The glass top assembly 250 may have sensors placed on it or associated with it to indicate if the glass top opening is closed, or if open, in what type of open configuration. The glass top assembly 250 may also have a sensor to detect when the glass top opening is not locked. The glass top assembly 250 may further have a lock controlled by electronic means capable of opening or closing without a physical key. The glass top assembly 250 may also have lights or other audio visual displays associated with it. In some embodiments, the glass top assembly 250 may have a motor associated with it to open and close the glass top opening automatically. The cabinet functionality 570 associated with the glass top assembly 250 and lock generate outputs that are sent to the primary computing system 500 and/or secondary computing system(s) 510 and may also receive inputs from the primary computing system 500 and/or the secondary computing system(s) 510.

The cabinet 10 may have other functional systems including anti-bump detection, auto-leveling, and memory input controlled by various sensors, switches, solenoids, and/or motors. The cabinet functionality 570 associated with the anti-bump detection and auto-leveling generate outputs that are sent to the primary computing system 500 and/or secondary computing system(s) 510 and may also receive inputs from the primary computing system 500 and/or the secondary computing system(s) 510.

The playfield 120 contains multiple components 130 including plurality of fixed, stationary, electrical, mechanical, or electro-mechanical components that may interact with the pinball(s) to score points and/or activate certain features of the game. Components attached to the playfield 120 typically include one or more of the following: accelerometers; action coils (e.g., flippers, slingshots, pop bumpers); ball devices (e.g., plunge, trough, vertical up kick, ball lock, kickback, scoop lock); diverters; lighting (e.g., lamps, lights or led chips); magnets whether actuated or fixed; motors (e.g., servos, stepper, dc motor); ramps; screens (e.g., LCD or LED), sensors, spinners; switches (e.g., rollover, eddy, kickback, button, IR, induction, solenoid, trough, or opto) and/or targets (e.g., drop, stationary, variable, kicking, rollover, popup). Playfield components 130 may further comprise low level computing and software controls that utilize conditional circumstances or logic to determine whether to change the state of the component or transmit data. The playfield 120 generates inputs that are sent to the primary computing system 500 and/or secondary computing system(s) 510 and may also receive outputs from the primary computing system 500 and/or the secondary computing system(s) 510.

The interactive touch control 140, primary computing system 500, secondary computing system(s) 510, and peripheral system(s) 520 may communicate with each other through one or more communication buses. Alternatively, interactive touch control 140, primary computing system 500, secondary computing system(s) 510, and peripheral system(s) 520 may communicate wirelessly through the communication system.

The interactive touch control 140 and each peripheral system 520 (and/or components thereof), may be connected to the primary computing system 500 and/or the secondary computing system(s) 510 directly or through intermediary I/O boards or controllers. The interactive touch control 140 and/or each peripheral system 520 (and/or components thereof), may have a separate I/O board or an I/O board built into the device.

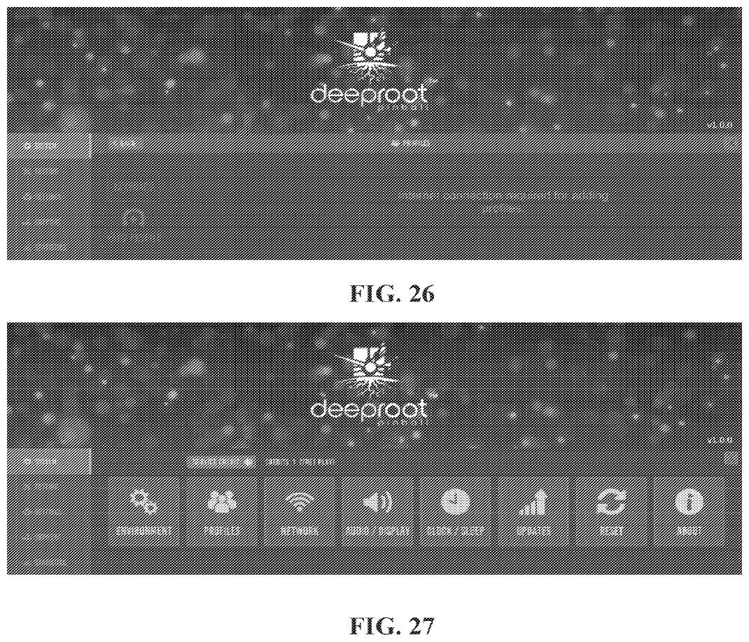

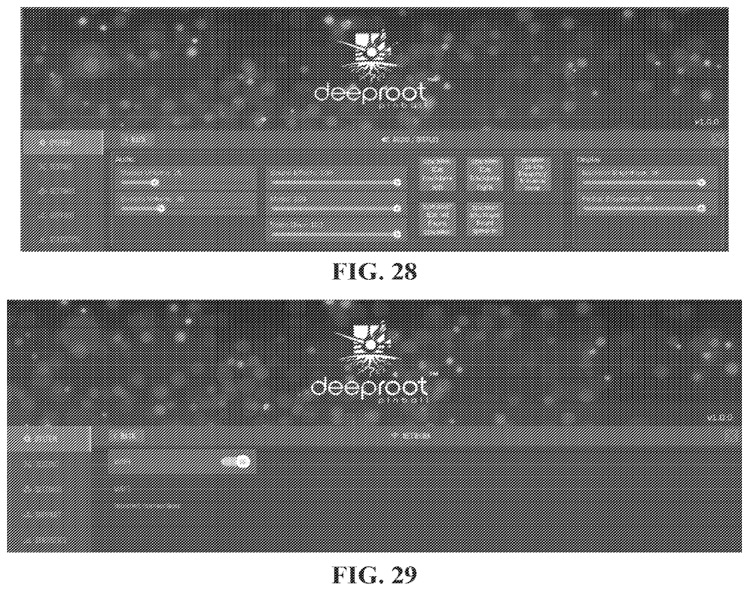

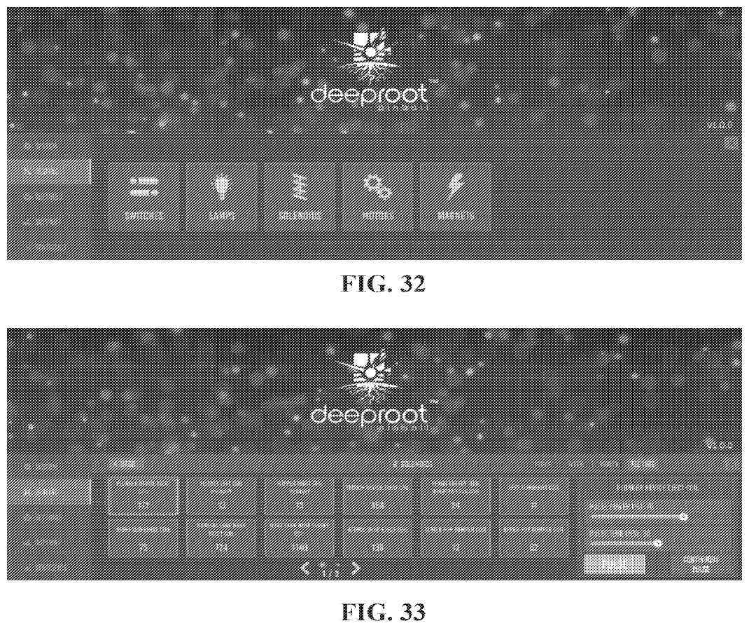

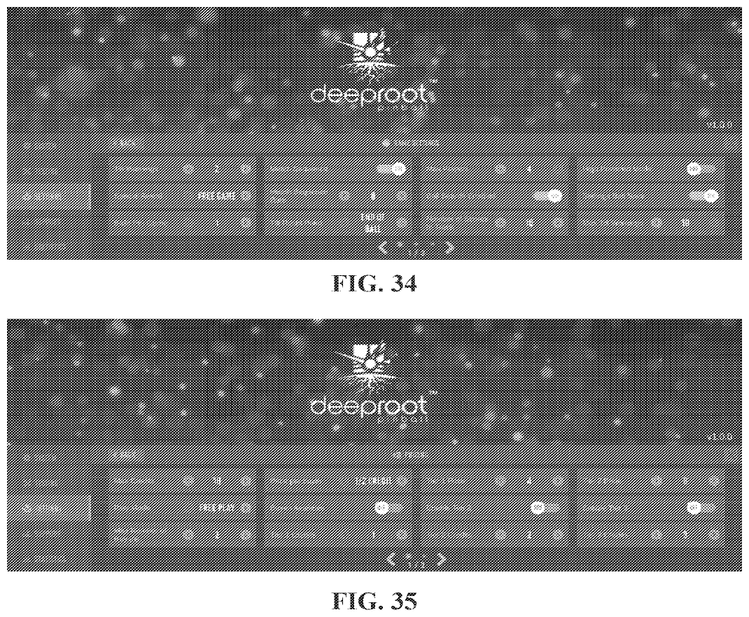

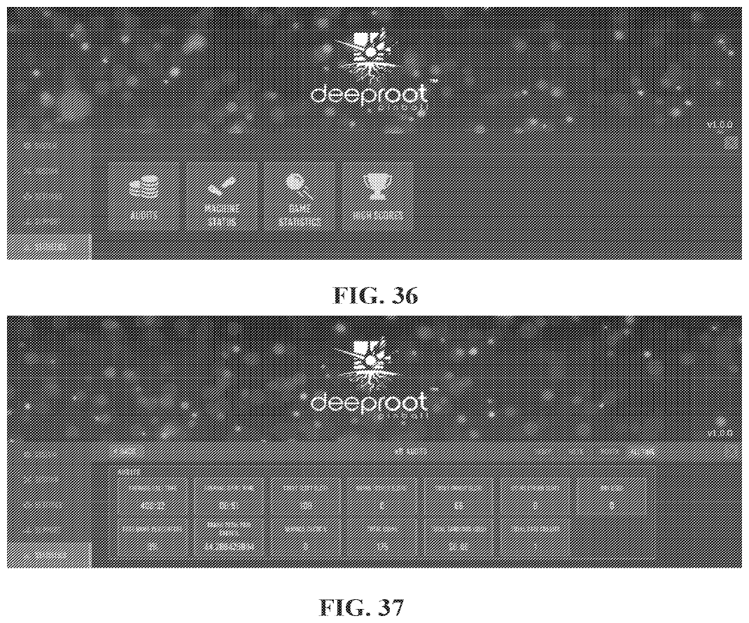

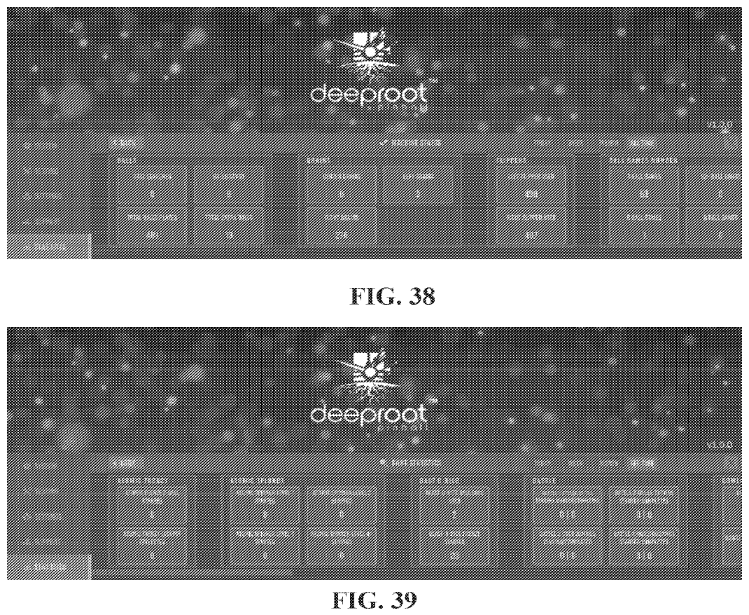

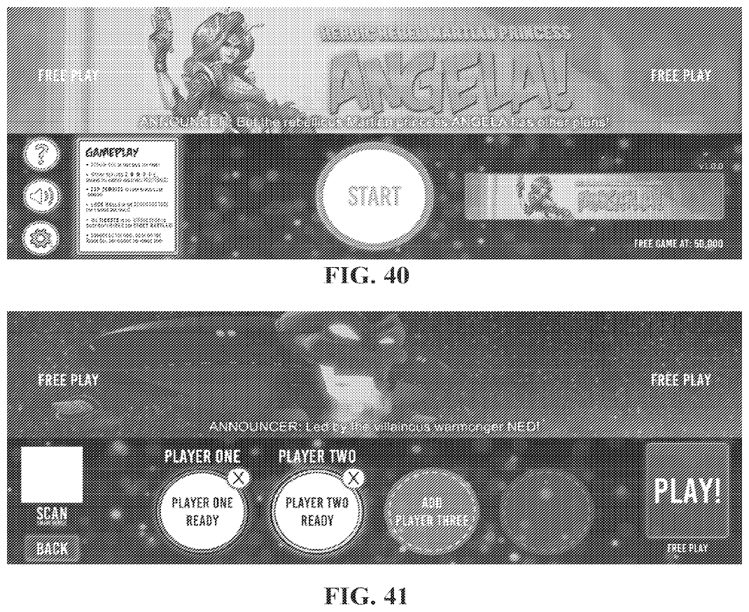

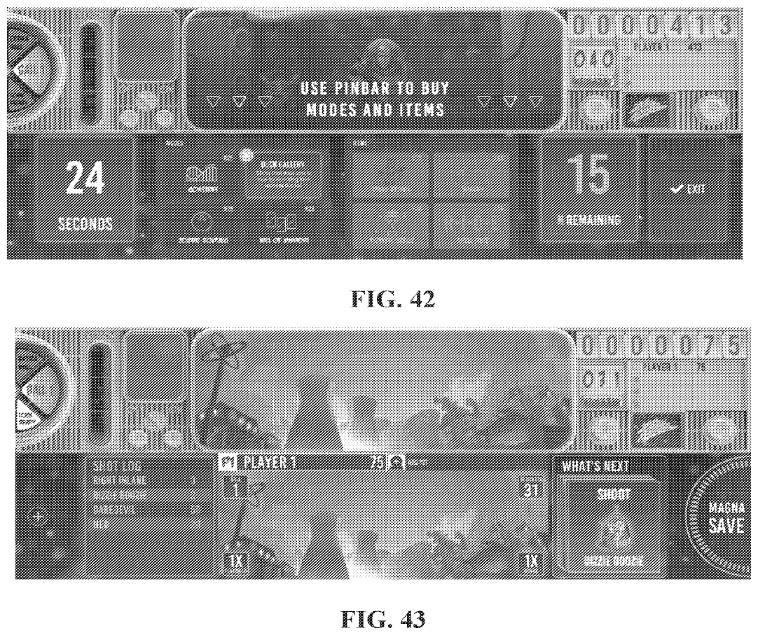

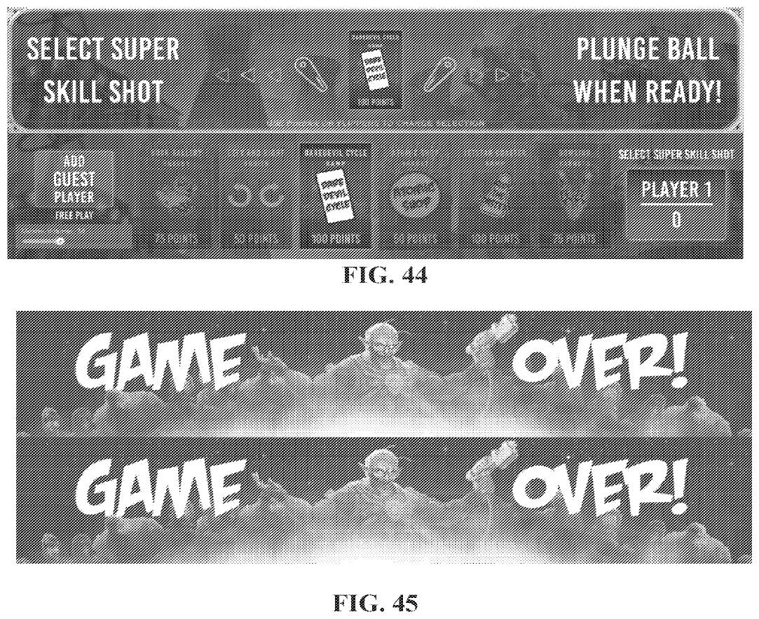

The interactive touch control 140 provides an interface for a user to control the pinball machine including inputting registration information, changing settings, adjusting gameplay, pausing game play, sharing scoring, concerning operation of the pinball machine as well as for displaying information related to the pinball machine. FIGS. 26-45 are illustrative examples of interfaces displayed on the interactive touch control 140 that permit such control. The illustrative examples identify buttons that a user may touch to select. The following descriptions should be read in view of the illustrative examples identified in FIGS. 26-45.

The artistic images and trademarks disclosed in the FIGS. 26-45 are owned by Applicant and subject to copyright and trademark protection. Publication of this application and/or issuance of a patent does not grant any person or entity a license or right to reproduce the copyrighted images or trademark contained herein except for use in patent related purposes such as prosecution. Governmental entities have the right to publish the figures herein as necessary pursuant to patent related purposes.

The interactive touch control 140 may provide a setup screen that allows a user to setup cabinet functionality 570, communication system 550, visual display system 560, playfield functionality 580, and audio system 540. For example, setting up cabinet functionality 570 may include setting the amount or credits or money necessary to play a game, setting up parameters for leveling and anti-bump detection. Setup may further include entering information for the communication system 550 to have access to the internet, other wireless devices, and/or other pinball machines with information pertaining to networks and/or passwords. Setup may further include setting information pertaining to the visual display system including brightness, color schemes, and other industry standard settings for lights, video screens, and other displays. The setup may also include setting camera information including live mode, recording, on/off, and adjusting performance measures of the camera. The inputs are transmitted to the primary computing system 500 where the primary computing system 500 stores and analyzes the information. Depending on the inputs, the primary computing system 500 may then send outputs to the secondary computing system(s) 510 and/or peripheral system(s) 520. For example, settings pertaining to the communication system are stored in memory and then utilized by the communication system to ensure connectivity to the internet. Other settings, such as those related to the camera, are stored in memory and then sent to the camera as an output.

The interactive touch control 140 may provide a setup screen that allows a user to setup a profile for the user and register the pinball machine. The profile may include information concerning the user such as age, skill level, identification information, picture, contact information, privacy settings, and statistics of game play among other relevant information. Such information may be inputted by the user through the interactive touch control 140 and then saved in the primary computing system 500. Registration of the machine may include machine identifiable information, association with the user profile, and ability to connect with the manufacturer for product and software updates, warranty, performance status, and maintenance among other information. This information shall be inputted on the interactive touch control 140 and is transmitted to the primary computing system 500 for storage in memory. Other setup information may be associated with a specific user profile or general operation of the pinball machine. Alternatively, the interactive touch control 140 may allow a user to retrieve their profile from physical memory such as a USB, from a separate source via the internet, or through other means such as Bluetooth, RF, wireless transmission, or NFC.

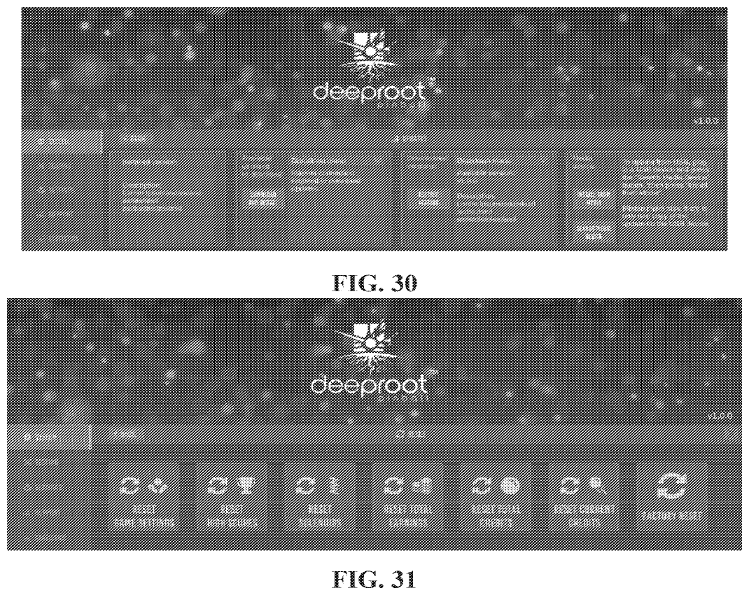

The interactive touch control 140 may provide the ability to adjust game play settings through inputs. The user may change sensitivity of the flipper buttons, may change the function of buttons on the cabinet, or may change scoring. Virtual buttons may be placed on the interactive touch control 140 which allows a user to control the flippers through the interactive touch control 140 including control based on degree of rotation of the flipper and velocity. Virtual buttons may also allow for ball save, inventory items, finesse buttons, additional virtual flipper (in addition to game's physical flipper buttons), activate a mechanical, coil, light, or switch on playfield. The interactive touch control 140 may provide the ability to change the game modes including those for multiplayer (multiple machines working together, handshake and shared game settings), free for all, training, story, tournament, timed, or custom. Other aspects of game play may be modified as well through the interactive touch control 140 including interactive training, mode shot guide, skill shot select, shot log, inventory list, active multiplier, ball save timer, game mode timer, animation screen (backbar mirror), game save button, game pause button, and ball lock status. FIGS. 31-35 are illustrative displays on the interactive touch control 140 related to a start menu and FIGS. 36-39 are illustrative displays on the interactive touch control 140 related to gameplay.

The interactive touch control 140 may provide the ability to adjust volume and sound settings and video settings. Other settings that may be changed or modified include music volume, sfx volume, sound mixing and eq, brightness of screen, brightness of interactive touch control 140, language, subtitles, difficulty level, camera, microphone, sleep (low power mode), leveling, and number of tilts allowed.

The interactive touch control 140 may permit for diagnostic tests and alerts. If some portion of the pinball machine is not working properly, as processed or detected by the primary computing system 500, an alert may be provided on the interactive touch control 140 with the ability to contact warranty or a service repairperson. The interactive touch control 140 may also provide a warning if some aspect of the machine is unsafe due to high voltage or one of the openings is not properly secured.

The interactive touch control 140 may permit the locking and unlocking of the glass top and/or coin door.

The interactive touch control 140 may display advertisements, high scores, pre-recorded videos about the game or other content, or provide a tutorial video with interaction from the user.

The interactive touch control 140 permits a user to change the modes, goals, and achievements, or software code during game play or between games through an interactive menu. The user also may choose which version of game software to use or alternate versions of software game code. Typically pinball machines do not offer the ability to have multiple modes that can be chosen by the player. Modes, goals, achievements, etc. add challenges and progression of a narrative to a pinball game's play. Most of the time these elements can only be entered in one of two ways: (i) accomplishment of a set of rules or outcome in the normal course of play; (ii) random selection upon a set occurrence; or (iii) one or more events are achieved through skill. Typically, the player has little to no ability to choose or have control over these elements without the traditional play of the ball or the specific software design of the machine.

The interactive touch control 140 permits a user to pause a game in progress. Walking away from a machine when the ball is in play typically results in the drain of the ball but the interactive touch control 140 permits a user to pause the game without losing the ball. The machine will remember the score and allow for restart.

The interactive touch control 140 permits a user the ability to set, save, change, or recognize a user or the user's personal preferences or settings upon starting a game, or the change of users in a multiplayer game.

The interactive touch control 140 permits a user to set the status of the machine for public use, private use, or tournament use. Settings may be modified to protect security or alter video/audio settings for home use versus a public setting.

The interactive touch control 140 permits a user to restrict certain player settings or certain players. This includes the ability to differentiate the type or geography of players. Also, the administrator settings can be remotely deployed, nor deployed to multiple machines at once.

The interactive touch control 140 permits a user to change difficulty level or game experience automatically based on the current user's profile. Typically most of the difficulty or game experience settings must be physically or manually set. And to do so would either require access to the locked coin door or inconvenient delays in game play.

The interactive touch control 140 permits a user to save scores and game play stats of the user to a local or central secured database for viewing or data analysis.

The interactive touch control 140 permits multiple users on multiple, but same-title pinball games to interact with each other during game play, or provide audio/video streamed multiplayer experiences.

The interactive touch control 140 permits multiple ways to view and change scoring and other visual/graphical information. In order for the user to interact with a display, during gameplay or not, the display must be in proximity to the normal resting position of the hands. As a result, there currently is no easy way to interactively interface with the machine for tasks like: software settings, setting up player accounts, instantly updating software, changing game rulesets, managing scores, opening the coin door or glass, etc. without experiencing these and other negatives.

The interactive touch control 140 allows the user to interact with the backbox display. The interactive touch control 140 can provide a mirror copy of the backbox display, scores, and game stats during game play, so players do not need to divert their eyes far away from events occurring on the playfield to view scores, graphical animations, game messages, and other visual elements that appear on the back box display during the game.

The interactive touch control 140 offers multiple ways to interact with video modes. Typically, games are limited to input from the two flippers buttons which substantially restricts the type of video modes and the interactivity with the software design or code behind the mode. The interactive touch control 140 may offer user-friendly interaction for selection of videos.

The interactive touch control 140 proximity to the top front of the pinball cabinet and within reach of both hands (and fingers) permits and encourages the player to interact with it. The design of the interactive touch control 140 also allows the player to still rest their palms on the traditional lockbar style top, even when interacting with the Interactive touch control 140 display. This creates a simple, ergonomic way to transition the hand (and fingers) from the flipper buttons to the interactive touch control 140.

By having the interactive touch control 140 proximity close to the player's hands, (if machine settings permit), access and control of machine settings are quick and simple to change on the fly; even during game play and without affecting the current game play. If the machine settings are protected, operators can quickly and easily log in and change settings on the fly while minimizing the inconveniencing of players.

The interactive touch control 140's software GUI provides unlimited ways the player can interact with the playfield components and the ball during gameplay. This includes adding graphical icons or software widgets to interact with playfield components in unique ways. This also includes adding functionality between multiple components or game play in ways never before imagined. The advantage this provides is that simply changing or updating the software can add additional ways to interact with the playfield components and ball, without changing the physical nature or layout of the playfield.

The interactive touch control 140 in conjunction with playfield components can permit in certain cases a game to be saved by saving physical and software state.

The interactive touch control 140 through its GUI interface can allow administrator settings to restrict certain types of players or activities, and (connected to the internet) can permit these settings to be deployed on multiple machines remotely.

The interactive touch control 140 through its GUI interface can allow player profile settings to rove with the player, including difficulty level or game experience settings on a global basis, or per game machine basis.

The interactive touch control 140 through its GUI interface and software can allow players to access and save scores and game play stats to a local or central secured database for viewing or data analysis. This includes the ability to compile scores and stats from roving machines on location.

The interactive touch control 140 through its GUI interface and software can allow multiple players on multiple, same-title pinball games to interact with each other during game play, or provide audio/video streamed multiplayer experiences.

The interactive touch control 140 through its GUI interface and software can allow a user to password restrict use of the pinball machine, limit the amount of playtime, or password restrict certain player profiles. Parental restrictions may be made for these purposes.

An alternative embodiment of the present invention allows for a removable or separate touch screen. In this embodiment, the touch screen is separate from the machine and offers the same functionality as the attached interactive touch control 140. In a separate embodiment, the software for the interactive touch control 140 is available as a downloadable application for use on off the shelf tablets.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

We claim:

1. A pinball machine comprising:
a primary computing system;
at least one peripheral system; and
an interactive touch control wherein the primary computing system is configured to receive inputs from and transmit outputs to the at least one peripheral system and to the interactive touch control.
